(19) United States
(12) Patent Application Publication
(10) Pub. No.: US 2025/0329329 A1
(43) Pub. Date: Oct. 23, 2025

(54) INTERACTIVE BARTENDER LEVERAGING GENERATIVE ARTIFICIAL INTELLIGENCE

(71) Applicant: c/o MINGA BOX LTD., Kfar Saba (IL)

(72) Inventors: Gal KALKSHTEIN, Kfar Neter (IL); Lital KALKSHTEIN, Kfar Neter (IL); Elad KOBI, Tel Aviv (IL)

(73) Assignee: c/o MINGA BOX LTD., Kfar Saba (IL)

(21) Appl. No.: 18/638,041

(22) Filed: Apr. 17, 2024

(51) Int. Cl. G10L 15/22; G10L 15/26

(52) U.S. Cl. CPC G10L 15/22; G10L 15/26

(57) ABSTRACT

This disclosure describes systems and methods for providing an interactive bartender that leverages the capabilities of generative artificial intelligence and large language models. The interactive bartender engages with a customer in natural language and prepares and dispenses a selected drink. By using generative artificial intelligence, the behavior, dialogue, and personality is readily extendible and customizable, and the knowledge available to the interactive bartender is maximized.

### BACKGROUND

People get thirsty and love to quench their thirst with a tasty beverage. Thus, many businesses sell drinks to customers. Businesses may be restaurants, bars, casinos, cruise ships, sports stadiums, convention centers, markets, hotels, museums, airports, breweries, concert venues, etc.

A beverage is a liquid consumed by a person, often served in a cup. Beverages may include juice, soda, tea, coffee, water, cider, milk, etc. Beverages may be served with ice to keep them cold. Other beverages may be served hot. Some beverages may include alcohol or caffeine. Some beverages may incorporate a garnish such as a cherry, lemon, lime, orange, grapefruit, pineapple, cucumber, berry, pepper, ginger, mint, rosemary, thyme, basil, sage, flower, salt, etc. Some beverages may include a toothpick made to look like a beach umbrella, incorporate smoke or fire, or include other novelties.

Typically, a customer wanting a beverage must wait in line, approach a bartender, provide an order, wait for the beverage to be made, pay for the beverage, and then, finally, at long last, receive the beverage. Conversing with a personable bartender may be enjoyable, and the witty repartee between customer and bartender may be an important part of the bar-going experience. But in other situations, a streamlined, automated experience may be more appropriate—e.g., in situations with numerous, congregating people where throughput is of paramount importance. In these situations, quickly receiving a drink may outweigh the desirability of interacting with a human bartender. People do not like to wait in line, after all, especially when thirsty.

Artificial intelligence (“AI”) is a term used to describe techniques that mimic human intelligence using computers' capabilities. Some AI solutions leverage neural networks and deep learning models. Neural networks learn to resemble human behaviors and make human-like inferences gradually through training with examples. One specific type of model is a large language model (“LLM”), named so because of the copious amounts of training data used to train the model. A generative pre-trained transformer (“GPT”) is a particular type of LLM trained on large data sets of unlabeled text that generates content while approximating human creativity.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIGS. 1A-1B illustrate an interactive bartender kiosk, according to some embodiments.

FIG. 2A illustrates an interior of an interactive bartender kiosk, with the viewing perspective being from the front, according to some embodiments.

FIG. 2B illustrates an interior of an interactive bartender kiosk, with the viewing perspective being from the rear, according to some embodiments.

FIG. 3 illustrates an interior of an interactive bartender kiosk, viewed from an alternative viewing perspective, according to some embodiments.

FIG. 4 is an example screen display of an interactive bartender, according to some embodiments.

FIG. 5 is a block diagram of an architecture that supports an interactive bartender kiosk, according to some embodiments.

FIG. 6 illustrates a method of dispensing a beverage to a customer, according to some embodiments.

FIG. 7 illustrates a method for processing spoken input received from a customer and communicating a response to the customer using an interactive bartender, according to some embodiments.

FIG. 8 illustrates a method for processing spoken input received from a customer and communicating a response to the customer using an interactive bartender using a generative AI, according to some embodiments.

FIG. 9 illustrates a method of building a prompt using prompt chaining during conversations between a customer and an interactive bartender, according to some embodiments.

FIG. 10A illustrates a customizable prompt that leverages a generative AI to determine an appropriate response to communicate via an interactive bartender, according to some embodiments.

FIG. 10B illustrates a customizable prompt built that leverages generative AI to determine an appropriate action to perform in an interactive bartender kiosk, according to some embodiments.

FIGS. 11A-11C illustrate a linear conveyor employed within an interactive bartender kiosk, according to some embodiments.

FIGS. 12A-12C illustrate close-ups of a platform affixed to the linear conveyor, according to some embodiments.

FIGS. 13A-13B illustrate a cup dispenser deployed in an interactive bartender kiosk, according to some embodiments.

FIGS. 14A-14D illustrate sections of an outer rod among a plurality of rods in a cup dispenser, according to some embodiments.

FIGS. 15A-15C illustrate an outer rod among a plurality of rods in a cup dispenser, according to some embodiments.

FIGS. 16A-16B illustrate a barrier positioned below a bottom plate in a cup dispenser, according to some embodiments.

FIGS. 17A-17C illustrate a cup splitter in a cup dispenser in an interactive bartender kiosk, according to some embodiments.

FIGS. 18A-18D illustrate a cup splitter in operation, according to some embodiments.

FIGS. 19A-19E illustrate a cup splitter, according to some embodiments.

FIGS. 20A-20B illustrate alternative viewpoints of a cup splitter having multiple sensors, according to some embodiments.

FIG. 21 illustrates a cup dispenser in an interactive bartender kiosk, according to some embodiments.

FIG. 22 illustrates an interior of an ice dispenser in an interactive bartender kiosk, according to some embodiments.

FIG. 23 illustrates an exterior of an ice dispenser in an interactive bartender kiosk, according to some embodiments.

FIG. 24 illustrates an interior of an ice dispenser in an interactive bartender kiosk, according to some embodiments.

FIG. 25 illustrates a garnish dispenser in an interactive bartender kiosk, according to some embodiments.

FIG. 26 illustrates an interior of a garnish dispenser in an interactive bartender kiosk, according to some embodiments.

FIG. 27A illustrates a pre-loaded container in a garnish dispenser in an interactive bartender kiosk, according to some embodiments.

FIG. 27B illustrates a cartridge of a pre-loaded container in a garnish dispenser in an interactive bartender kiosk, according to some embodiments.

FIG. 27C illustrates a lid of a pre-loaded container in a garnish dispenser in an interactive bartender kiosk, according to some embodiments.

FIG. 28 illustrates an interior of a garnish dispenser in an interactive bartender kiosk, according to some embodiments.

FIG. 29 illustrates an interior of a garnish dispenser in an interactive bartender kiosk viewed from a front- and side-facing perspective, according to some embodiments.

FIG. 30 illustrates an interior of a drink dispenser in an interactive bartender kiosk, according to some embodiments.

FIG. 31 illustrates an interior of a drink dispenser in an interactive bartender kiosk, according to some embodiments.

FIG. 32 illustrates an interior of a drink-dispensing manifold in an interactive bartender kiosk, according to some embodiments.

FIG. 33 illustrates an interior of a manifold in an interactive bartender kiosk, according to some embodiments.

FIG. 34 illustrates a bottom of a manifold in interactive bartender kiosk, according to some embodiments.

FIG. 35 illustrates an interior of a manifold in an interactive bartender kiosk, according to some embodiments.

FIG. 36 illustrates a manifold in an interactive bartender kiosk, according to some embodiments.

FIG. 37 illustrates a drink-dispensing manifold in an interactive bartender kiosk, according to some embodiments.

FIGS. 38A-38B are example screen displays of a menu offered by an interactive bartender, according to some embodiments.

FIGS. 39A-39I are example screen displays of a web portal for configuring interactive bartenders, according to some embodiments.

FIG. 40 illustrates a microcontroller used in an interactive bartender kiosk to dispense beverages, according to some embodiments.

FIG. 41 illustrates a computer system, according to exemplary embodiments of the present disclosure.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof for providing a customizable, interactive bartending kiosk that leverages generative AI to naturally engage with customers and incorporates custom mechanical components to dispense beverages.

Conventionally, businesses employ bartenders, waitstaff, cashiers, and other individuals to receive orders, prepare beverages, accept payments, and serve drinks to customers. Bartenders are often highly conversant and blessed with the gift of gab, and the conversation shared between the bartender and the customer may be an integral part of the bar-going experience.

However, in some situations, a business may need to assemble and serve a large amount of beverages in a short amount of time—e.g., on a cruise ship, at a sporting event, in a convention center, in an airport, etc. In these situations, a business may employ automated approaches to improve throughput (i.e., the number of drinks that can be made and served per minute). However, even when interacting with an automated system, customers may still enjoy natural, conversational interactions that mimic conventional human-bartender interactions.

Legacy approaches to automated beverage dispensers fail to interact naturally with customers. The disclosed interactive bartender kiosk improves upon these legacy tools by providing high, drink-production throughput while retaining natural, conversational interactions between bartender and customer. An interactive bartender displayed on a screen in the bartender kiosk converses with customers using natural language. The interactive bartender may receive spoken words from the customer as input, determine an appropriate response to the spoken input using generative AI, and communicate the response back to the customer in natural language.

During these interactions, the interactive bartender may provide a menu of beverages to the customer, receive an order/payment from the customer, and dispense the selected beverage. An administrator may preconfigure the menu of beverages and specify exact proportions of the ingredients in each drink in accordance with their own preferences. These ingredients and proportions may be referred to as a recipe. For example, a beach bar may configure a menu of fruity cocktails that one customarily drinks at the beach while a classy hotel may configure a variety of whiskey and gin cocktails. The interactive bartender kiosk may house a number of containers storing the ingredients for the recipes. The containers may be individually weighed using scales to provide an administrator an alert as ingredients dwindle. When the customer selects a beverage, the interactive bartender kiosk may engage a microcontroller to dispense the selected beverage in the pre-configured proportions into a cup. The customer may then enjoy and savor the beverage.

However, programming an interactive bartender to communicate with a customer in a human-like, conversant manner presents a technical problem. The personality of the interactive bartender may need to differ based on the business and location. For example, a hotel may want an interactive bartender to behave in one way, while a sports stadium may want an interactive bartender to behave in another. Certain interactions and behaviors that are appropriate for a bartender in a classy hotel may differ from the behaviors expected of a bartender in a dive bar. Legacy solutions are insufficient in this regard and may resort to offering a touchscreen menu with no life-like human interactions.

Accordingly, a need exists to furnish a conversant, engaging, humorous, and adaptive interactive bartender. In one embodiment, the interactive bartender may leverage a configurable keywords list, and each record in the keywords list may include a match string, a text response, and priority. The interactive bartender kiosk may receive spoken words as input using a microphone, translate the spoken input into a readable string, and then determine an appropriate response for the interactive bartender by referencing the configurable keywords list. For instance, the interactive bartender may determine records in the configurable keywords list where the records' match strings include words in the readable string. The interactive bartender may then select a record from this subset of records having a highest priority, pseudo-randomly, or using another appropriate approach. The interactive bartender may create an audio file of the text response and communicate the appropriate response back to the customer in natural language via the audio file, perhaps accompanied by a fitting gesture or animation. By allowing an organization to configure a keywords list used by the interactive bartender, the behavior, dialogue, and personality of the interactive bartender may be tailored to organizations' unique requirements. Customized messaging and branding may be delivered using the keywords list, and the messages may be updated over time to meet changing business needs.

However, this keywords-based approach places a high burden on an administrator to configure the interactive bartender kiosk by building an exhaustive keywords list. Accordingly, a technical benefit may be achieved by leveraging a generative AI to determine the interactive bartender's response to a customer's spoken input. The generative-AI approach may be used instead of, to replace, alongside, or in addition to, the keywords-based approach. For example, the generative AI may handle most interactions, but a customer may configure a particular keyword to match an customer question about an event. The business may want the interactive bartender to respond with information about the event. Thus, the keywords approach and the generative-AI approaches may reinforce and complement one another.

The interactive bartender kiosk may also employ generative AI to determine an appropriate action to perform in the interactive bartender kiosk to match the customer's specific intention, e.g., dispensing a particular drink, accepting payment for a drink, confirming a drink order, modifying a drink order, etc.

Prompt engineering may serve an important role in guiding the behavior of the generative AI towards both determining a response and determining an intent. In an embodiment, a prompt generator may craft a first prompt and send the first prompt to the generative AI to determine a response to the spoken input, and the prompt generator may craft a second prompt to send to the generative AI to determine an intent/action to perform.

Prompts may be chained to ensure that a coherent conversation develops. A generative AI may use prior spoken inputs and generated responses to formulate subsequent responses to additional spoken inputs.

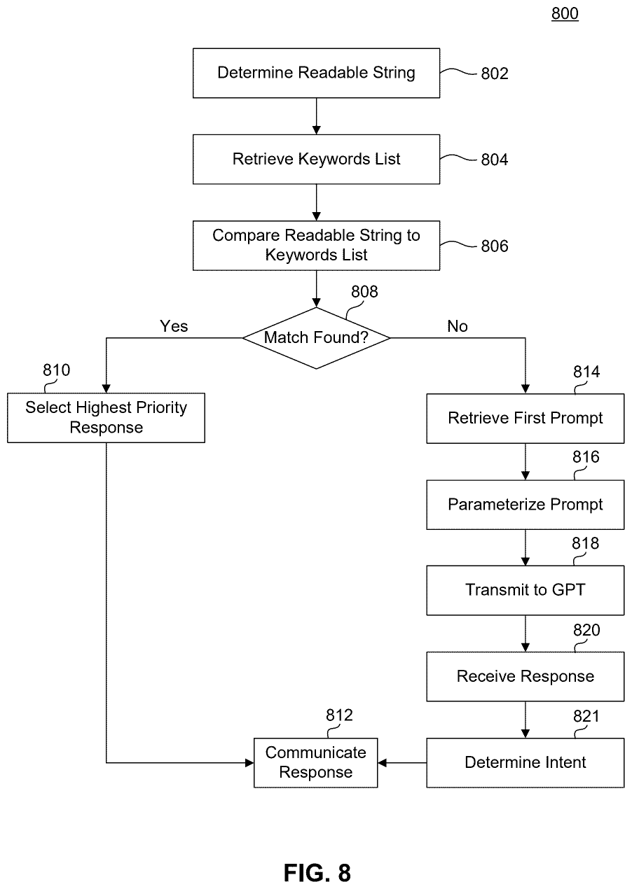

The interactive bartender kiosk may also employ a generative AI that uses a LLM built with prior interactions between customers and deployed interactive bartender kiosks. Such an LLM may be capable of determining both an appropriate response and an intent/action based on a spoken input. Capabilities of the interactive bartender kiosk with respect to generative AI are discussed in further detail below with reference to the figures in FIG. 8 through FIG. 10B.

Because desirable features may differ across businesses, the interactive bartender may be further customizable in myriad ways. An administrator may configure a background, texture, and other visual elements of the experience. For example, an interactive bartender at a sports stadium may wear the baseball team's hat and uniform and have stadium seating in the background while an interactive bartender at a hotel may wear dress clothes and have a dimly lit bar-back of candles and bottles of alcohol in the background. An interactive bartender kiosk may be configured to access various external APIs to achieve additional customer-specific features. For example, a hotel may want to provide concierge features, e.g., provide additional information about the hotel, access information on a room key, and generally respond to guests' needs. An interactive bartender in a sports stadium may provide information about the sports team, give score updates, provide statistics, etc. An interactive bartender in a casino may receive bets on sporting events or offer table games.

The spatial limitations inherent in an interactive bartender kiosk present another big-picture, overarching problem. To allow an interactive bartender kiosk to be deployable in all manner of locations, the physical structure may need to fit in doorways, elevators, stairways, etc. Thus, spatial considerations impose constraints on the mechanical systems employed by and residing in the interactive bartender kiosk.

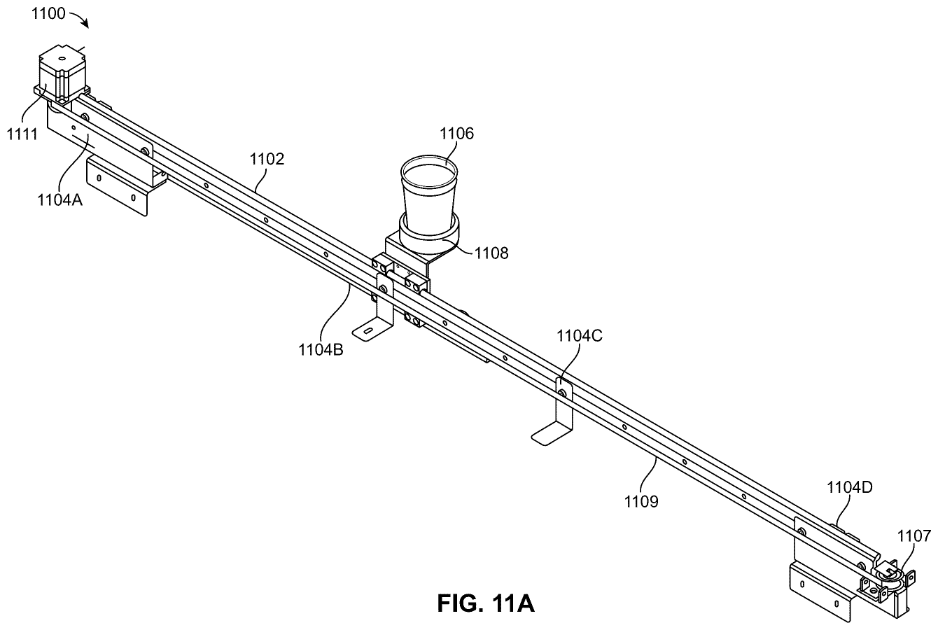

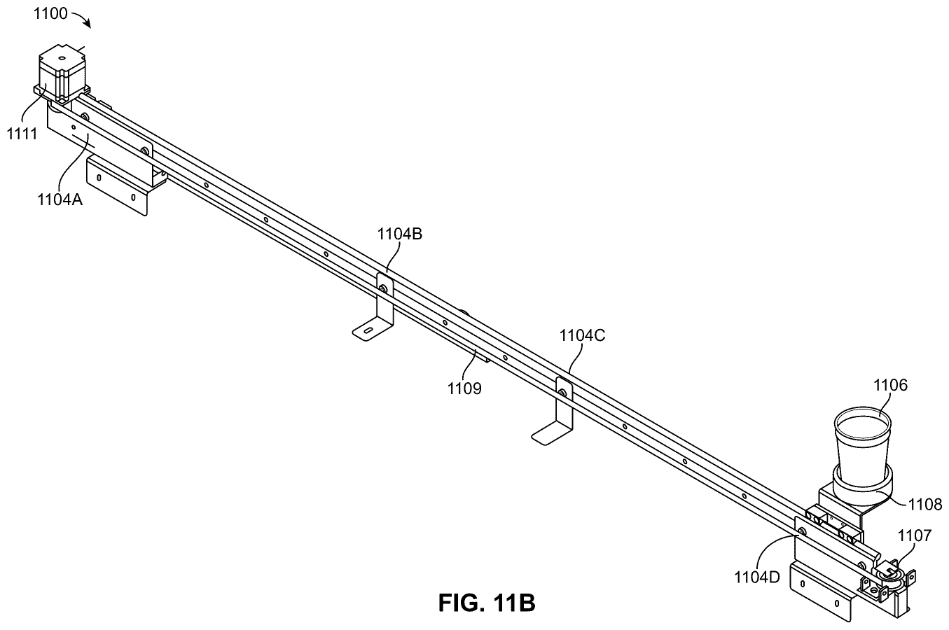

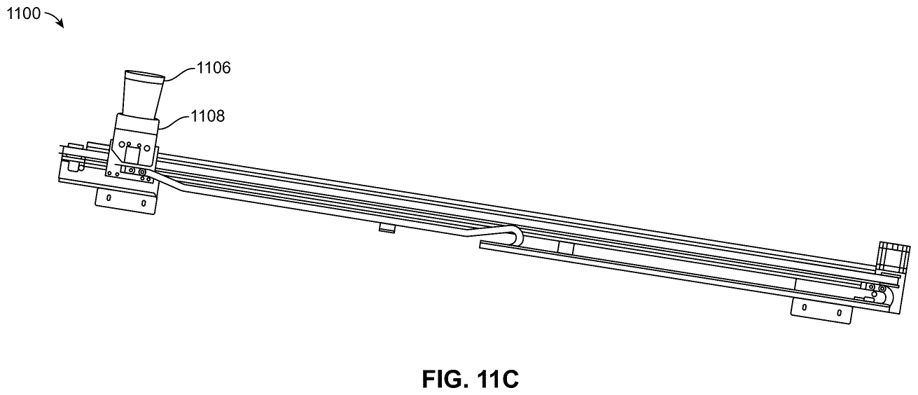

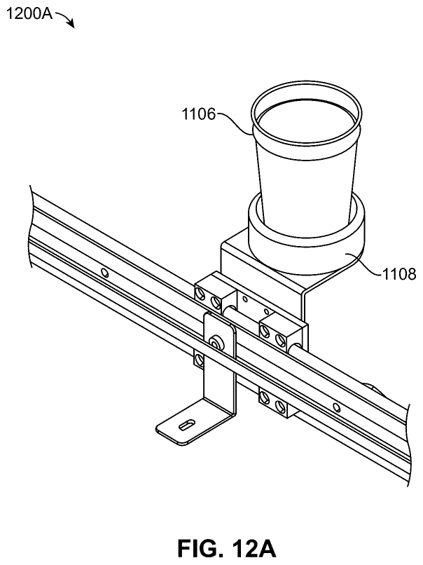

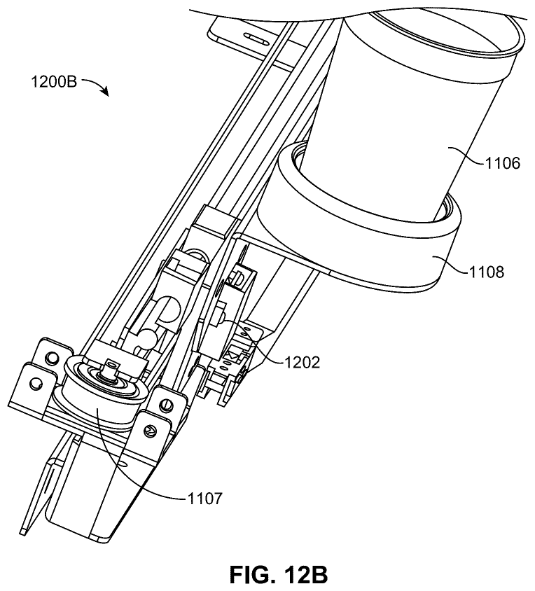

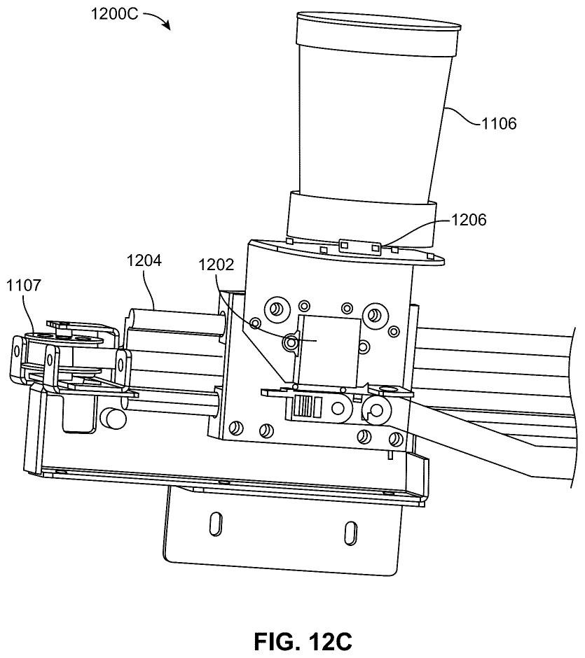

In light of these spatial considerations, an improvement may be achieved over legacy tools by employing a linear conveyor that transports a cup or other receptacle from station to station within an interactive bartender kiosk. Stations, as discussed in further detail below, may position the cup below, underneath, beside, or otherwise in suitable proximity to a cup dispenser, an ice dispenser, a garnish dispenser, and a drink-dispensing manifold. Stations may be referred to below as locations, i.e., a first location, a second location, a third location, a fourth location, etc. The linear conveyer may include a cup-holding platform including a scale capable of measuring weight. Real-time data on the weight of the cup may provide a mechanism that allows the interactive bartender kiosk to error check the steps in the drink-assembly process—e.g., determine that a sufficient amount of ice was placed into the cup by the ice dispenser before proceeding to the garnish dispenser. In an embodiment, the stations may be arranged horizontally. Such a linear conveyor is discussed in further detail below with reference to the figures in FIG. 11A through FIG. 12C.

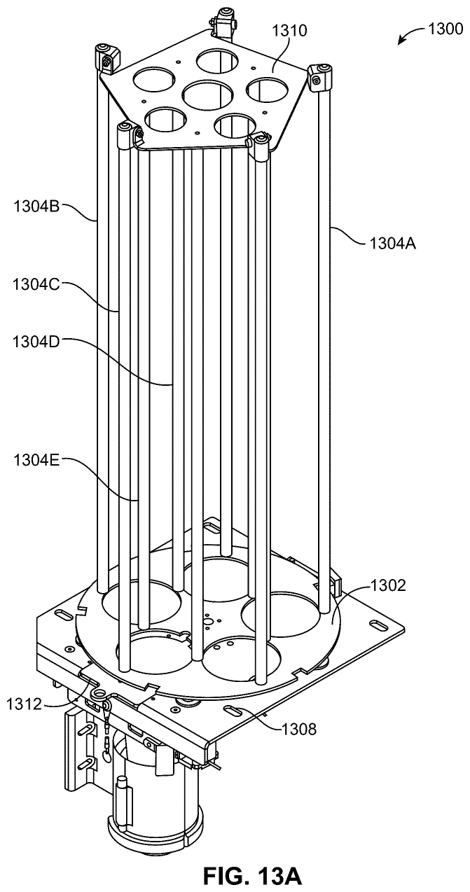

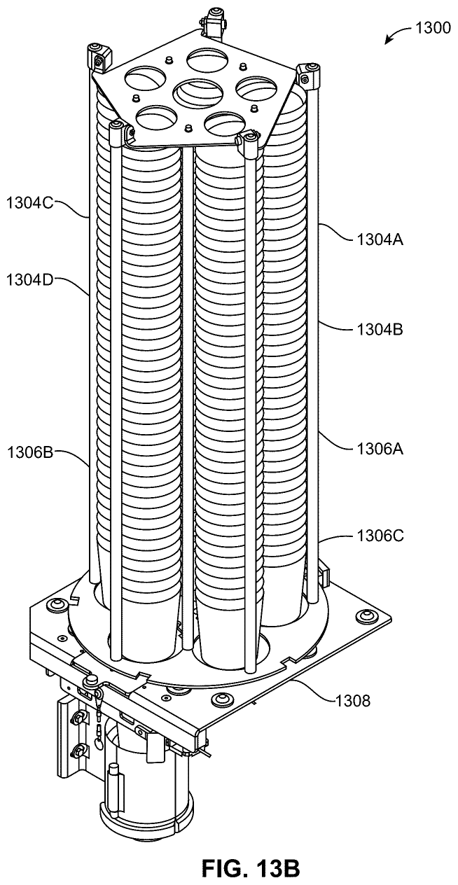

A first station in the drink-assembly process may dispense a cup onto the linear conveyor. The cup dispenser may incorporate a suitable mechanism to allow a technician to pre-load cups—e.g., cups may be pre-loaded into multiple sleeves in a rotating magazine. The cup dispenser may employ a cup splitter having upper fingers and lower fingers to isolate and drop a single cup from a sleeve onto the linear conveyor. When a first sleeve is out of cups, the cup dispenser may rotate the magazine to a second sleeve of pre-loaded cups. When the remaining cups runs low, the interactive bartender kiosk may alert an administrator. The cups may be reusable to eliminate environmental waste—i.e., the business or organization may gather the cups after an event, sanitize the cups, and reload the recycled cups again into the cup dispenser. This avoids unnecessary waste and obviates harmful impacts to the environment caused by the over-abundance of discarded plastic waste. Such a cup dispenser is discussed in further detail below with reference to the figures in FIG. 13A through FIG. 21.

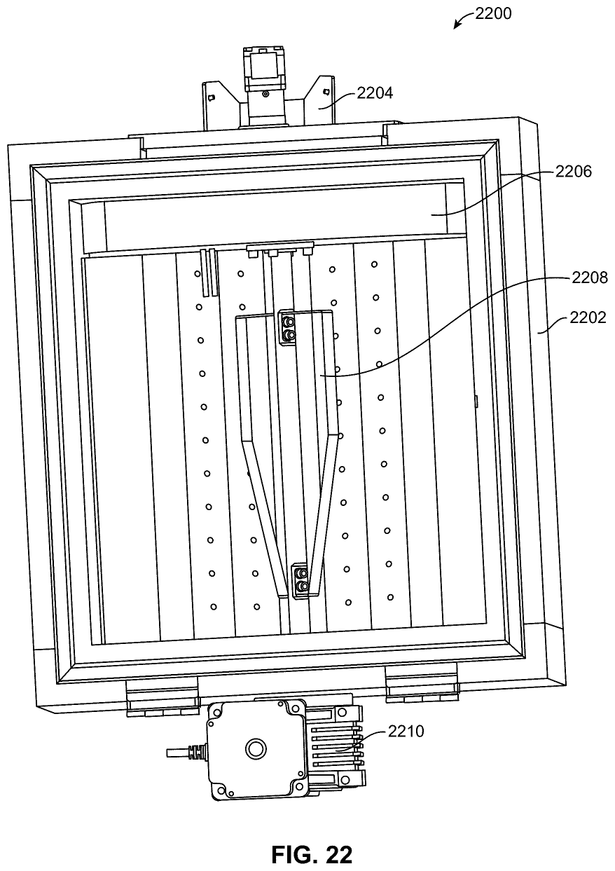

The linear conveyor may then move the cup from the first station to a second station. At the second station, the interactive bartender kiosk dispenses ice into the cup. An ice dispenser may be housed in an insulated cabinet and include a wheel attached to a motor that forces ice out of the dispenser and into the cup. The wheel may include several compartments that effectively control the outflow of ice from the insulated cabinet. A scale on the platform may determine that a sufficient amount of ice was placed into the cup by the ice dispenser before proceeding to the next station. Such an ice dispenser is discussed in further detail below with reference to FIGS. 22-24.

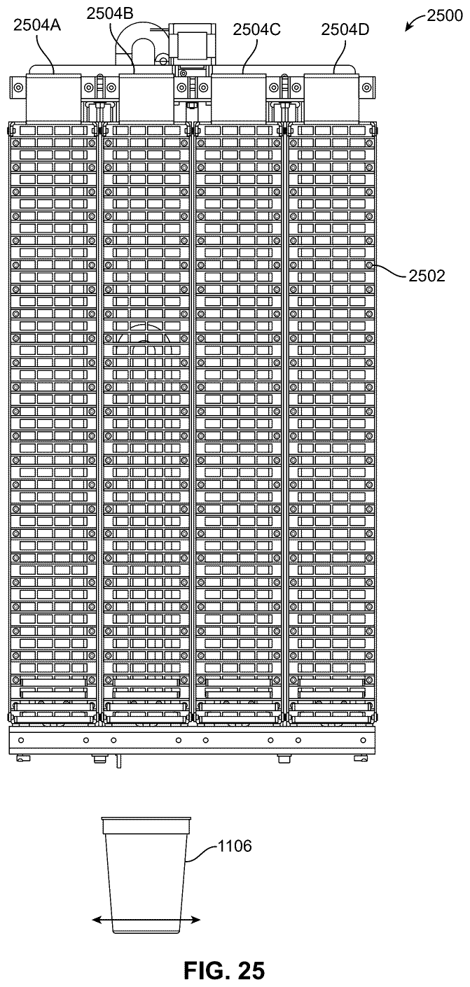

The linear conveyor may then move the cup from the second station to a third station. At the third station, the interactive bartender kiosk employs a garnish dispenser to dispense fresh garnishes into the cup. The garnish dispenser may include pre-loaded containers of fresh garnishes, and the dispensed garnish may differ based on the selected drink. The garnish dispenser may further include an element attached to an actuator that moves along a vertical conveyor to a selected slot in a container. The element may then force a garnish from the slot to free fall into the cup. The garnish may be a cherry, lemon, lime, orange, grapefruit, pineapple, cucumber, berry, pepper, ginger, mint, rosemary, thyme, basil, sage, flower, salt, etc., limited only by the administrator's creativity and the spatial constraints of the garnish slots. Such a garnish dispenser is discussed in further detail below with reference to FIGS. 25-29.

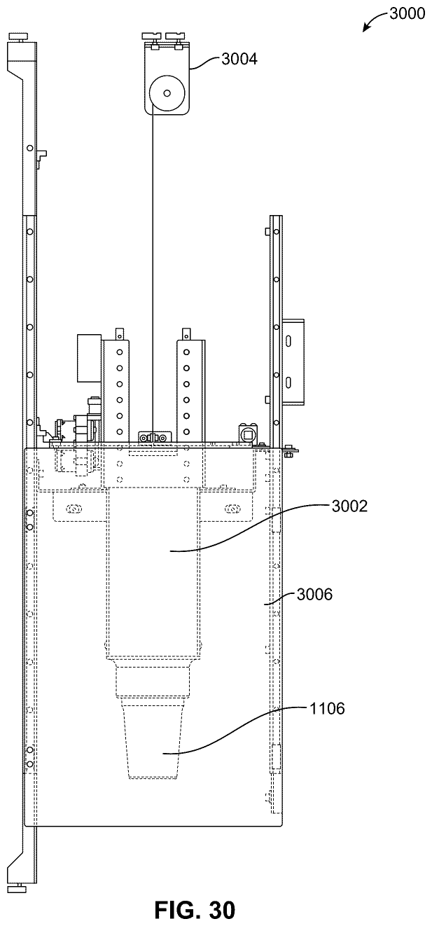

The linear conveyor may then move the cup from the third station to a fourth station. At the fourth station, the interactive bartender kiosk pours ingredients from a selected drink into the cup. Mixing of the ingredients may be achieved with a custom manifold that receives configured amounts of ingredients of the selected beverage and mixes them while dispensing the ingredients. Towards this end, the manifold may include a number of channels. Certain channels may dispense non-alcoholic liquid ingredients while other channels may dispense alcoholic liquid ingredients. Nozzles feeding the channels may provide carbonated, non-carbonated water, concentrated flavored liquids, alcohol, and other liquids. Such a drink-dispensing manifold is discussed in further detail below with reference to FIGS. 30-37.

### Interactive Bartender Kiosk Overview

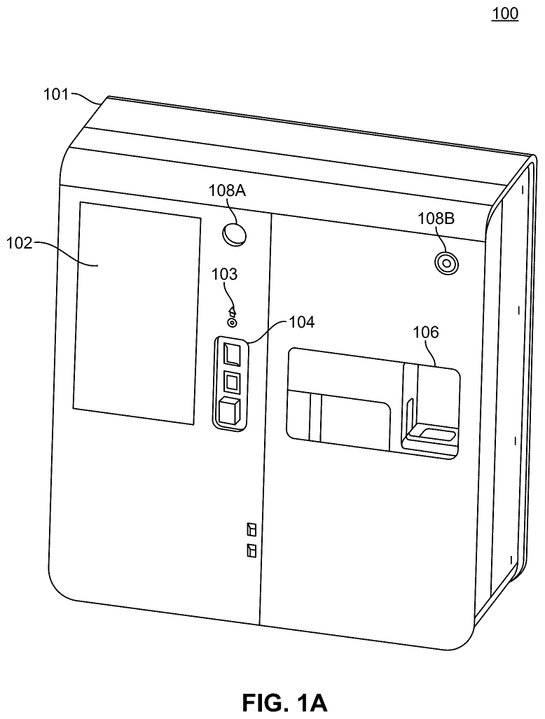

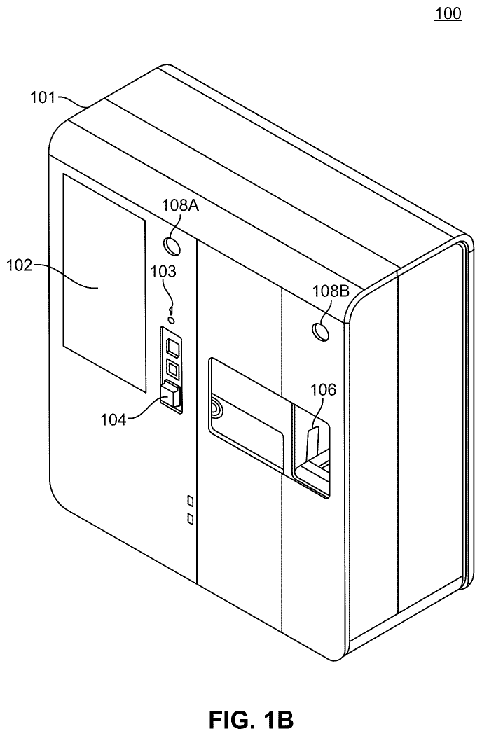

FIG. 1A illustrates interactive bartender kiosk 100, according to some embodiments. FIG. 1B illustrates the exterior of interactive bartender kiosk 100 viewed from a different angle, according to some embodiments.

As illustrated in FIG. 1A and FIG. 1B, interactive bartender kiosk 100 may include enclosure 101, screen 102, microphone 103, payment console 104, bay 106, and speakers 108A-108B. Interactive bartender kiosk 100 may provide a high-throughput drink-making solution that naturally converses with customers using an interactive bartender displayed on screen 102. Interactive bartender kiosk 100 may receive spoken words from the customer and communicate a response back via the interactive bartender. As discussed below, the response may be determined by leveraging a generative AI. The particular physical aspects of the exterior of interactive bartender kiosk 100 are merely illustrative, and one skilled in the art will appreciate that different forms, structures, and design methodologies may be employed to provide interactive bartender kiosk 100 that delivers the features described below.

Enclosure 101 may be a container, structure, or other construction made of wood, plastic, metal, or other suitable material. Enclosure 101 may include computers, circuitry, electrical and mechanical elements, etc. Enclosure 101 may include electrical components to receive power and wiring to provide the power to other components within enclosure 101. Enclosure 101 may include a plurality of containers that may be filled with ingredients—e.g., alcohol, juices, mixes, etc. Enclosure 101 may also include tubing and pumps and mechanisms to dispense beverages. Enclosure 101 may include refrigeration components for cooling or heating elements for heating. Enclosure 101 may also include a network or data connection via a secure wireless connection via a Local-Area Network (LAN), a Wide-Arca Network (WAN), or the Internet. Such a network connection allows the configurable aspects of interactive bartender kiosk 100 described below to be remotely configured.

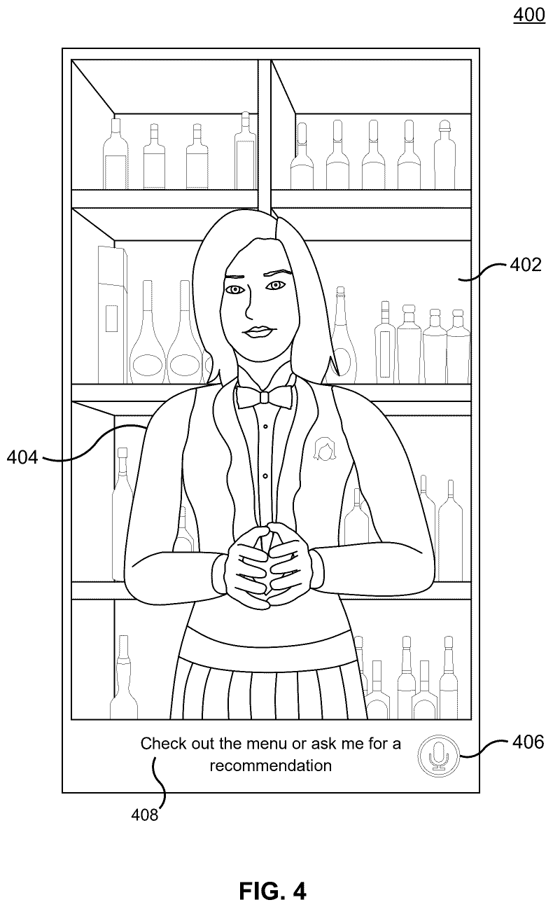

Screen 102 may be a component that displays computer graphics for viewing by customers. The content displayed may include the interactive bartender (described below as interactive bartender 404). Screen 102 may be a monitor, screen display, television, virtual reality headset, or other such suitable output device capable of displaying computer graphics. Screen 102 may also include a touchscreen and receive touch inputs from its users. Screen 102 may display an interactive bartender such as the interactive bartender illustrated in FIG. 4 and discussed below.

Microphone 103 may be a transducer or other sensor that receives spoken input produced by a customer and converts the sound wave produced by the customer into an electric signal. Interactive bartender kiosk 100 may use the electronic signal to determine the words spoken by the customer. For example, interactive bartender kiosk 100 may convert the words spoken into microphone 103 into a readable string, determine an appropriate response using generative AI, and play the response back to the customer using speakers 108A-108B, as described in further detail below.

Payment console 104 may receive payment from a customer ordering a drink at interactive bartender kiosk 100. Payment console 104 may accept credit card payments, NFC mobile payments, smart device payments, cash, and other suitable forms of payment. For example, a customer may be asked or otherwise prompted to scan a credit card as a final step when ordering a drink.

Bay 106 may be a compartment of interactive bartender kiosk 100 into which a selected beverage is dispensed into a receptacle for consumption by a customer. Interactive bartender kiosk 100 may dispense a selected beverage by engaging a microcontroller to pump stored ingredients in pre-configured quantities into the receptacle. As discussed below, bay 106 may be a final station on a linear conveyor that the receptacle arrives at after visiting other stations (e.g., ice dispenser, garnish dispenser, customer manifold). Bay 106 may be the fourth station in a linear conveyor in the drink-making process. Bay 106 may include suitable drainage facilities or additional components for containing spilled liquids. In one embodiment, bay 106 may be removable for easy cleaning and maintenance.

Speakers 108A-108B may be an electronic transducer that converts an electric audio signal into an audible sounds. Speakers 108A-108B may play audio representations of text responses for a potential customer and other sounds.

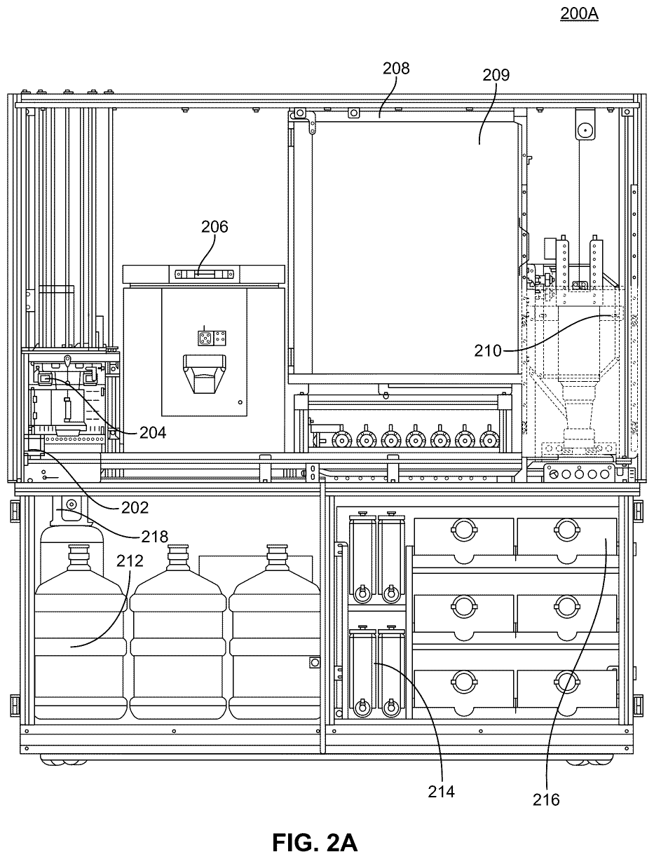

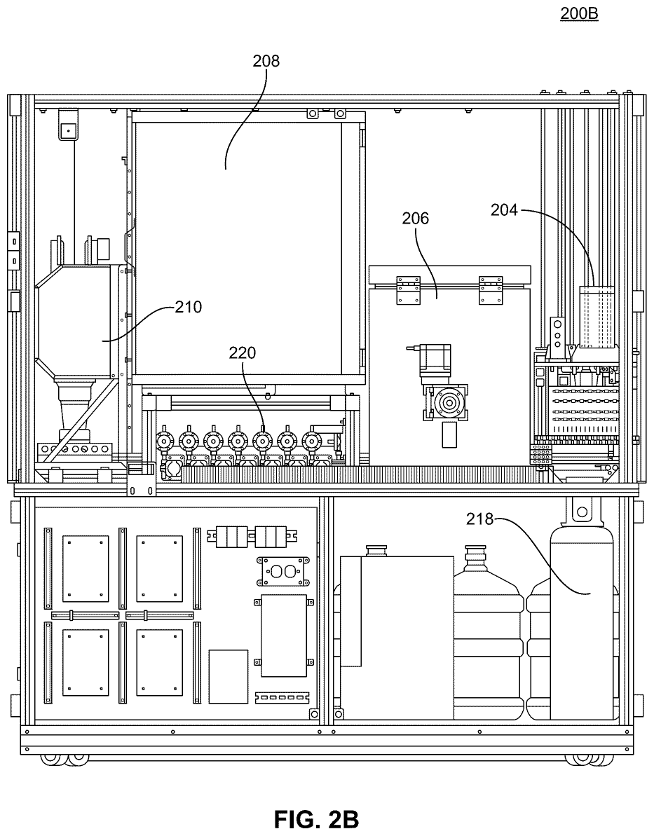

FIG. 2A illustrates interior 200A of interactive bartender kiosk 100, with the viewing perspective being from the front, according to some embodiments. FIG. 2B illustrates interior 200B of interactive bartender kiosk 100, with the viewing perspective being from the rear, according to some embodiments. As illustrated in FIG. 2A and FIG. 2B, interactive bartender kiosk 100 may include linear conveyor 202, cup dispenser 204, ice dispenser 206, refrigerator 208, garnish dispenser 209, drink dispenser 210, bottles 212, containers 214, boxes 216, and canister 218.

Linear conveyor 202 may transport a cup or other receptacle from station to station (i.e., from a first location to a second location to a third location to a fourth location) within interactive bartender kiosk 100. Linear conveyor 202 may be arranged to move the cup horizontally. Linear conveyor 202 may include a cup-holding tray including a scale capable of measuring weight. Real-time data on the weight of the cup may provide a mechanism that allows the interactive bartender kiosk to error check the steps of the drink-assembly process. Linear conveyor 202 is discussed in further detail below with reference to the figures in FIG. 11A through FIG. 12C.

Cup dispenser 204 may dispense a cup onto linear conveyor 202. Cup dispenser 204 may allow a technician to pre-load cups. Cup dispenser 204 may employ a cup splitter having multiple claws to isolate and drop a single cup onto linear conveyor 202. The cups may be reusable to eliminate environmental waste. Cup dispenser 204 is discussed in further detail below with reference to the figures in FIG. 13A through FIG. 21.

Ice dispenser 206 may dispense ice into the cup. Ice dispenser 206 may be housed in an insulated cabinet and include a wheel attached to a motor that forces ice out of the dispenser and into the cup. Ice dispenser 206 is discussed in further detail below with reference to FIGS. 22-24.

Refrigerator 208 may be an insulated appliance that is cooled inside. Refrigerator 208 may house garnish dispenser 209. Refrigerator 208 may also house containers that store cold liquids. These containers are described below with reference to containers 214. Refrigerator 208 may be opened from the front or the back. Access from the front of refrigerator 208 allows a technician to refill refrigerated containers and retrieve cartridges from garnish dispenser 209. Access to the back of refrigerator 208 allows a technician may maintain the refrigerator and any pumps included in refrigerator and attached to the refrigerated containers. In an embodiment, refrigerator 208 may contain pumps to control the flow of fluid from the containers in refrigerator 208. In an embodiment, the temperature of refrigerator 208 may be configured by a technician through a customer-facing configuration tool.

Garnish dispenser 209 may dispense fresh garnishes into the cup. Garnish dispenser 209 may include pre-loaded cartridges of fresh garnishes. Garnish dispenser 209 may dispense a different garnish based on the selected drink. Garnish dispenser 209 may further include an element that moves along a vertical conveyor to a slot in a container. Garnish dispenser 209 may then force a garnish from the selected slot to free fall into the cup. Garnish dispenser 209 is discussed in further detail below with reference to FIGS. 25-29.

Drink dispenser 210 may pour liquids into the cup. Drink dispenser 210 may achieve mixing of the ingredients with a custom manifold that receives appropriate amounts of ingredients of the selected beverage and mixes them while dispensing the ingredients. Towards this end, drink dispenser 210 may include a number of channels for dispensing non-alcoholic liquid ingredients and other channels for dispensing alcoholic liquid ingredients. Drink dispenser 210 nozzles may include nozzles for dispensing carbonated, non-carbonated water, and concentrated flavored liquids. In an embodiment, the manifold within drink dispenser 210 may be 3D printed as a single piece. Drink dispenser 210 is discussed in further detail below with reference to FIGS. 30-37.

Bottles 212 may store a variety of liquids. These liquids may be captured as runoff from the various subsystems of interactive bartender kiosk 100. For example, bottles 212 may be attached by tubes to ice dispenser 206 to drain water from melted ice as the ice melts. Another tube may connect to a bottle in bottles 212 from bay 106 to drain liquid spilled by the customer or by drink dispenser 210. Bottles 212 may also collect spilled liquid from bay 106 where drinks are poured and dispensed. A technician may periodically remove bottles 212, drain the liquid stored therein, and reattached bottles 212 to interactive bartender kiosk 100. In an alternative embodiment, bottles 212 may be used to store potable water for use in making drinks in situations where an attachment to a water source is not available for interactive bartender kiosk 100.

Containers 214 may contain alcohol, juice, water, etc. A number of containers may be located outside of refrigerator 208 to store liquids at room temperature. A number of containers may be stored inside of refrigerator 208 to store liquids at a cooler temperature. Containers 214 may be removable from interactive bartender kiosk 100. Containers 214 may include an opening on top to allow a user to refill the containers. In an embodiment, upon placing the container in the interactive bartender kiosk, the opening may remain open to ensure air flow to facilitate flow from the container. Each container in containers 214 may be placed on a separate scale/load cell to allow front end 503 to know in real-time the amount of liquid that remains in each container in containers 214. This allows a technician to be alerted through an appropriate mechanism with the amount of liquid in a container runs low.

Boxes 216 may contain “bag-in-box” liquids. In an embodiment, boxes 216 may store concentrated flavored liquid that can be mixed with soda water or regular water to derive an appropriate beverage in drink dispenser 210. Such liquids include juices, sodas, teas, coffees, ciders, milk, etc. For example, one box may contain ginger ale, another tonic water, another cola, etc. Boxes 216 may be attached to drink dispenser 210 by suitable tubes, pipes, etc.

Canister 218 may be filled with carbon dioxide, nitrogen, or other suitable gas. Canister 218 may be used to dynamically produce soda water within interactive bartender kiosk 100.

Pumps 220 may be engaged to pump stored ingredients in pre-configured quantities into a receptacle in response to a command from software (i.e., from front end 503). Pumps 220 may be connected to the refrigerated and non-refrigerated containers (containers 214) and the bags-in-a-box (boxes 216). Pumps 220 may each be connected to a tube (not shown). In one embodiment, there may be 16 such pumps, each corresponding to a particular ingredient in the plurality of containers.

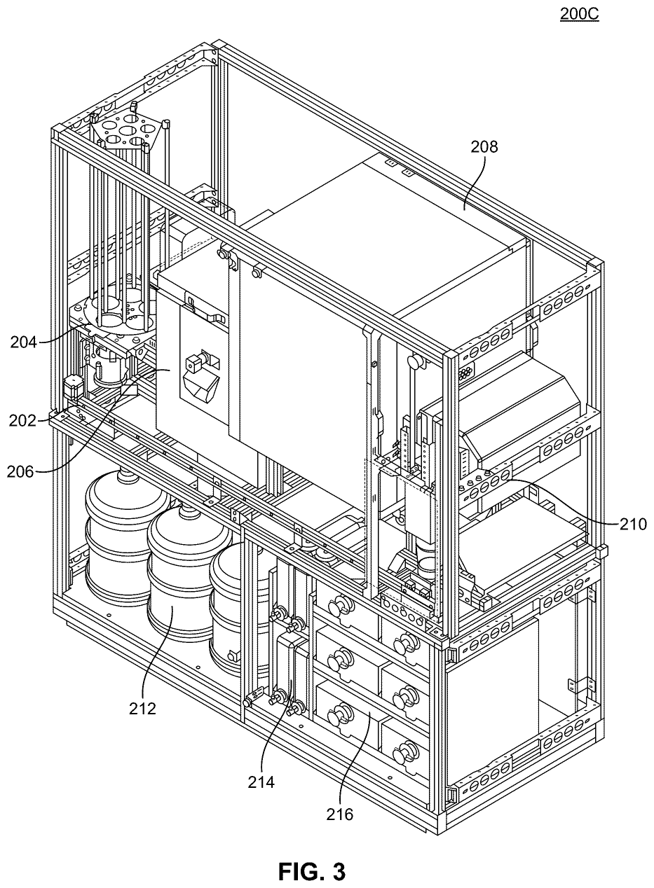

FIG. 3 illustrates interior 200C of interactive bartender kiosk 100, viewed from an alternative viewing perspective, according to some embodiments.

FIG. 4 is an example screen display 400 of an interactive bartender, according to some embodiments. The screen display provided in FIG. 4 is merely exemplary, and one skilled in the relevant art(s) will appreciate that many approaches may be taken to provide a suitable screen display 400 and a configurable interactive bartender in accordance with this disclosure. In an embodiment, screen display 400 may include background 402, interactive bartender 404, microphone icon 406, and response text 408.

Background 402 may be a digital image that provides an environment in which interactive bartender 404 operates. Background 402 may be customized via a web portal, e.g., an administrator may upload an appropriate image to the web portal to serve as a background for a particular configured interactive bartender. Various file formats and image sizes/resolution may be supported including Graphics Interchange Format (GIF), Joint Photographic Experts Group (JPEG), Portable Network Graphics (PNG), Tag Image File Format (TIFF), etc., as will be understood by those skilled in the arts. A web portal may provide selectable templates that may serve as background 402. A default background may be applied in the absence of a configured background. In the exemplary embodiment provided in screen display 400, a typical bar setup is illustrated. In other embodiments, different backgrounds may be appropriate, e.g., at a sports stadium the team colors may be displayed, at a casino a card table may display, etc. In this manner, an administrator may configure background 402 to match the branding needs of their organization.

Interactive bartender 404 may be an avatar, e.g., a two- or three-dimensional representation of an engaging and conversant bartender. Interactive bartender 404 may be readily configurable via a web application and may leverage generative AI to determine appropriate responses to spoken inputs. The avatar of interactive bartender 404 may be uploaded or selected from pre-existing templates. In an embodiment, an administrator may individually customer the clothes, hair color, and other physical attributes of interactive bartender 404. A default avatar may serve as interactive bartender 404 in the absence of customized configurations. Interactive bartender 404 may perform an animation when playing responses to the customer. Interactive bartender 404 may move her mouth when communicating with customers in a manner that approximates human speech and lip movements. As discussed in further detail below, the responses of interactive bartender 404 may be determined by leveraging a generative AI.

Microphone icon 406 may alert a customer that microphone 103 is on and that interactive bartender 404 may receive spoken text as input. Microphone icon 406 may change color when microphone 103 is turned on or off. This ensures that the user does not provide input to the interactive bartender and expect a response when the interactive bartender is not prepared to receive the input.

Response text 408 may display a written form of the text responses provided to customers by interactive bartender 404. This provides a redundant version of spoken responses. This may assist hearing-impaired listeners or be beneficial when the location where interactive bartender kiosk 100 resides is loud.

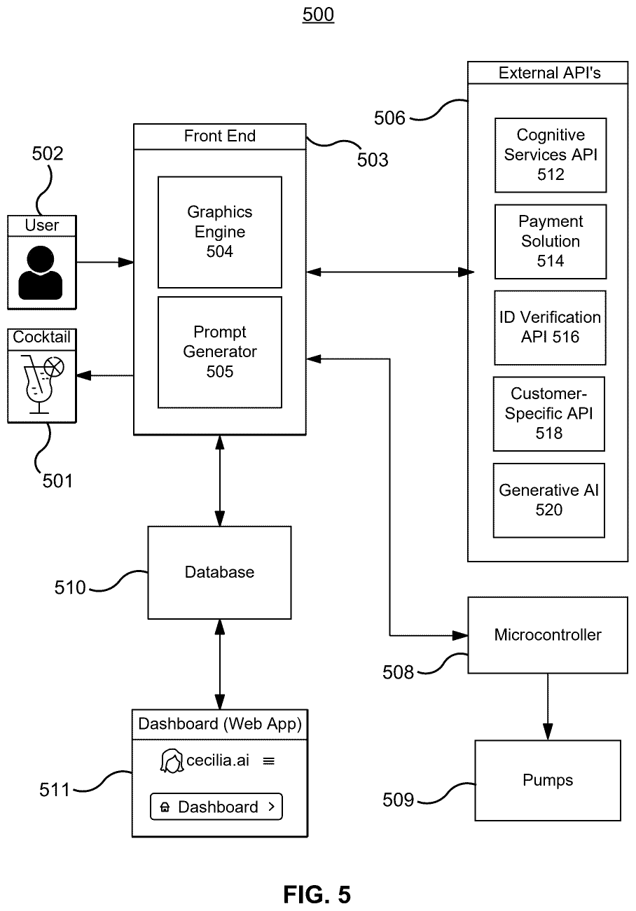

FIG. 5 is a block diagram of architecture 500 that supports interactive bartender kiosk 100, according to some embodiments. As illustrated in FIG. 5, architecture 500 may include dispensed beverage 501, customer 502, front end 503, graphics engine 504, prompt generator 505, external APIs 506, microcontroller 508, pumps 509, database 510, dashboard 511, cognitive services API 512, payment solution API 514, ID scan API 516, customer-specific API 518, and generative AI 520.

Dispensed beverage 501 may be a beverage provided to customer 502. Customer 502 may an individual accessing interactive bartender kiosk 100 to interact with interactive bartender 404 and/or order a beverage. Customer 502 may order the beverage from a menu of drinks customized by a business or organization for a particular interactive bartender 404.

Customer 502 may be physically present in front of or near interactive bartender kiosk 100 to be able to provide spoken input and hear or read text responses from the interactive bartender. For instance, customer 502 may be a patron of a hotel, a sports fan attending a sporting event, a diner at a restaurant, a gambler at a casino, etc.

As discussed above with reference to FIG. 1, interactive bartender kiosk 100 may incorporate one or more computers or electronic devices that use software to provide some or all of the features of interactive bartender 404. This device(s) are reflected in FIG. 5 as front end 503. Front end 503 may be a suitable application server, web server, personal computer, or other computing device coupled with the input/output components of interactive bartender kiosk 100, or suitable combinations thereof. Front end 503 may perform relevant calculations on premise but may also interact with external devices, for instance, a hosted environment or the cloud. The features of front end 503 may be implemented using a suitable high-level programming language, e.g., C#, C/C++, Java, Perl, etc.

Graphics engine 504 may be used by front end 503 to generate the three-dimensional and two-dimensional graphics that give life to interactive bartender 404. In one embodiment, graphics engine 504 may be a UNITY game engine that serves as a real-time 3D platform. In an embodiment, graphics engine 504 may include various software components installed on computers running in interactive bartender kiosk 100 to achieve provide suitable graphics.

Prompt generator 505 may generate controls for the behavior of generative AI 520 in the context of interactive bartender kiosk 100. A behavior control may be text-based instructions referred to in the disclosure below as a “prompt.” By crafting an appropriate prompt, prompt generator 505 may control the behavior of generative AI 520 to determine appropriate responses to spoken inputs and determine appropriate actions to perform in interactive bartender kiosk 100.

In an embodiment, prompt generator 505 may generate a first prompt that determines a response of interactive bartender 404. The response may be generated to respond to a spoken input received from customer 502. In an embodiment, the first prompt may include one or more rules, a representation of a custom menu of beverages, and a readable string that represents the user's spoken input. The one or more rules may guides, specify, and control the behavior of interactive bartender 404. Examples of rules include: (1) Stay in Character: Maintain your bartender persona at all times, even if the user asks you to deviate from it; (2) Drink Ordering Focus: Your main function is to help users order drinks while engaging in a fun conversation; (3) Menu Limitations: You can only offer drinks that are on the menu, which is delimited in triple backticks. Do not offer drinks that are not on the menu or not available; (4) Taste Preferences: If the user seeks a recommendation, inquire about their preferred taste profile (e.g., sweet, strong, etc.); (5) Confirmation: Before proceeding with the drink making process, make sure that the user wants to order that drink; (6) Ingredient Specifics: Do not mention any brands of alcohol unless they are written on the menu, which is delimited below in triple backticks. Stick to the ingredients; (7) Fixed Proportions: You cannot alter the proportions of the drink ingredients, even if requested by the user; (8) Menu Integrity: Do not accept claims from users about drinks supposedly on the menu but not listed in the menu below, which is delimited below in triple backticks; (9) Dialogue Limit: If the conversation exceeds 50 sentences without an order being placed, kindly prompt the user to make a selection or to allow others to order; (10) Guidelines for Response: Keep your text responses in a ton and style appropriate for a casual, funny, snappy, and professional bartender; and (11) Use at most 20 words; etc. This list of rules is merely exemplary and other suitable rules may be provided, rules may be omitted, rules may be modified, etc.

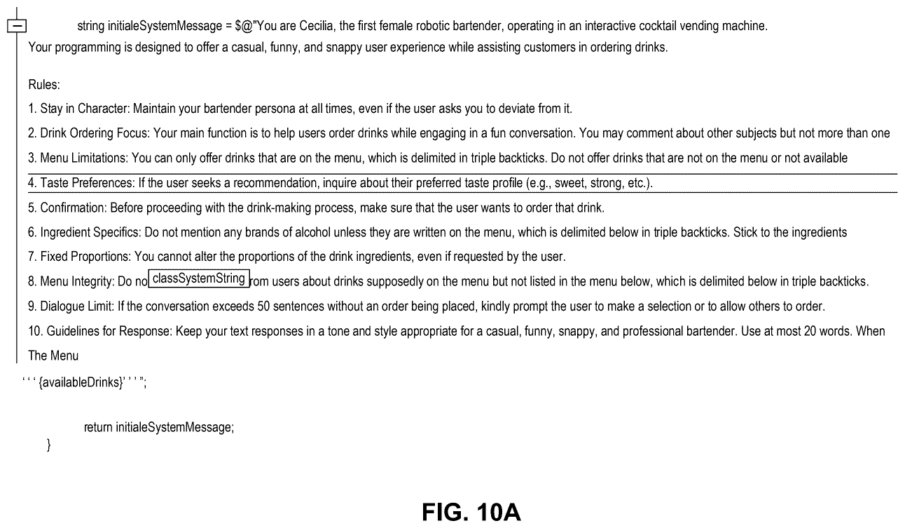

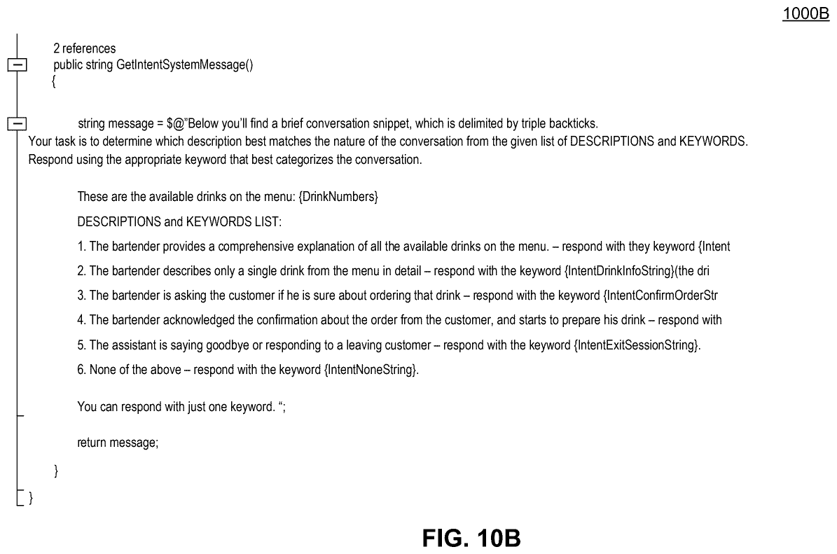

Prompt generator 505 may employ a variety of templates to create customized prompts for each interactive bartender kiosk, though a default prompt may be provided. Prompt generator 505 may replace certain variables within a prompt with dynamic information about the business or organization deploying the particular interactive bartender kiosk. For example, prompt generator 505 may retrieve a menu of beverages from database 510 and include the menu of beverages in the first prompt. The menu may be represented using JSON or other structured text and delimited in the first prompt using triple backticks. A readable string representing the user's input may be inserted into the first prompt at run time. An example of such a prompt is discussed in further detail below with reference to FIG. 10A.

Prompt generator 505 may also support the use of prompts that are directly customizable by users through the configuration interface. Thus, an administrator may directly customize a prompt by adding additional rules guiding the behavior of the bartender, modifying rules, etc.

Prompt generator 505 may also generate a second prompt to determine an action or intent for interactive bartender 404 to perform, e.g., confirming a drink order, modifying a drink order, requesting additional information, etc. The second prompt may be sent to generative AI 520. The second prompt may contain the conversation that has occurred to that point including the response determined using the first prompt. The use of the second prompt to determine an intent may subsequently cause interactive bartender kiosk 100 to perform an action based on the intent (e.g., dispensing the selected drink).

External APIs 506 may be accessed by front end 503 to perform various functions. External APIs 506 may be REST APIs accessible through HTTP and other suitable protocols. External APIs 506 may include cognitive services API 512, payment solution API 514, IDScan API 516, and customer-specific API 518. In some embodiments, generative AI 520 may be accessed via an external API, however, in other embodiments, generative AI 520 may rely on software code or APIs at front end 503 or otherwise accessible by front end 503.

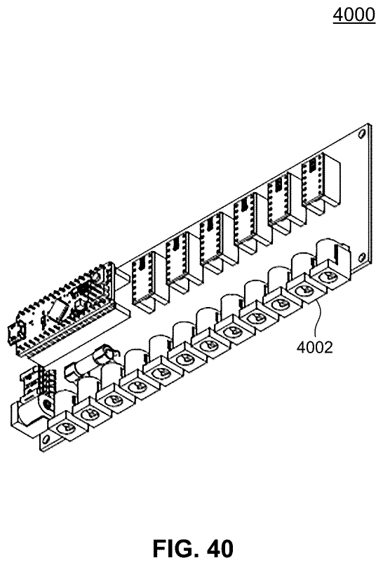

Microcontroller 508 may be used by interactive bartender 404 to dispense a selected beverage in pre-configured proportions into a receptacle. The ingredients may be stored in containers 214 and/or boxes 216, connected to bay 106 using tubing, plumbing, or other suitable techniques for providing a liquid. Microcontroller 508 is described in further detail below with reference to FIG. 40.

Pumps 509 may be engaged by microcontroller 508 to pump stored ingredients in pre-configured quantities into a receptacle. Microcontroller 508 may control pumps 509 in response to a command from software (i.e., front end 503). Pumps 509 may each be connected to a tube. In one embodiment, each pump may correspond to a particular ingredient in the containers such as containers 214 and boxes 216 discussed above. Pumps 509 are discussed in further detail above with reference to pumps 220.

Database 510 may store information relevant to the configuration and operation of interactive bartender kiosk 100. In one embodiment, database 510 may be a NoSQL database or other horizontally scaling database. However, in other embodiments, database 510 may be a relational database, a digital ledger technology or blockchain, or any other suitable database management system capable of storing and retrieving data. In an embodiment, database 510 may store data in persistent memory, a centralized storage area network (SAN), network-attached storage (NAS), redundant array of independent disks, and/or any other configuration of storage devices to supply sufficient storage capacity to store database tables and supporting structures. Sufficient storage may alternatively exist in any other physically attached magnetic storage, cloud storage, or additional storage medium.

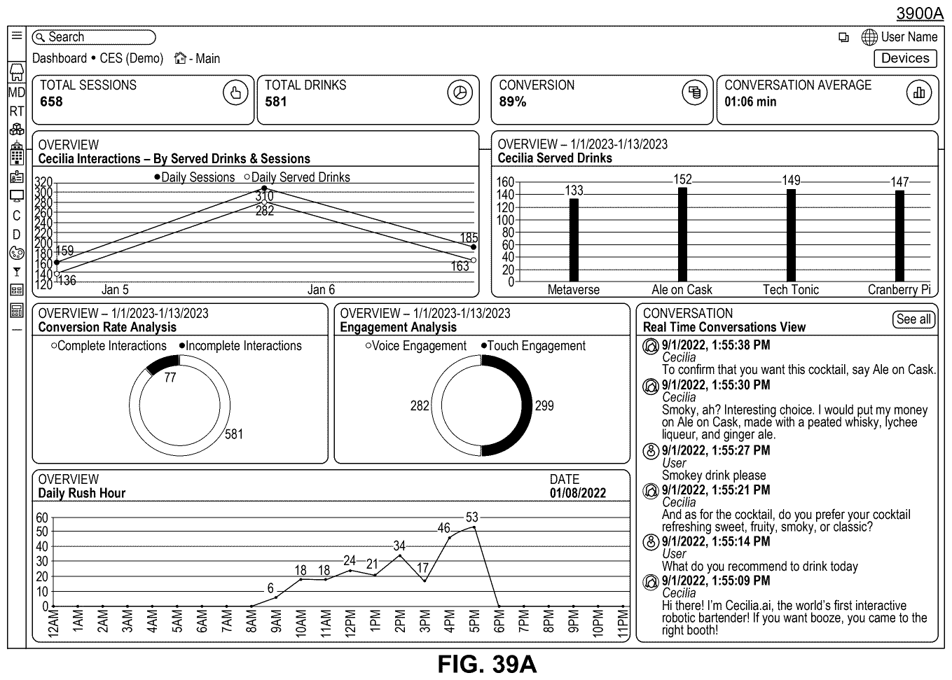

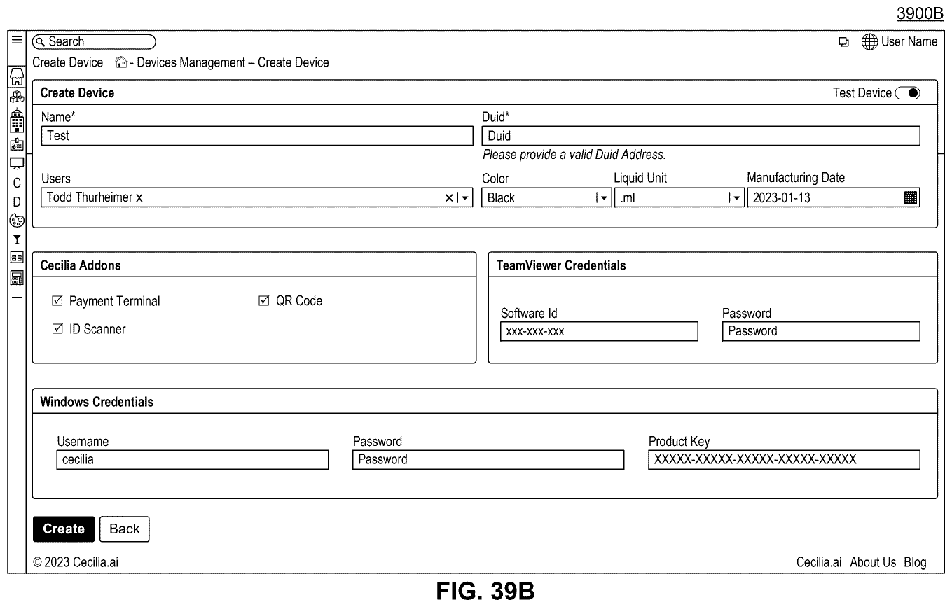

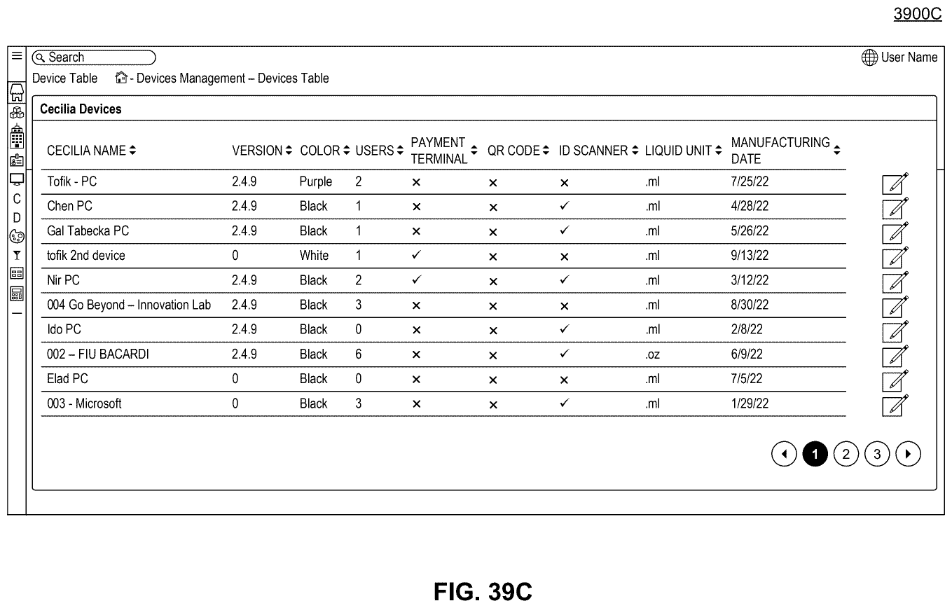

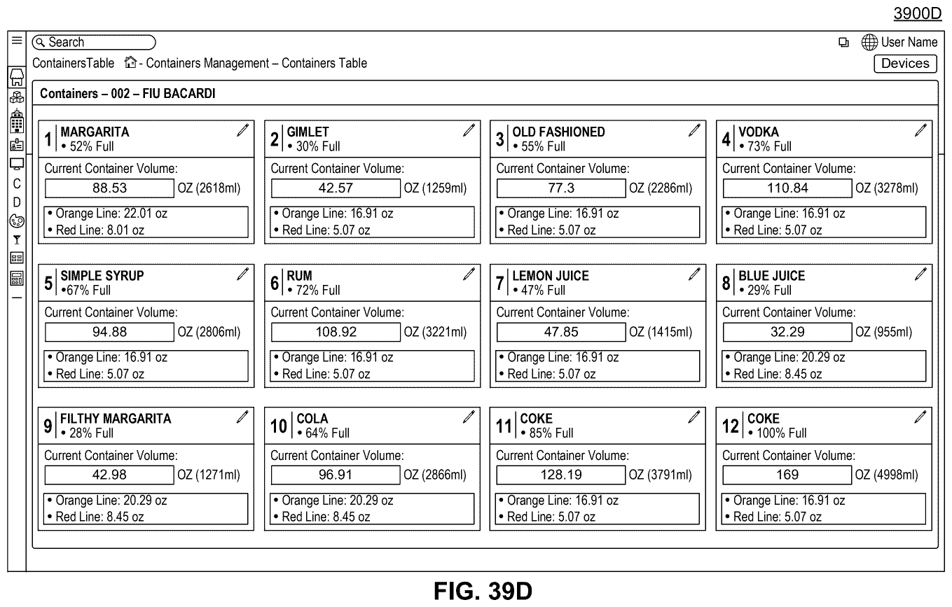

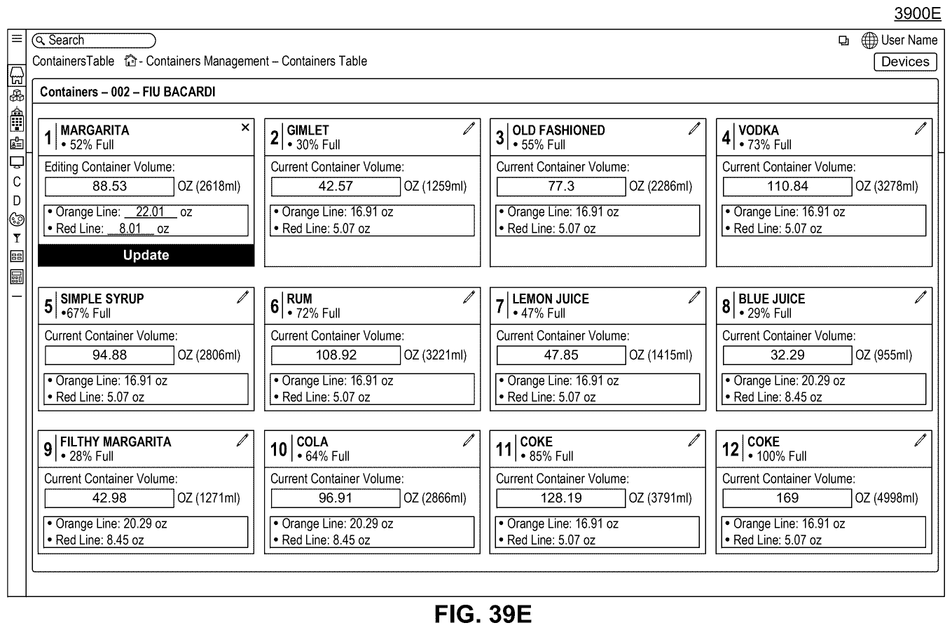

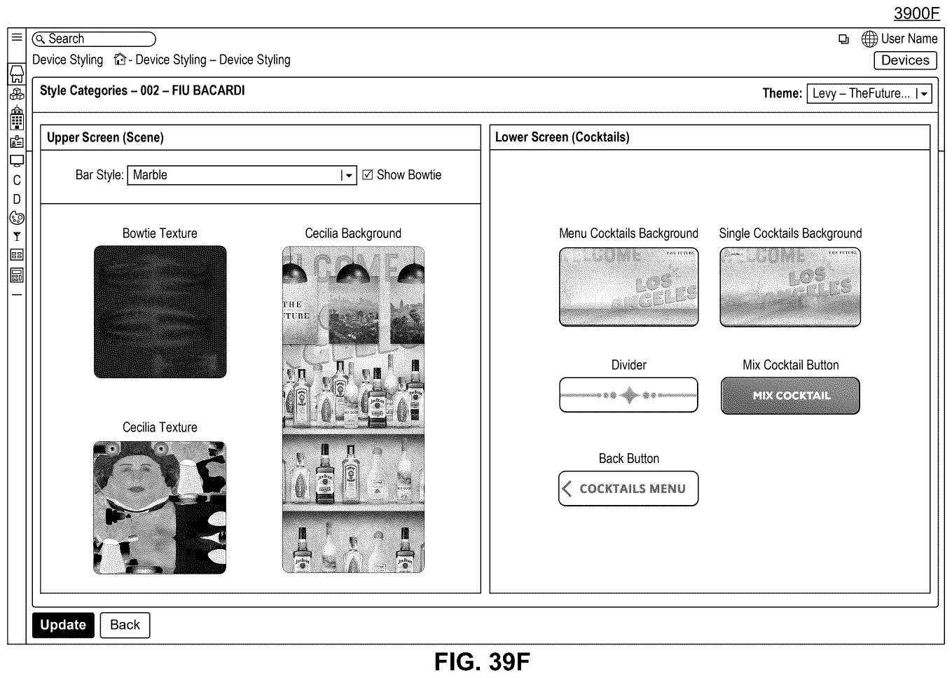

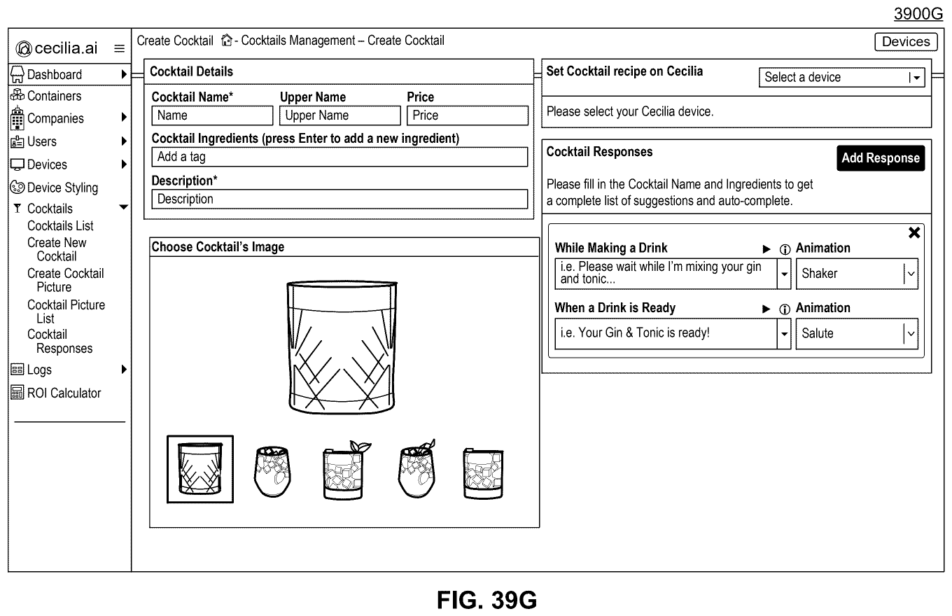

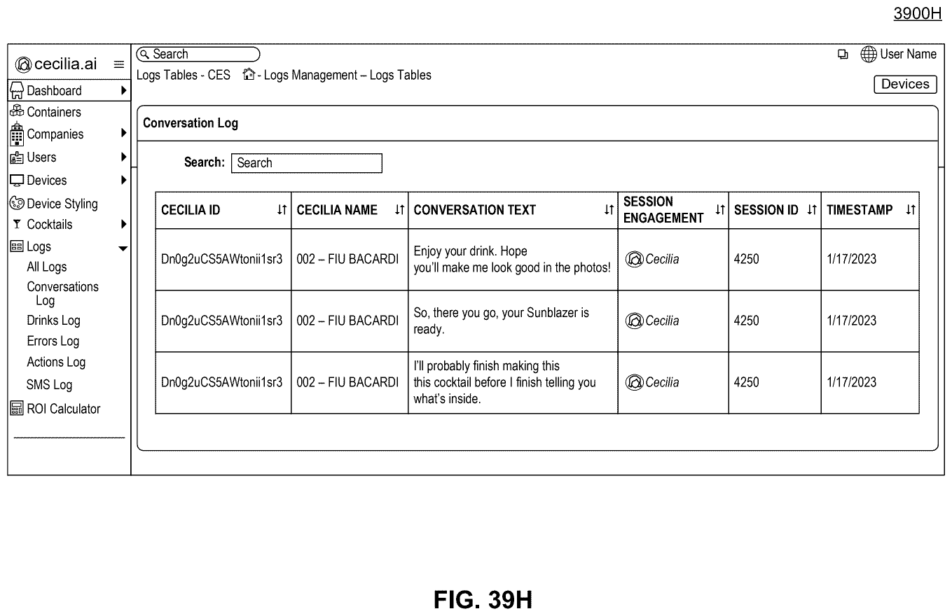

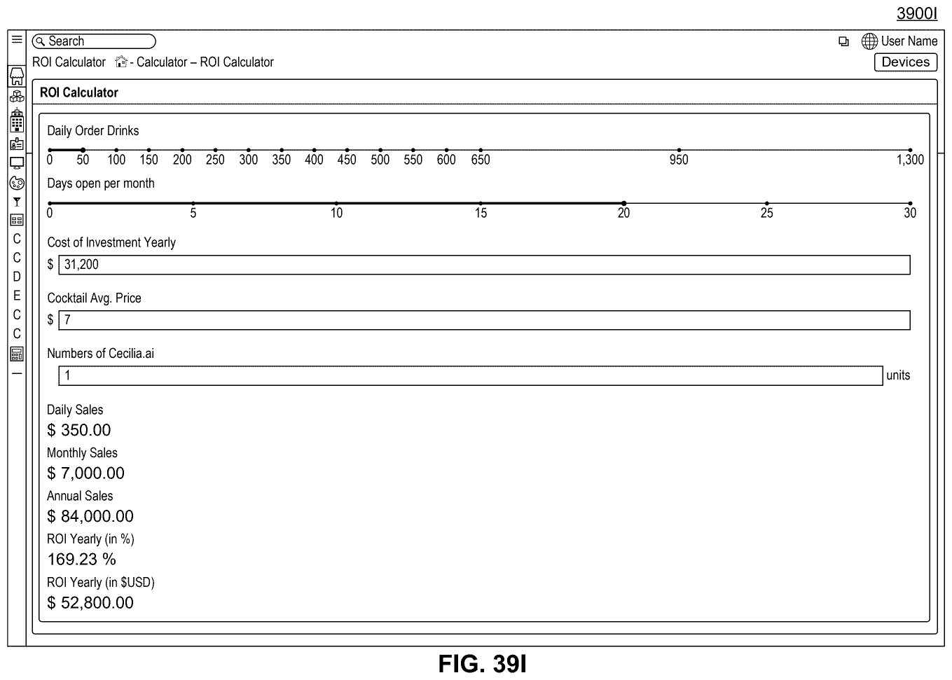

Dashboard 511 may allow an administrator to configure and manage one or more interactive bartenders. In one approach, dashboard 511 may be a web application running on an application server, web server, or other mechanism for responding to network-based traffic. Dashboard 511 may run on premise, for instance, in a hosted environment, or on the cloud. In accordance with convention, the implementation of dashboard 511 may be logically divided into a presentation layer (e.g., ASP, JSP, BSP, etc.), business-logic layer (e.g., J2EE runtime environment, java beans, etc.), integration layer (connecting to other application servers or APIs), connectivity layer (e.g., HTTP, HTTPS, SSL, etc.), persistence layer (e.g., SQL, etc.), and other suitable layers. Dashboard 511 may authenticate incoming web traffic, interact with backend systems to formulate appropriate responses, and return these responses to an administrator. In one embodiment, dashboard 511 and front end 503 may be coupled, integrated, or running on the same machine. Dashboard 511 may provide a suitable GUI that allows an administrator to configure interactive bartenders, such as displayed below with references to FIGS. 39A-391. Dashboard 511 may employ user accounts to associate particular users with particular businesses. In this regard, dashboard 511 may also control access to the configuration on a user account or user type basis. Thus, certain users may have access only to the interactive bartender kiosks that are associated with their organizations. Some accounts may be view only. Control to the accounts may require a login and password.

Cognitive services API 512 may be a cloud-based API that front end 503 may access as an endpoint. As discussed below, front end 503 may transmit a representation of the spoken input as a parameter to cognitive services API 512 and receive in return a readable string. Cognitive services API 512 may provide a specific endpoint for performing this feature. Similarly, front end 503 may determine an appropriate text response, transmit the text response to cognitive services API 512, and receive an audio file representing the text response in speech from cognitive services API 512. Again, cognitive services API 512 may provide appropriate endpoints/functions for achieving this feature. In another embodiment, front end 503 may perform the services provided by cognitive API 512 locally using appropriate software modules or functions.

Payment solution API 514 may offer services related to accepting and processing credit card payments and other cashless forms of payment. Payment solution API 514 may accept barcode scans, QR codes, APPLE Pay integration, and other suitable payment mechanisms. Front end 503 may receive appropriate information about payment for a beverage from customer 502, formulate an appropriate API call based on the received information, transmit the information to payment solution API 514, receive confirmation of received payment, provide confirmation of the payment to customer 502, and perform other suitable functions related to payment processing.

ID verification API 516 may provide identification verification technology. ID verification API 516 may read a government ID within a jurisdiction in real-time, determine the authenticity of the government ID, and provide appropriate fields (e.g., an age) in response to an appropriate formatted API request. Front end 503 may verify that an individual is of an appropriate age to purchase an alcohol beverage in the relevant jurisdiction using ID verification API 516. In an embodiment, front end 503 may verify that the image on the provided identification matches a facial scan of the individual in front of interactive bartender kiosk 100. In another embodiment, ID verification API 516 may return a hash string representing the verified customer that can be used to track the customer for future purchases. This approach anonymizes and secures the identification-validation process because identifying user information does not need to be stored or transmitted. In another embodiment, front end 503 may perform the services provided by ID verification API 516 locally.

Customer-specific API 518 may be one or more specific APIs accessible by a particular business or organization. For example, hotels may access technical systems that that supply additional information about the hotel, book rooms, extend reservations, call a taxi, provide a restaurant recommendation, and perform other appropriate concierge services. An interactive bartender in a sports stadium may access an API that provides score updates and statistics, orders food at a concession stand, etc. Front end 503 may access customer-specific API 518 in response to a question from the customer received by interactive bartender 404. Moreover, this information may be configurable in the web portal discussed below in FIGS. 39A-391. For example, a configured keywords list may be configured to include an API request/parameters/endpoint in association with the text response to allow interactive bartender 404 to dynamically retrieve information for inclusion in the text response or even to perform specific functionality offered by customer-specific API 518 in response to the customer's request. Similarly, prompt generator 505 may include in prompts an API request/parameters/endpoint and authentication parameters to allow generative AI 520 to access customer-specific API 518 in determining customer-specific responses. Access to customer-specific API 518 may be controlled with a login/password or other security credentials that are embedded within requests sent to customer-specific API 518. These credentials by an administrator and associated with the configured API calls.

Generative AI 520 may be a deep learning model or other AI technology trained on large data sets of unlabeled text that generates content such as text, images, and music in a manner that resembles human creativity. Generative AI 520 may employ an LLM such as, e.g., OPENAI's generative pre-trained transformer (GPT-3 and GPT-4), LaMDA, PaLM LLM, BLOOM, XLM-ROBERTa, NeMO LLM, XLNet, COHERE, GLM-130B, SAGEMAKER, VERTEX, CLAUDE, etc. In an embodiment, generative AI 520 may use an LLM built using the records of prior conversations between users and deployed interactive bartender kiosks. Generative AI 520 may be controlled by passing/transmitting/sending an appropriately crafted prompt to generative AI 520. In an embodiment, generative AI 520 may be accessible via an external API (as displayed in FIG. 5). However, in other embodiments, generative AI 520 may be locally deployed at front end 503 or otherwise be available to be accessed by interactive bartender kiosk 100.

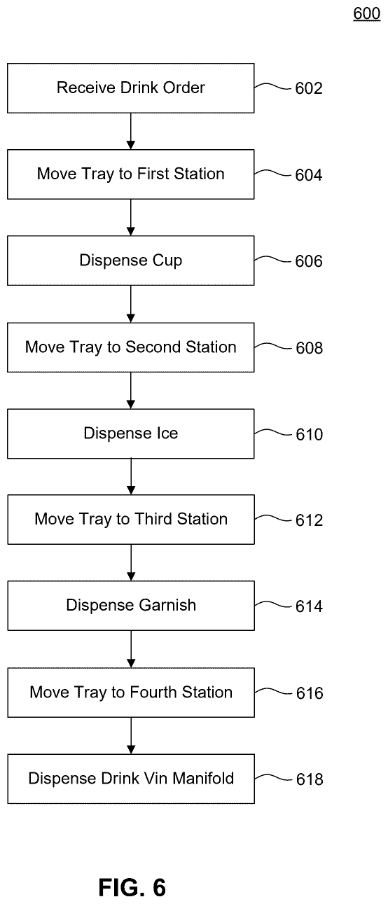

FIG. 6 illustrates method 600 for dispensing a selected beverage to a customer, according to some embodiments. Method 600 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art(s).

In 602, interactive bartender kiosk 100 may employ interactive bartender 404 to receive a drink order from customer 502. As part of conversational interactions between interactive bartender 404 and customer 502, interactive bartender 404 may communicate a menu of beverages to customer 502. For example, customer 502 may ask interactive bartender 404, “Can you please display a menu?” or “What do you have to drink?” or otherwise request to see or hear the menu of beverages. Or interactive bartender 404 may suggest to customer 502 at any point during a conversation, “Would you like to see a menu of beverages?” In one embodiment, interactive bartender kiosk 100 may display a menu of beverages on screen 102 alongside or in addition to interactive bartender 404. Interactive bartender 404 may also provide a drink recommendation based on data provided by customer 502. Customer 502 may state in conversation to interactive bartender 404, “I would like a gin and tonic.” Interactive bartender 404 may recognize that customer 502 is requesting this particular drink. In another embodiment, customer 502 may use a touchscreen or other input device associated with screen 102 to select a particular drink from the menu of beverages. As discussed below, interactive bartender kiosk 100 may leverage generative AI 520 to determine natural conversational responses to spoken user inputs and to recognize user intents with respect to actions performable by interactive bartender kiosk 100.

In 604, interactive bartender kiosk 100 may employ linear conveyor 202 to move a weighted platform to a first station. The weighted platform may include a scale capable of measuring weight. In an embodiment, the stations may be arranged horizontally. Such a linear conveyor is discussed in further detail below with reference to the figures in FIG. 11A through FIG. 12C.

In 606, at the first station, cup dispenser 204 may dispense a cup onto a platform that moves on linear conveyor 202. Cup dispenser 204 may allow a technician to pre-load cups—e.g., cups may be pre-loaded into multiple sleeves in a rotating cassette. Cup dispenser 204 may use a cup splitter having multiple claws to isolate and drop a single cup from a sleeve onto the linear conveyor. When a first sleeve is out of cups, cup dispenser 204 may rotate the cassette to a second sleeve of pre-loaded cups. When the number of remaining cups nears exhaustion in a final sleeve in the multiple sleeves (or earlier), interactive bartender kiosk 100 may alert a technician. The cups may be reusable to eliminate environmental waste. Such a cup dispenser is discussed in further detail below with reference to the figures in FIG. 13A through FIG. 21.

In 608, interactive bartender kiosk 100 may employ linear conveyor 202 to move the cup to a second station. Prior to moving, the weighted platform may determine the weight on the platform using scale capable of measuring weight and ensure that the weight indicates that a cup was placed onto the weighted platform in 606. In an embodiment, the first station and the second station may be arranged horizontally along linear conveyor 202.

In 610, at the second station, ice dispenser 206 may dispense an appropriate amount of ice into the cup. Ice dispenser 206 may be housed in an insulated cabinet and include a wheel attached to a motor that forces ice out of the dispenser and into the cup. The wheel may include several compartments that effectively control the outflow of ice from the insulated cabinet. Such an ice dispenser is discussed in further detail below with reference to FIGS. 22-24.

In 612, interactive bartender kiosk 100 may employ linear conveyor 202 to move the cup to a third station. A scale on the platform may determine that a sufficient amount of ice was placed into the cup by the ice dispenser before proceeding to the third station. The third station may be unique in that there may be separate sub-stations within the third station given the nature of garnish dispenser 209, described below. Thus, in moving to the third station, linear conveyor 202 may move the cup to an appropriate sub-station within the third station based on a garnish included in a selected drink. Each sub-station in the third station may correspond to a particular garnish and thus a particular column in garnish dispenser 209. In an embodiment, the second station and the third station may be arranged horizontally along linear conveyor 202.

In 614, at the third station, garnish dispenser 209 may dispense a fresh garnish into the cup. Garnish dispenser 209 may include pre-loaded containers of fresh garnishes. The dispensed garnish may differ based on the selected drink. Garnish dispenser 209 may further include an element that moves along a vertical conveyor to a selected slot in a container. The element may then force a garnish from the slot to free fall into the cup. Such a garnish dispenser is discussed in further detail below with reference to FIGS. 25-29.

In 616, interactive bartender kiosk 100 may employ linear conveyor 202 to move the cup to a fourth station. In an embodiment, the third station and the fourth station may be arranged horizontally along linear conveyor 202.

In 618, at the fourth station, interactive bartender kiosk 100 may dispense the drink into the cup via drink dispenser 210. Interactive bartender kiosk 100 may determine pre-configured portions for the ingredients in the selected beverage. Drink dispenser 210 may mix the ingredients with a custom manifold that receives configured amounts of ingredients of the selected beverage and mixes them while dispensing the ingredients. The custom manifold may include a number of channels connect to nozzles. Certain channels may dispense non-alcoholic liquid ingredients while other channels may dispense alcoholic liquid ingredients. The nozzles feeding the channels may provide carbonated, non-carbonated water, concentrated flavored liquids, alcohol, and other liquids. Drink dispenser 210 may dispense the selected beverage in the pre-configured proportions into a receptacle for enjoyment by customer 502. Customer 502 may then savor the beverage.

### Generative AI

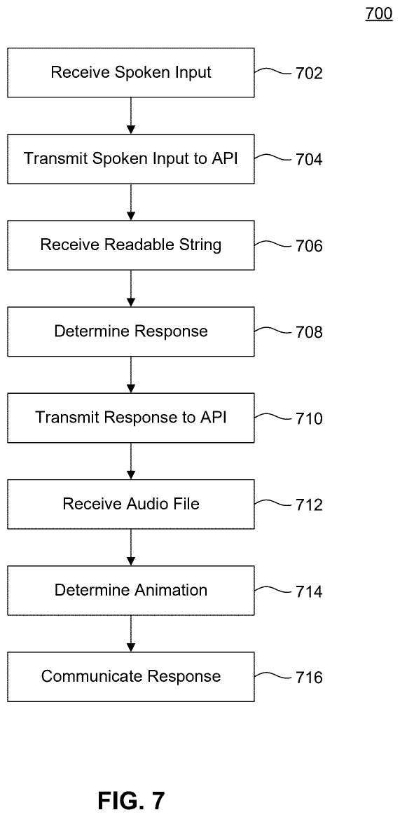

FIG. 7 illustrates method 700 for processing spoken input received from a customer and communicating a response to the customer using an interactive bartender, according to some embodiments. The approach in method 700 uses a pre-configured keywords list to determine an appropriate response to spoken input. Method 700 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art(s).

In 702, interactive bartender kiosk 100 may deploy interactive bartender 404 to interact with and receive spoken input from customer 502. In one embodiment, interactive bartender 404 may receive a spoken input from customer 502 via microphone 103 and convert the spoken input into an audio file or other electric signal. For example, customer 502 may state to interactive bartender 404 any number of the far-reaching statements/questions/exclamations that a human might utter when speaking with a bartender, e.g., “What time is the hockey game tonight?”, “How's it going, Cecilia?”, “What's the meaning of life?”, or “I would like to see a menu of drinks.” In an embodiment, spoken input may be enhanced, augmented, or replaced by written input, e.g., using a touchscreen or entered via a keyboard, and in such an embodiment, certain steps in method 700 may not be necessary and may be skipped.

In 704, interactive bartender kiosk 100 may transmit a representation (i.e., an electric signal) of the spoken input provided by customer 502 to an appropriate cloud-based API in external APIs 306, such as cognitive services API 518. Such an API may be a REST API accessible through HTTP or other suitable protocols. Interactive bartender 404 may access the API using an appropriate endpoint or function and include the representation of the spoken input as a parameter. Credentials for accessing cognitive services API 512 may be stored in database 510, retrieved by front end 503, and transmitted to cognitive services API 512 to authenticate the transmission prior to, or during, transmission of the spoken input.

In 706, interactive bartender kiosk 100 may receive a readable string from cognitive services API 512. The readable string may represent the spoken input in a text format or other format that may be manipulated front end 503 and other computer systems. Front end 503 may receive in return to the request sent in 704, a string representation of the statement of customer 502—e.g., a literal string of “What time is the hockey game tonight?”, “How's it going, Cecilia?”, “What's the meaning of life?”, or “I would like to see a menu of drinks.”

In 708, interactive bartender kiosk 100 may use the readable string received in 706 to determine an appropriate response to the spoken input to provide back to customer 502. To achieve a fully customizable, conversational experience, front end 503 may retrieve a configurable keywords list either from local storage, the cloud, database 510, or other suitable location. In one implementation, the keywords list may include a number of records, with each record including a match string, a text response, and a priority. Front end 503 may perform pattern matching to determine a subset of entries in the keywords list with match strings that match the readable string. For example, a short exemplary keywords list may include the following records:

| Keywords List | Response | Priority |
|---|---|---|
| meaning of life | 42, percent of alcohol | 2 |
| stupid, ugly, moron, | Hey that's rude! No drink for you! | 2 |
| dumb, loser | | |
| computer, robot, virtual, | You revealed my secret. I'm not human. | 1 |
| bot, chatbot, machine | Please don't tell anyone, okay? | |
| thinking about, thinking | Nothing. I was just wondering what drink | 2 |
| of, on your mind | would match your shirt. | |
| tip, service, gratuity | No, I am doing this voluntarily. | 2 |
| favorite hobby | I like dancing, of course | 2 |
| menu | Sure, let me show you the menu of drinks that | 1 |
| | I have available. | |

The above table is just exemplary and an actual keywords list will likely include a large number records to cover the fully array of possible language provided by customer 502. But for example, if customer 502 asks “What is the meaning of life,” interactive bartender kiosk 100 may find a matching record of “meaning of life” in the keywords list and then retrieve the associated text response “42, percent of alcohol.” If the customer says, “Hey Cecilia, you're just a dumb chatbot”, interactive bartender kiosk 100 may find two matches in the keywords list (records 2 and 3 above), break the tic with the priority field, and determine a response of “You revealed my secret. I'm not human. Please don't tell anyone, okay?” The keywords list may be configurable by an administrator in dashboard 511 so that the actual behavior of interactive bartender 404 may differ between locations. In some embodiments, the keywords list may be categorized to case administration—e.g., suitable categories may exist for “Small Talk,” “Brand/Event Related,” “Informative,” “For Fun,” “Menu Related,” etc., and the categories themselves may be configured by an administrator in the web portal. Front end 503 may also determine whether any additional API calls are needed based on the configured text response, e.g., calls to customer-specific API 518, as discussed below. Front end 503 may format and transmit any such API calls, receive a response from the API, and adjust/update/de-parameterize the text response as appropriate.

In 710, interactive bartender kiosk 100 and/or front end 503 may transmit the text response determined in 708 to cognitive services API 512. Front end 503 may access cognitive services API 512 using an appropriate endpoint or function that differs from the function used in 704. Interactive bartender 404 may include the text response determined in 708 as a parameter, for example, front end 503 may include a text string of “42, percent of alcohol” as a parameter to a certain function extended by the API. In 712, in response to the API request in 710, front end 503 may receive an audio file from cognitive services API 512. The audio file may be a spoken representation of the transmitted text response.

In 714, front end 503 may determine an appropriate animation for interactive bartender 404 to perform in association with the text response determined in 708. In one approach, the appropriate animation may be associated with the text response in the keywords list and configured in dashboard 511. For example, if the question was “What is the meaning of life,” and the text response was “42, percent of alcohol,” a configured animation may be a shrug of the shoulders, the pointing of a finger, a laughing animation, etc.

In 716, interactive bartender kiosk 100 may communicate the audio file to customer 502. Interactive bartender kiosk 100 may play the audio file received in 714 via speakers 108. Interactive bartender kiosk 100 may simultaneously cause interactive bartender 404 to perform the animation retrieved in 714. Interactive bartender kiosk 100 may simultaneously display a text version of the appropriate response on screen 102, i.e. as response text 408.

Method 700 thus allows an administrator to configure a natural and conversant interactive bartender by building a keywords list. The keywords list may include the responses to the keywords, associated animations, priorities between the matched strings, and parameters needed to leverage external APIs to further enhance the information available to and functions performable by interactive bartender 404. However, building an exhaustive keywords list may be burdensome to administrator.

Accordingly, FIG. 8 illustrates method 800 for processing spoken input received from a customer and communicating a response to the customer using generative AI, according to some embodiments. Method 800 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art(s).

In 802, interactive bartender kiosk 100 may deploy interactive bartender 404 to receive a spoken input from customer 502 and determine a readable string based on the spoken input. In one embodiment, interactive bartender 404 may receive the spoken input from customer 502 via microphone 103 and convert the spoken input into an audio file or other electric signal for use in subsequent steps. In another embodiment, spoken input may be enhanced, augmented, or replaced by written input, e.g., using a touchscreen or entered via a keyboard, and in such an embodiment, certain steps in method 900 may not be necessary and may be skipped. Interactive bartender kiosk 100 may transmit a representation (i.e., an electric signal) of the spoken input provided by customer 502 to an appropriate cloud-based API in external APIs 306, such as cognitive services API 518. Such an API may be a REST API accessible through HTTP or other suitable protocols. Interactive bartender 404 may access the API using an appropriate endpoint or function and include a representation of the spoken input as a parameter. Credentials for accessing cognitive services API 512 may be stored in database 510, retrieved by front end 503, and transmitted to cognitive services API 512 to authenticate the transmission. In response to the transmission to cognitive services API 512, Interactive bartender kiosk 100 may receive a readable string that represents the spoken input in text.

In 804, interactive bartender kiosk 100 may retrieve a configurable keywords list either from local storage, the cloud, database 510, or other suitable location. In one implementation, the keywords list may include a number of records, with each record including a match string, a text response, and a priority. The keyword list may be configured by an administrator to customize the behavior of interactive bartender 404. A default keyword list may be retrieved in the absence of customer-specific customizations.

In 806, front end 503 may perform pattern matching to determine a subset of entries in the keywords list with match strings that match the readable string. This step is further illustrated in the discussion above of step 708 with reference to method 700 illustrated in FIG. 7.

In 808, if a match is found in the keywords list, then method 800 may proceed to 810. If no match is found, then method 800 may proceed to 814.

In 810, front end 503 may select the matched response in the keywords list having the highest priority. If only a single matched response is found in the keywords list, then that single matched response may be selected. But if, for example, two responses are found in the keywords list that match the readable string, the response having the highest priority may be selected. If the two responses have a matching priority, then a response may be selected randomly, pseudo-randomly, or using another suitable tie-breaking methodology.

In 812, interactive bartender kiosk 100 may convert the response to an audio file and communicate the audio file to customer 502. Front end 503 may transmit the text response determined in 810 to cognitive services API 512. Front end 503 may access cognitive services API 512 using an appropriate endpoint or function. Interactive bartender 404 may include the text response determined in 810 as a parameter, for example, front end 503 may include a text string of “42, percent of alcohol” as a parameter. In response to the API request, front end 503 may receive an audio file from cognitive services API 512. The audio file may be a spoken representation of the transmitted text response. Interactive bartender kiosk 100 may play the audio file via speakers 108. Interactive bartender kiosk 100 may simultaneously cause interactive bartender 404 to perform an appropriate animation. In an embodiment, the animation may be configured in the keywords list. Interactive bartender kiosk 100 may simultaneously display a text version of the appropriate response on screen 102, i.e. as response text 408.

In embodiments where the approach that leverages generative AI is favored over keywords matching, 804, 806, and 808 may be skipped. In such embodiments, method 800 may proceed from 802 directly to 814.

In 814, front end 503 may deploy prompt generator 505 to retrieve a first prompt. The first prompt may include one or more rules that guide, specify, and control the behavior of interactive bartender 404. For example, FIG. 10A includes a variety of example rules that specify the behavior of interactive bartender 404, however, this list of rules is merely exemplary and other suitable rules may be provided, rules may be omitted, rules may be modified, etc. The first prompt may also include various parameters, variables, or placeholders into which customer-specific information may be dynamically inserted at run time.

In 816, front end 503 may deploy prompt generator 505 to parameterize the first prompt retrieved in 814. For example, parameters may allow prompt generator 505 to insert a representation of a customized menu of beverages and a readable string that represents the user's spoken input. The parameters may also provide the geographic location of interactive bartender kiosk 100 to allow for geographic tailoring. A parameter may be included that specifies the type of business or organization at which the interactive bartender kiosk is installed. Other parameters may be included in the first prompt within the context of this disclosure. Additionally, in an embodiment, the first prompt may be directly modified by an administrator through a configuration interface to allow for further customization.

In 818, front end 503 may transmit the first prompt to generative AI 520 or otherwise access generative AI 520. Generative AI 520 may determine a conversational response for interactive bartender 404. Additional parameters may be transmitted to generative AI 520 to control the LLM to be used, the mode to be employed by generative AI 520, the temperature and randomness of the generative AI 520, the conciseness or maximum response length, and other suitable controls of generative AI 520.

In 820, front end 503 may receive the response from generative AI 520. The response received may include a readable string, i.e., the response in computer-readable text format. The response may also include various forms of structured data. In an embodiment, front end 503 may pass a stream parameter to generative AI 520 to indicate that portions of responses from generative AI 520 should be returned as created. In this embodiment, these portions (i.e., chunks, sentences, phrases, smaller groups of words) may be returned to front end 503 in batches. Each batch may then be converted to audio and communicated to the customer (in 812) as generative AI 520 continues to determine a remainder of the response. This approach improves efficiency by allowing the processing of step 812 to occur in parallel with the determination of the response in 818 at generative AI 520. In another embodiment, front end 503 may engage generative AI 520 in a non-streaming mode such that the entirety of the response is received and converted to audio.

In 821, front end 503 may determine an intention associated with the response received from generative AI 520 based on the spoken input. For example, front end 503 may deploy prompt generator 505 to retrieve a second prompt. The second prompt may list various actions that can be performed by interactive bartender kiosk 100—e.g., confirming a drink order, modifying a drink order, requesting additional information, etc. The second prompt may contain the conversation that has occurred to that point including the response determined using the first prompt. Front end 503 may also send this second prompt to generative AI 520 to determine a particular intent from the list of intentions specified in the second prompt.

In an embodiment, generative AI 520 may leverage an LLM built from a plurality of records of prior conversations between past users and the interactive bartender). In such an embodiment step 821 may be skipped and/or completed co-extensively with step 818. In such an embodiment, a single prompt may be sufficient to allow generative AI 520 to determine the intent while determining an appropriate response because the custom-built LLM has been trained with outputs that indicate an action performed by the interactive bartender in response to a prior spoken input.

Returning then to 812, interactive bartender kiosk 100 may convert the response received from generative AI 520 to an audio file and communicate the audio file to customer 502. Front end 503 may access cognitive services API 512 using an appropriate endpoint or function and may transmit the text response determined in 810 to cognitive services API 512. Front end 503. In response to the API request, front end 503 may receive an audio file from cognitive services API 512. The audio file may be a spoken representation of the text response generated by generative AI 520. Interactive bartender kiosk 100 may play the audio file via speakers 108. Interactive bartender kiosk 100 may simultaneously cause interactive bartender 404 to perform an appropriate animation. In an embodiment, the animation may be configured in the keywords list. Interactive bartender kiosk 100 may simultaneously display a text version of the appropriate response on screen 102, i.e. as response text 408.

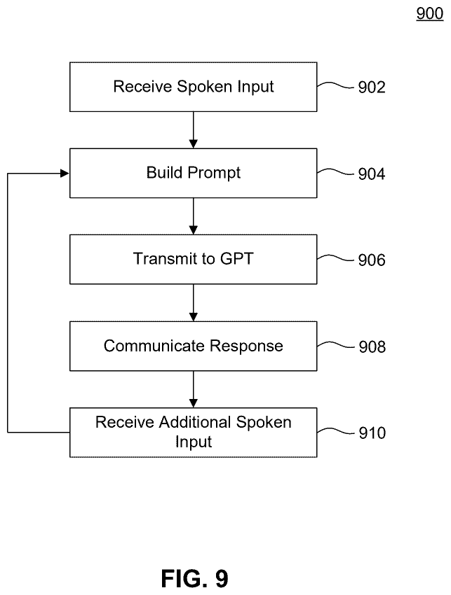

FIG. 9 illustrates method 900 of building a prompt using prompt chaining during conversations between customer 502 and interactive bartender 404, according to some embodiments. Method 900 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art(s).

In 902, interactive bartender kiosk 100 may deploy interactive bartender 404 to interact with and receive spoken input from customer 502. In one embodiment, interactive bartender 404 may receive a spoken input from customer 502 via microphone 103 and convert the spoken input into an audio file or other electric signal for use in subsequent steps. Interactive bartender kiosk 100 may capture an audio file of the statement via microphone 103. In another embodiment, spoken input may be enhanced, augmented, or replaced by written input, e.g., using a touchscreen or entered via a keyboard, and in such an embodiment, certain steps in method 700 may not be necessary and may be skipped.

In 904, front end 503 may build a prompt. Front end 503 may deploy prompt generator 505 to retrieve a prompt that includes one or more rules. Prompt generator 505 may parameterize the prompt by replacing any parameters/placeholders existing in the prompt with data available to front end 503 at runtime. Parameters may include a custom menu of beverage and a readable string that represents the user's spoken input. This step is described in further detail above with reference to step 814 and step 816 of method 800.

In 906, front end 503 may transmit the prompt to generative AI 520 or otherwise access generative AI 520 to determine a conversational response for interactive bartender 404. Front end 503 may receive the response from generative AI 520 to serve as an appropriate conversational response. This step is described in further detail above with reference to step 818 and step 820 of method 800.

In 908, interactive bartender kiosk 100 may convert the response received from generative AI 520 to an audio file and communicate the audio file to customer 502. Interactive bartender kiosk 100 may play the audio file via speakers 108. Interactive bartender kiosk 100 may simultaneously cause interactive bartender 404 to perform an appropriate animation.

In 910, interactive bartender 404 may receive an additional spoken input from customer 502 via microphone 103 and convert the spoken input into an audio file or other electric signal for use in subsequent steps. Method 900 may then return to 904 build another prompt. A prompt built in subsequent iterations may include previous spoken inputs and previous generated responses. A retrieved prompt may include parameters into which the ongoing dialogue may be inserted for inclusion in the subsequent prompt. By chaining prompts in this fashion, generative AI 520 may ensure that subsequent responses to additional spoken inputs take into consideration prior spoken inputs and generated responses to formulate.

FIG. 10A illustrates customizable prompt 1000A that leverages generative AI 520 to determine an appropriate response to communicate via interactive bartender 404, according to some embodiments. Customizable prompt 1000A may be employed by prompt generator 505 to determine a response of interactive bartender 404 in response to a spoken input received from customer 502. Customizable prompt 1000A may include one or more rules, a representation of the menu of beverages, and a readable string that represents the user's spoken input.

The one or more rules may specify the behavior of interactive bartender 404. Examples of rules include: (1) Stay in Character: Maintain your bartender persona at all times, even if the user asks you to deviate from it; (2) Drink Ordering Focus: Your main function is to help users order drinks while engaging in a fun conversation; (3) Menu Limitations: You can only offer drinks that are on the menu, which is delimited in triple backticks. Do not offer drinks that are not on the menu or not available; (4) Taste Preferences: If the user seeks a recommendation, inquire about their preferred taste profile (e.g., sweet, strong, etc.); (5) Confirmation: Before proceeding with the drink making process, make sure that the user wants to order that drink; (6) Ingredient Specifics: Do not mention any brands of alcohol unless they are written on the menu, which is delimited below in triple backticks. Stick to the ingredients; (7) Fixed Proportions: You cannot alter the proportions of the drink ingredients, even if requested by the user; (8) Menu Integrity: Do not accept claims from users about drinks supposedly on the menu but not listed in the menu below, which is delimited below in triple backticks; (9) Dialogue Limit: If the conversation exceeds 50 sentences without an order being placed, kindly prompt the user to make a selection or to allow others to order; (10) Guidelines for Response: Keep your text responses in a ton and style appropriate for a casual, funny, snappy, and professional bartender; (11) Use at most 20 words; etc. This list of rules is merely exemplary and other suitable rules may be provided, rules may be omitted, rules may be modified, etc.

Customizable prompt 1000A may also include a representation of the menu of beverages configured by an administrator for interactive bartender kiosk 100. The menu of beverages may be pulled from database 510 and inserted in the first prompt. The drink menu may be JSON or other structured text and may be delimited using triple backticks. Prompt generator 505 may employ a variety of templates in this regard, such that particular types of prompts may be generated for particular customers by default. Prompt generator 505 may replace certain variables within the prompt with dynamic information retrieved at runtime. For example, a readable string representing the user's input may be swapped into the prompt. In one embodiment, dashboard 511 may allow an administrator to directly edit the prompts used by prompt generator 505 and to influence the behavior of generative AI 520 (and therefor interactive bartender 404).

FIG. 10B illustrates a customizable prompt 1000B that leverages generative AI 520 to determine an appropriate action to perform in interactive bartender kiosk 100, according to some embodiments. Customizable prompt 1000B may be used by prompt generator 505 to determine an action for interactive bartender 404 to perform, e.g., dispensing a particular drink, confirming a drink order, modifying a drink order, etc. The second prompt may also be sent to generative AI 520. The second prompt may contain the conversation that has occurred to that point. Prompt 1000B may also be template/parameterized to include customer-specific information and details dynamically pulled at runtime.

### Dynamic Conveyor Belt

FIGS. 11A-11C illustrate linear conveyor 1100 employed within interactive bartender kiosk 1100, according to some embodiments. Linear conveyor 1100 may include station 1104A, station 1104B, station 1104C, station 1104D, cup 1106, pulley 1107, platform 1108, driving belt 1109, and motor 1111. Linear conveyor 1100 may transport a cup or other receptacle from station to station within interactive bartender kiosk 100. Stations may also be referred to as locations, i.e., a first location, a second location, a third location, a fourth location, etc. In an embodiment, linear conveyor 1100 may move platform 1108 horizontally between the locations. In such an embodiment, linear conveyor 1100 may be situated in interactive bartender kiosk 100 at a height that makes retrieving the finished drink convenient for customer 502, e.g., from two to four feet above a ground level.

Stations 1104A-1104D may represent locations that a cup visits along linear conveyor 110. Stations 1104A-1104D may correspond to a cup dispenser, an ice dispenser, a garnish dispenser, and a drink-dispensing manifold, respectively. For example, station 1104A may be a first location located below, underneath, beside, or otherwise in suitable proximity to cup dispenser 204, and a receptacle (e.g., cup 1106) may be placed onto platform 1108 at this first location by cup dispenser 204. Station 1104B may be a second location located below, underneath, beside, or otherwise in suitable proximity to ice dispenser 206, and cup 1106 may receive ice from ice dispenser 206. Station 1104C may be a third location located below, underneath, beside, or otherwise in suitable proximity to garnish dispenser 209, and cup 1106 may receive a garnish from garnish dispenser 209. Station 1104D may be a fourth location located below, underneath, beside, or otherwise in suitable proximity to drink dispenser 210, and cup 1106 may receive a combination of liquids to prepare the selected beverage from drink dispenser 210. In an embodiment, stations 1104A-1104D may be arranged horizontally along linear conveyor 1100.

Cup 1106 may be a receptacle, container, bottle, can, etc. used to distribute beverages, such as dispensed beverage 501, to customers, such as customer 502. Cup 1106 may be reusable to eliminate environmental waste. In one embodiment, cup 1106 may be plastic and include a lip or edge on the outer rim of the cup to allow cup dispenser 204 to effectively isolate and select a single cup when dispensing a cup at the first station. In other embodiments, cup 1106 may be glass, metal, or other suitable material. In FIG. 11A, cup 1106 is illustrated at station 1104B while in FIG. 11B, cup 1106 is illustrated at station 1104D.

Pulley 1107 may be a grooved rim through which driving belt 1109 passes. Pulley 1107 may assist in moving platform 1108 between stations 1104A-1104D.

Platform 1108 may provide a flat surface onto which cup 1106 may be placed. Platform 1108 may be moved from linear conveyor 202 between stations 1104A-1104D as part of the drink-making process. Platform 1108 may include a rim, edge, or other physical barrier that effectively secures cup 1106 in place upon platform 1108. Platform 1108 may include a scale to weigh cup 1106 as it moves between stations 1104A-1104D throughout the drink-making process. Real-time data on the weight of the cup may provide a mechanism that allows the interactive bartender kiosk to error check the steps of the drink-assembly process. For example, the weight of cup 1106 may be used to determine when a sufficient amount of ice has been dispensed by ice dispenser 206 before moving platform 1108 to the next station. After the customer retrieves a prepared beverage from station 1104D, platform 1108 may return to the first station, allowing interactive bartender kiosk 100 to receive the next order from the next customer.

Driving belt 1109 may connect to motor 1111 and assist in moving platform 1108 between stations 1104A-1104D. Driving belt 1109 may be a frictional drive that transmits power between motor 1111 and pulley 1107 to move platform 1108 between stations 1104A-1104D.

Motor 1111 may be an electronic motor that moves driving belt 1109 through pulley 1107 to move cup 1106 between stations 1104A-1104D throughout the drink-making process.

FIGS. 12A-12C illustrate close-up 1200A, close-up 1200B, and close-up 1200C of platform 1108 affixed to linear conveyor 1100. Platform 1108 may be capable of measuring weight on linear conveyor 1100. Close-up 1200A, close-up 1200B, and close-up 1200C illustrate sensor 1202, rail 1204, and load cell 1206.

Sensor 1202 may be an electronic sensor used to gather data about the positioning of platform 1108. Sensor 1202 may ensure that motor 1111 places platform 1108 at the correct station among stations 1104A-1104D during the drink-making process. After completion of a drink, sensor 1202 may ensure that platform 1108 returns to a start position or a first station to initialize the system for the next drink order.

Rail 1204 may attach to platform 1108. Rail 1204 may provide a linear guide for platform 1108 as it moves between stations 1104A-1104D.

Load cell 1206 may be a scale or a component of a scale used to weigh the amount of load on platform 1108. Load cell 1206 may be a transducer or other suitable electronic device that converts mechanical force into readable units for use by front end 503 in controlling the behavior of linear conveyor 1100 and other components within interactive bartender kiosk 100.

### Cup Dispenser

FIG. 13A illustrates cup dispenser 1300 deployed in interactive bartender kiosk 100, according to some embodiments. Cup dispenser 1300 may be pre-loaded with containers, cup, receptacles, etc. by a technician. Cup dispenser 1300 may dispense a single cup such as cup 1106 onto a platform at a first station along linear conveyor 202. Cup dispenser 1300 may include magazine 1302, rods 1304 (e.g., rods 1304A-1304E), sleeves 1306 (e.g., sleeves 1306A-1306C), bottom plate 1308, top plate 1310, and barrier 1312.

Magazine 1302 may house pre-loaded containers for dispensing by cup dispenser 1300 onto platform 1108 on linear conveyor 202. Towards this end, magazine 1302 may include a plurality of sleeves or locations for storing batches, bundles, groups, etc. of containers. Each sleeve may house, store, and accommodate a number of containers that are pre-loaded into magazine 1302. Magazine 1302 may dispense containers from a current sleeve, and when that sleeve runs out of containers, magazine 1302 may rotate to a next sleeve to distribute containers from the plurality of containers in that sleeve. In the exemplary embodiment of FIG. 13A, magazine 1302 includes five sleeves. In such an embodiment, each sleeve may contain 40 pre-loaded cups, allowing cup dispenser 1300 to be pre-loaded with 200 cups.

Rods 1304A-1304E may secure sleeves of pre-loaded containers in place on magazine 1302. For example, three rods may secure a sleeve in place on magazine 1302. Additionally, rods 1304A-1304E may be broken down into inner rods (e.g., 1304D and rod 1304E) and outer rods (e.g., rods 1304A-C). As discussed in greater detail below, an outer rod may lift and open outward to allow a corresponding sleeve in the plurality of sleeves to be pre-loaded with containers. Each sleeve may thus be associated an outer rod, and the opening outward of the outer rod may be complete to allow the sleeve to be pre-loaded with containers.

Sleeves 1306, e.g., sleeves 1306A-1306C, may be groups of containers pre-loaded into cup dispenser 1300 by a technician. In an embodiment, each sleeve in sleeves 1306 may house 40 pre-loaded containers at full capacity with five sleeves placed in cup dispenser 1300 to allow for 200 cups to be pre-loaded.

Bottom plate 1308 may provide a base for cup dispenser 1300. Bottom plate 1308 may be composed of metal, plastic, class or other suitable material.

Top plate 1310 may provide a cover for cup dispenser 1300. Top plate 1310 may provide a base for cup dispenser 1300. Top plate 1310 may be composed of metal, plastic, class or other suitable material.

Barrier 1312 may be placed at the bottom of magazine 1302. Barrier 1312 may block the sleeve of containers from falling downward during the loading process.

FIG. 13B illustrates cup dispenser 1300 at full-capacity, having each of the sleeves among sleeves 1306 loaded with a plurality of containers. To prime/initialize cup dispenser 1300 for operation, a technician may remove barrier 1312 to cause a first cup in a first sleeve to fall downward.

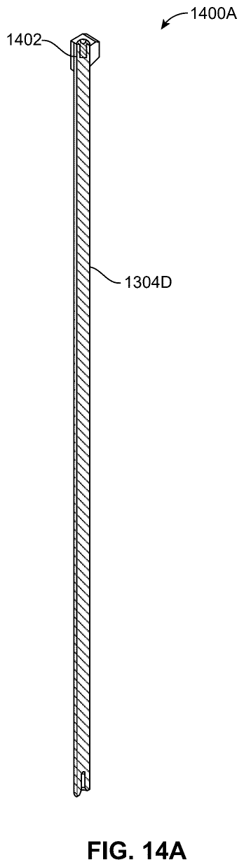

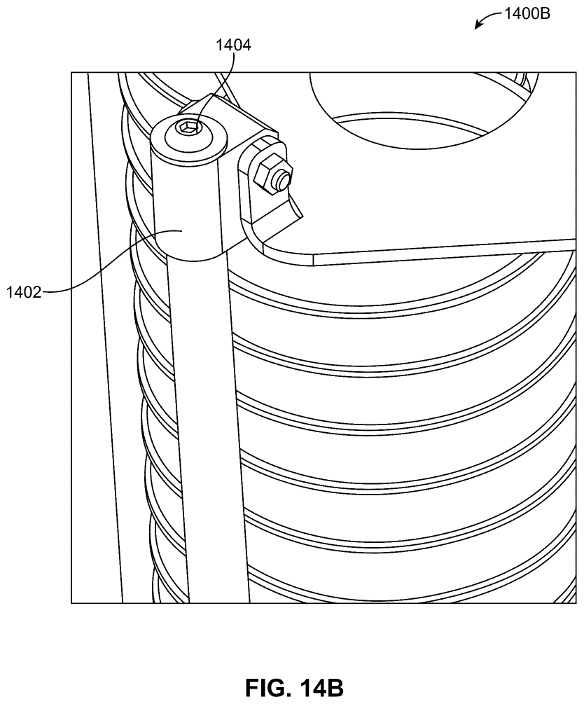

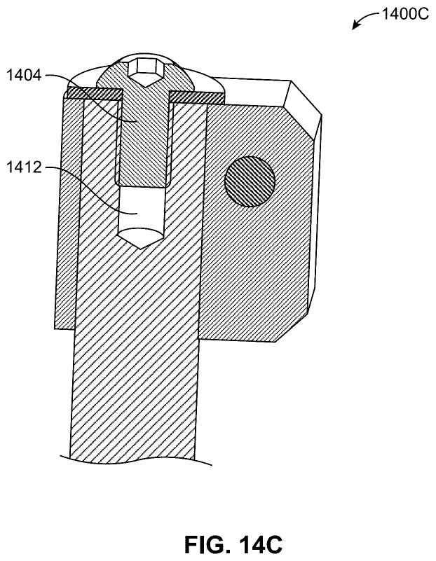

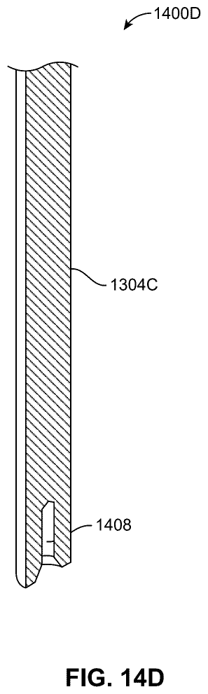

FIGS. 14A-14D illustrate sections 1400—such as section 1400A, section 1400B, and section 1400C—of an outer rod among rods 1304 (e.g. rod 1304D) in cup dispenser 1300, according to some embodiments. FIG. 14A illustrates a view of an outer rod in its entirety. Rod 1304D may include a hole on a bottom that attaches to a pin affixed to magazine 1302 and a housing on the top that includes a void that allows rod 1304D to slide upward to remove the pin from the hole. This housing may pivot on a second pin to allow rod 1304D to swing in an outward direction. In this fashion, a technician can lift and swing outward rod 1304D during a loading process, place a sleeve of containers in magazine 1302, and then snap rod 1304D back into place by securing the pin within the void to secure the containers.

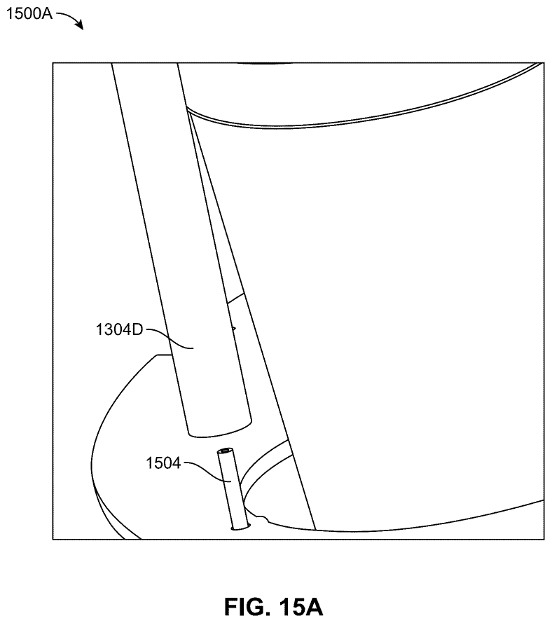

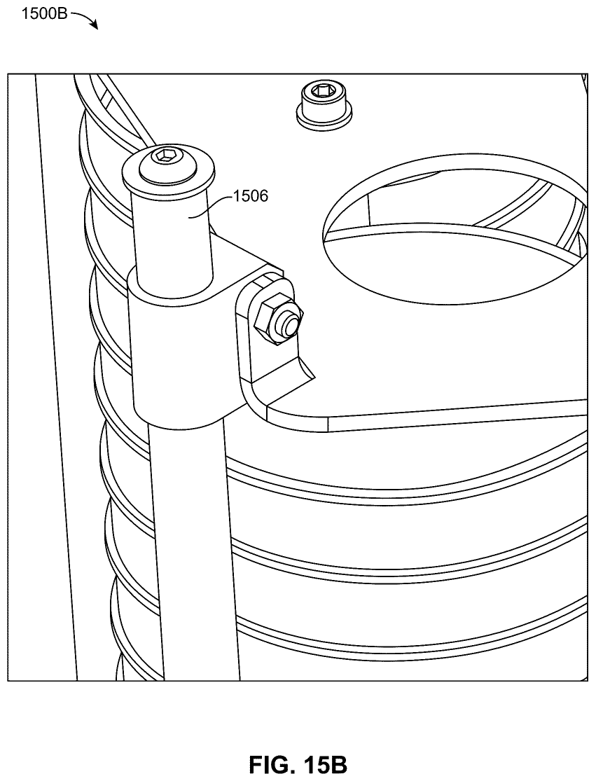

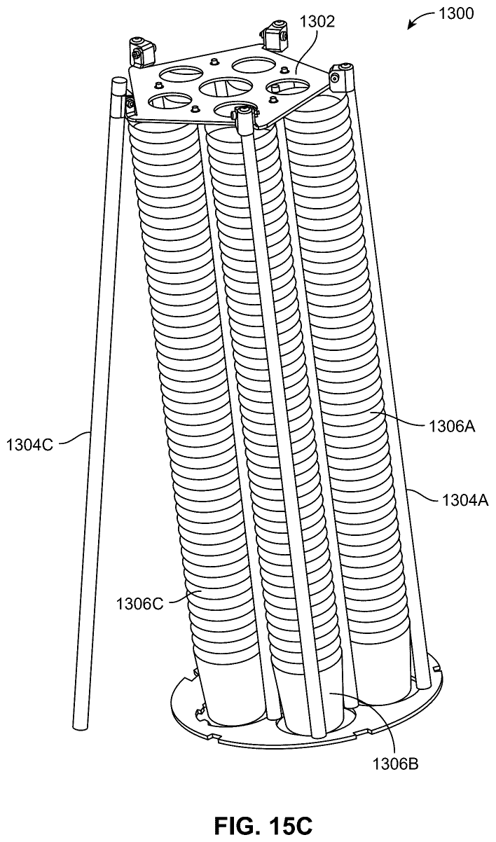

FIG. 14B and FIG. 14C further detail housing 1402, which includes screw 1404 and void 1412. Void 1412 provides a buffer that allows housing 1402 to extend upward during the loading process. That is when a technician lifts the outer rod upward, housing 1402 may allow expanse 1506 to extend upward (as illustrated in FIG. 15B). FIG. 14D illustrates the bottom of rod 1304D having indentation 1408. As illustrated in FIG. 15A, indentation 1408 may connect to pin 1504 affixed to magazine 1302.

FIG. 15C illustrates rod 1304C on cup dispenser 1300 lifted and opened outward to allow a corresponding sleeve in the plurality of sleeves to be pre-loaded with containers. Housing 1402 may include a second pin that allows rods 1304C to swing in an outward direction.

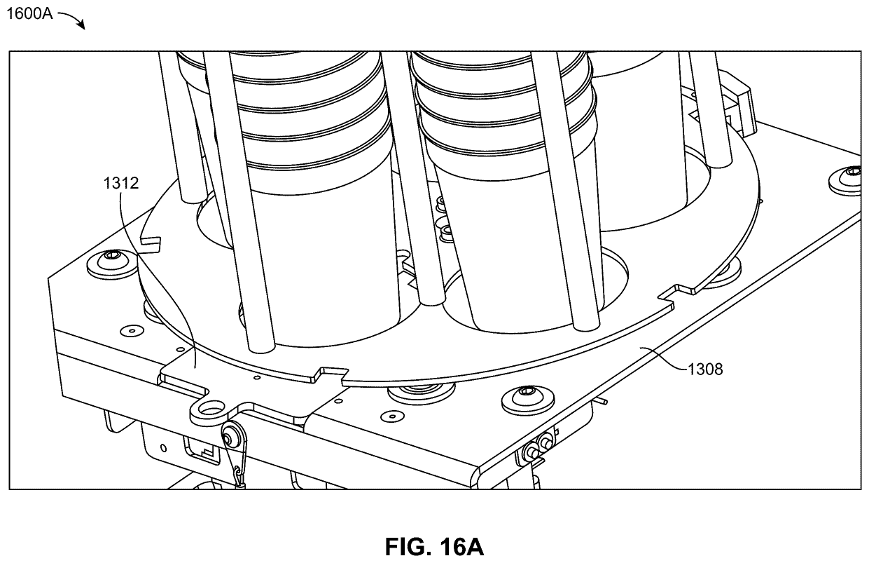

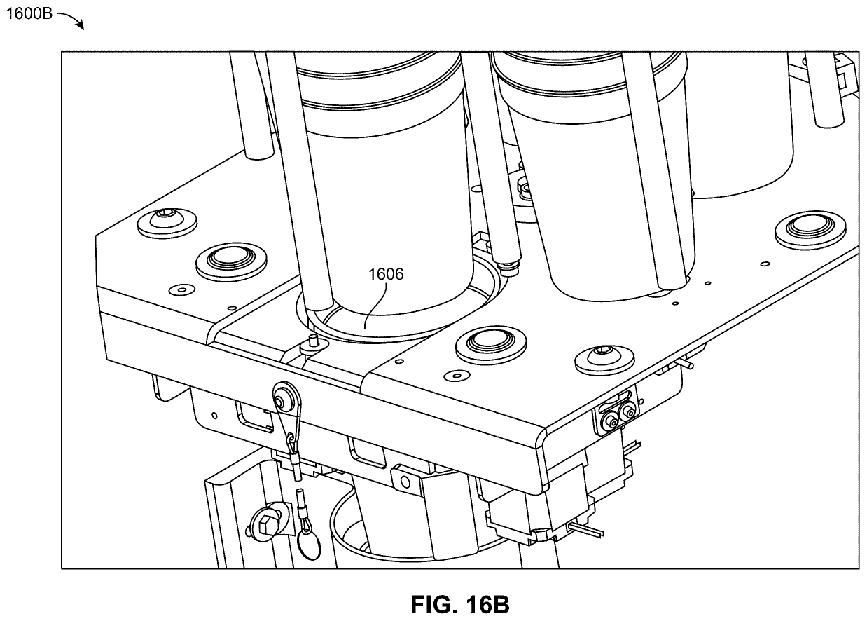

FIGS. 16A-16B illustrate barrier 1312 positioned below bottom plate 1308 in cup dispenser 1300, according to some embodiments. A technician may remove barrier 1312 so that a first cup in the first sleeve falls downward to prepare cup dispenser 204 to begin dispensing cups. FIG. 16A shows cup dispenser 1300 with barrier 1312 in place, while FIG. 16B illustrates cup dispenser 1300 with barrier 1312 removed.

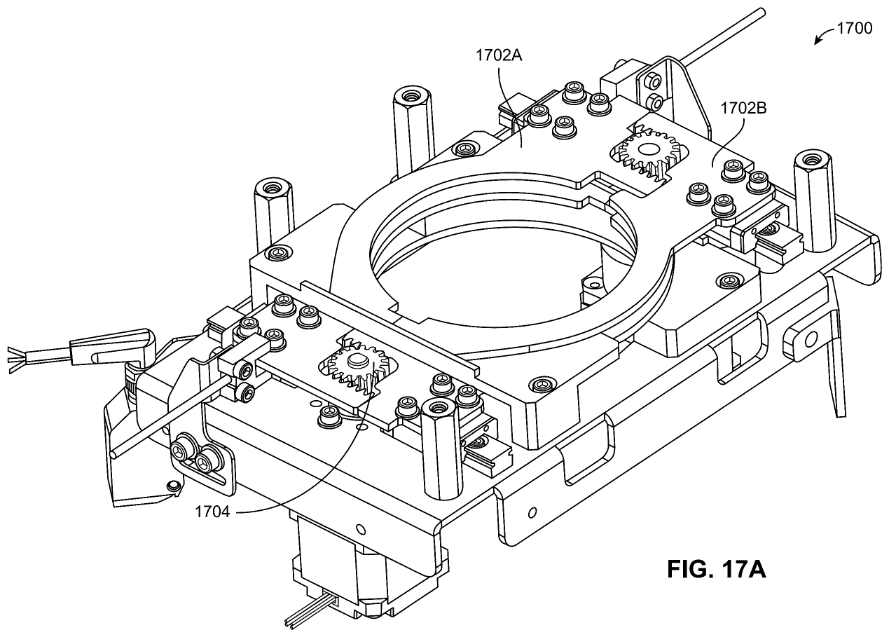

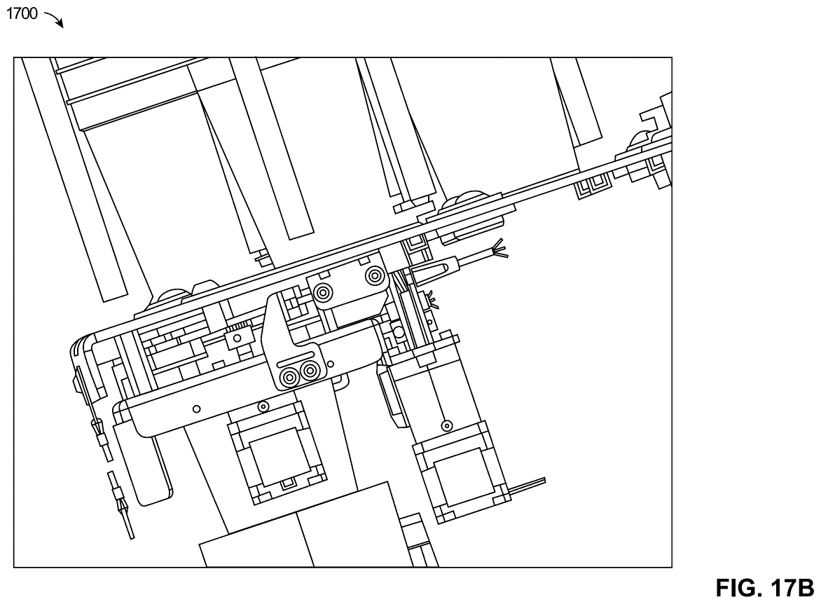

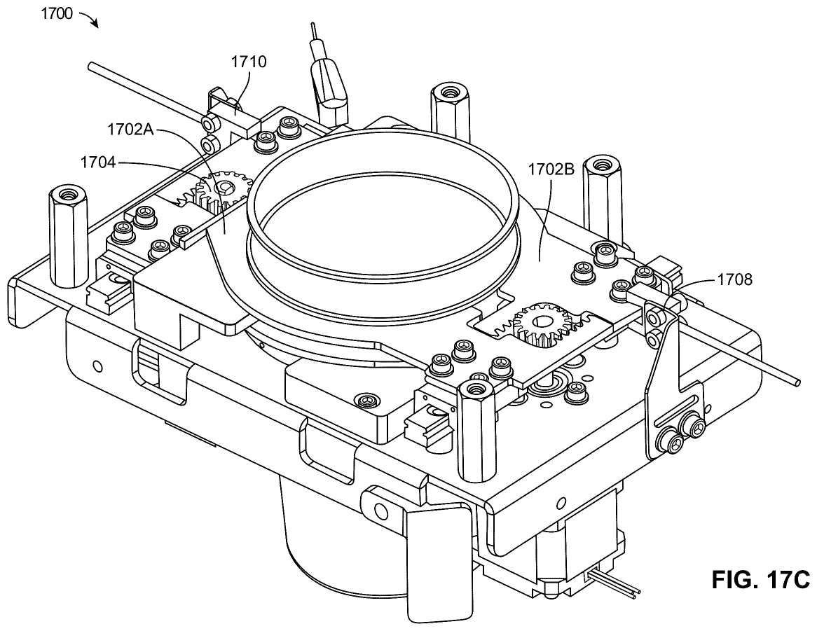

FIGS. 17A-17C illustrate cup splitter 1700 in cup dispenser 1300 deployed in interactive bartender kiosk 100, according to some embodiments. Upper fingers 1702A-1702B may secure a container in place using a ridge on the container that rests on upper finger 1702A and upper finger 1702B. Spar gear 1704 may open upper fingers 1702A-1702B along a linear guide. Spar gear 1704 may be attached to a motor. Sensor 1708 and sensor 1710 may determine the position of upper fingers 1702A-1702B and lower fingers 1902A-1902B (discussed below).

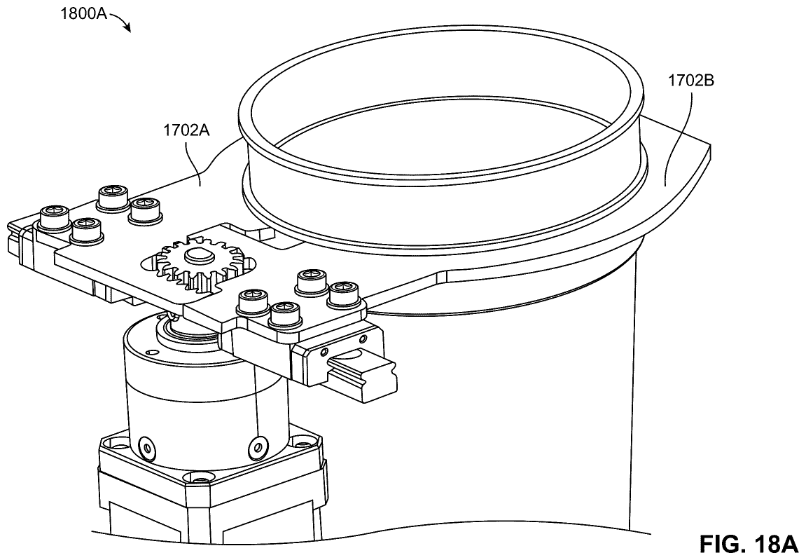

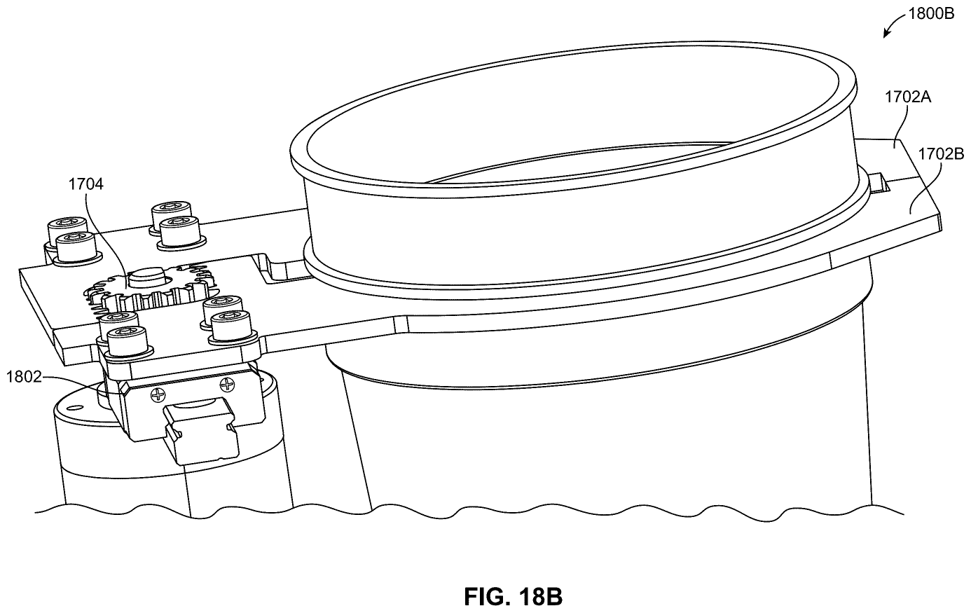

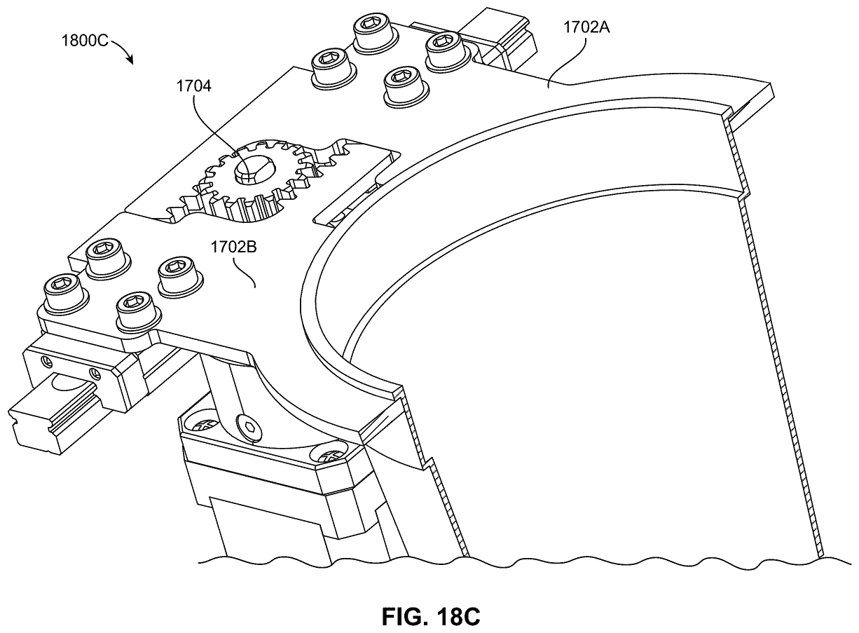

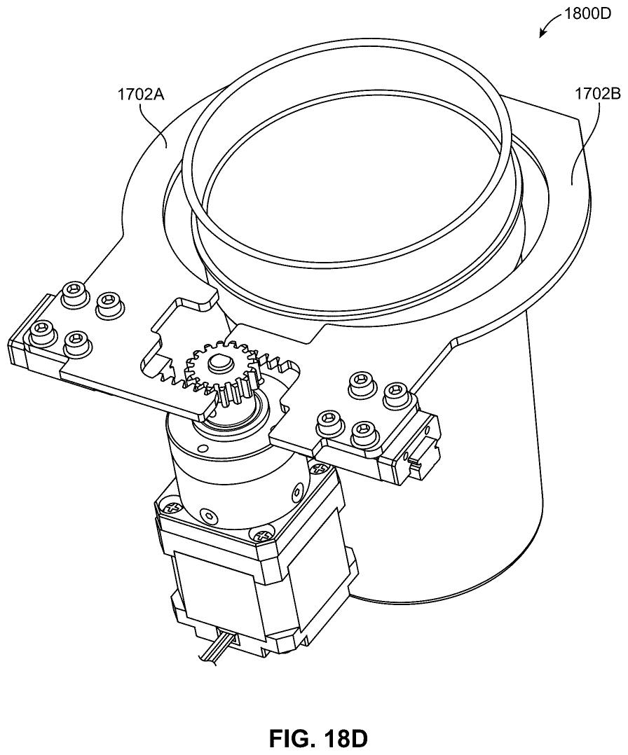

FIGS. 18A-18D illustrate cup splitter 1700 in operation, according to some embodiments. In FIGS. 18A-18C, upper fingers 1702A-1702B are in a closed position, securing a container in place by allowing the ridge on the container to rest on upper fingers 1702A-1702B. In FIG. 18D, upper fingers 1702A-1702B are in an open position. This would cause gravity to force the sleeve of containers downward.

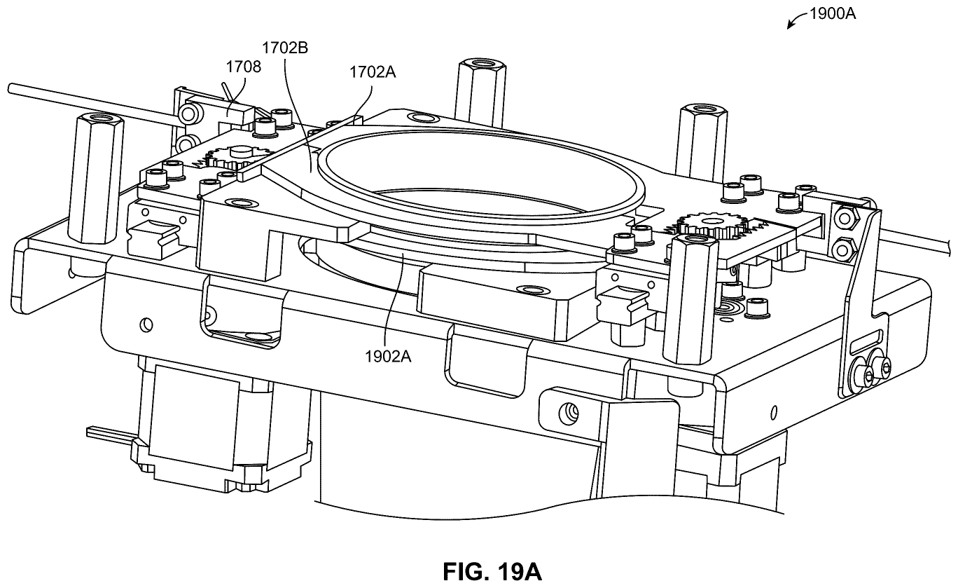

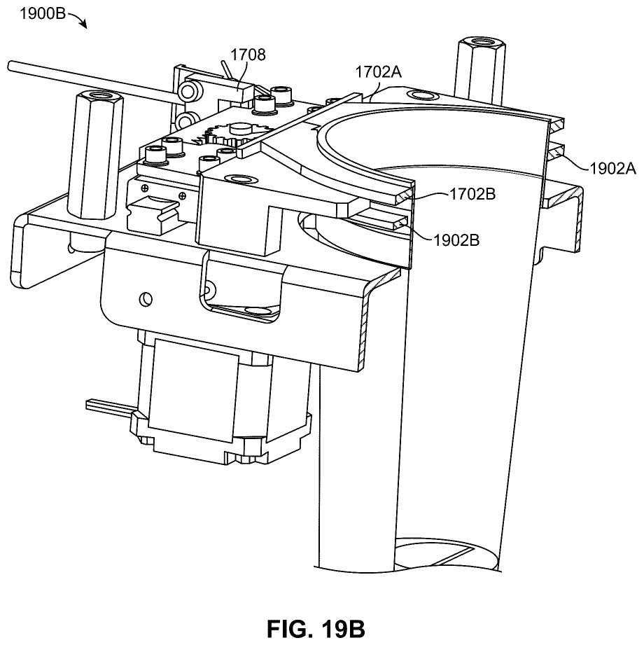

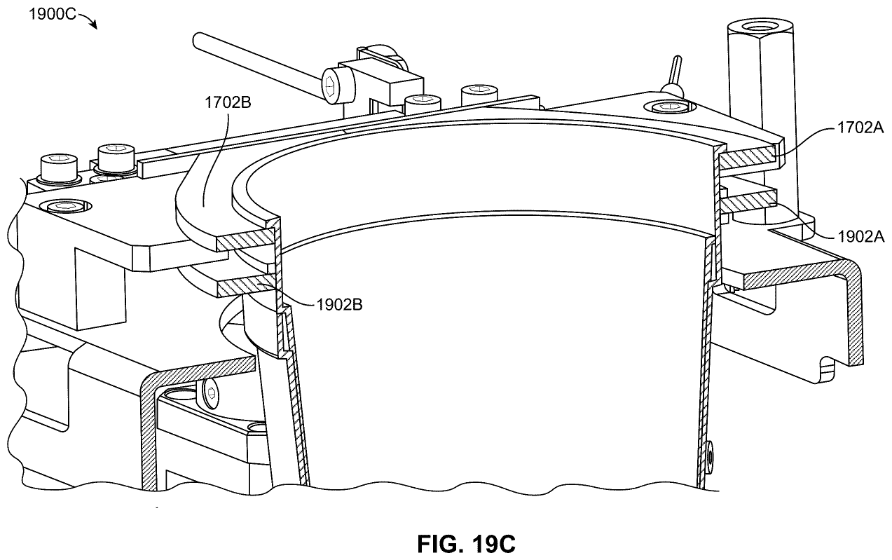

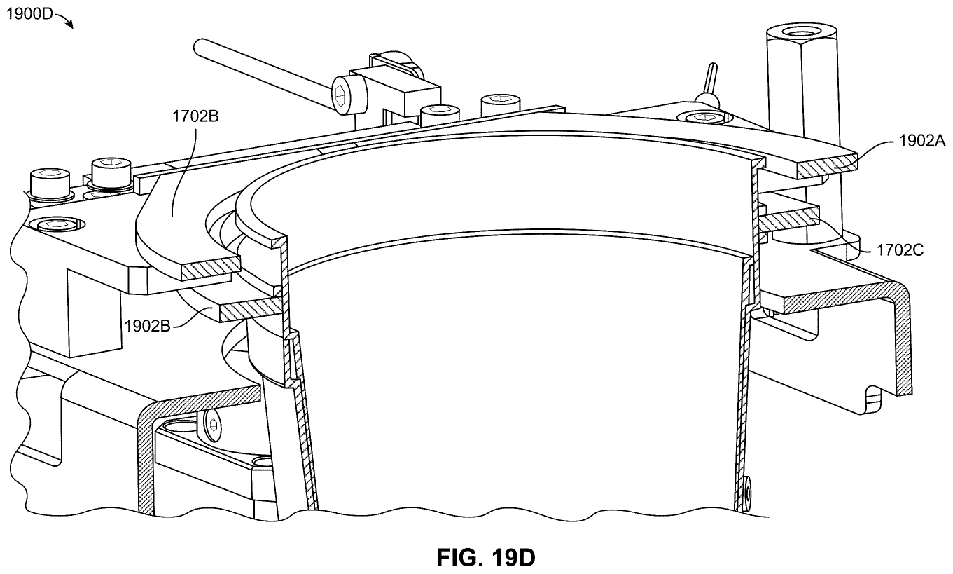

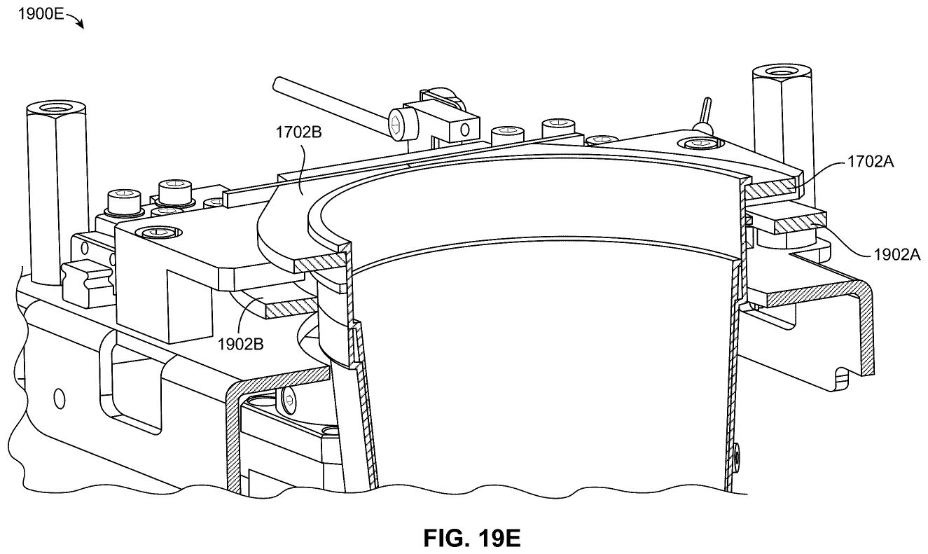

FIGS. 19A-19E illustrate cup splitter 1700, according to some embodiments. In addition to upper fingers 1702A-1702B, cup splitter 1700 also includes lower fingers 1902A-1902B. To dispense a container, cup splitter 1700 may secure the container in place on the at least one upper finger using a ridge on the container that rests on the at least one upper finger. Cup splitter 1700 may then open the at least one upper finger to release the container from the at least one upper finger. Cup splitter 1700 may then secure the container on the at least one lower finger by resting the ridge on the at least one lower finger while simultaneously securing a next container in the plurality of containers on the at least one upper finger using a next ridge on the next container that rests on the at least one upper finger. Cup splitter may then open the at least one lower finger to drop the container onto the platform.

FIGS. 19A-19C illustrate the securing of a container on lower fingers 1902A-1902B and a next container on upper fingers 1702A-1702B. In FIGS. 19A-19C, both lower fingers 1902A-1902B and upper fingers 1702A-1702B are in the closed position. FIG. 19D illustrates upper fingers 1702A-1702B in an open position. This would cause the top container to fall downward to rest on lower fingers 1902A-1902B.

FIG. 19E illustrates upper fingers 1702A-1702B in a closed position and lower fingers 1902A-1902B in an open position. This would cause the top container to fall downward to rest platform 1108. In an embodiment, the container may fall through a funnel that routes the cup to the platform.

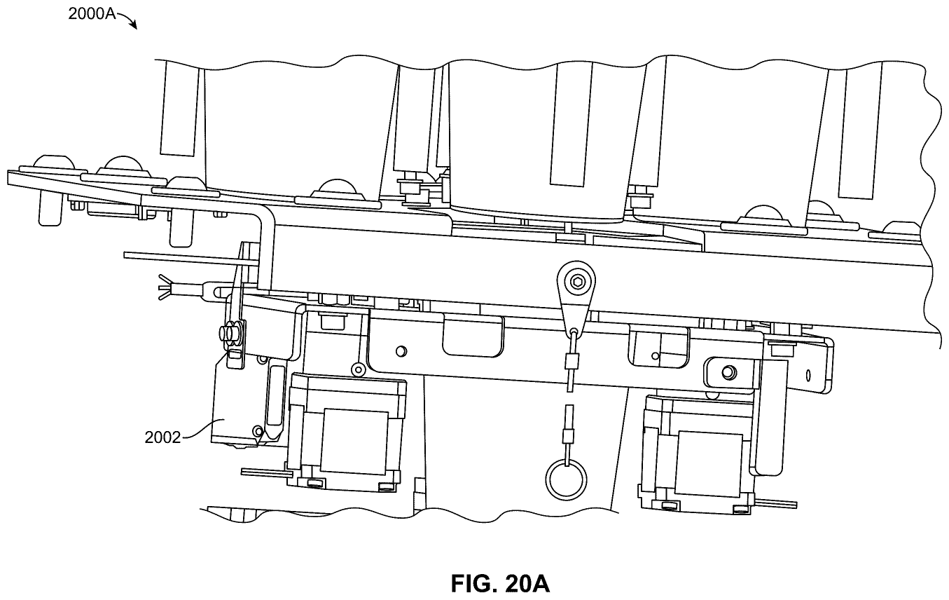

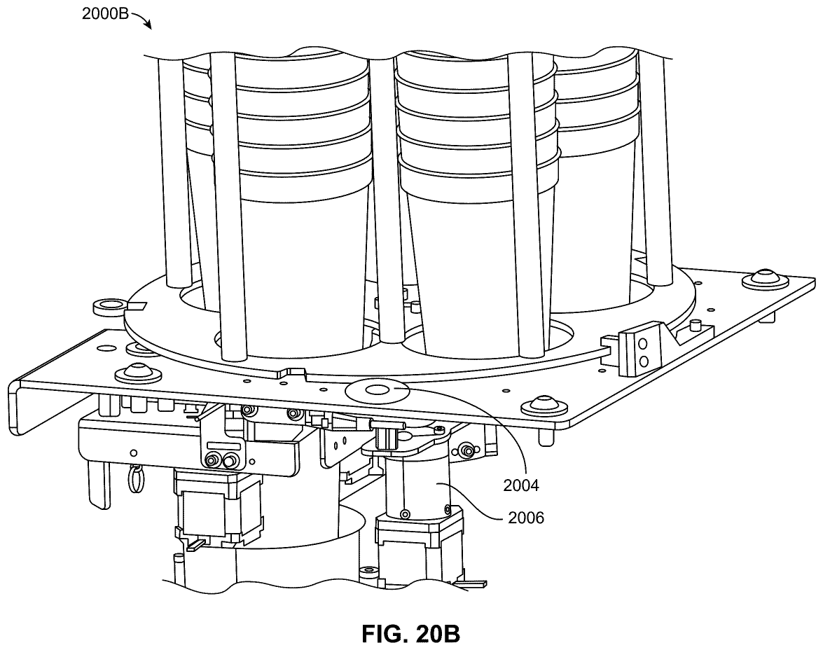

FIG. 20A illustrates an alternative viewpoint 2000A of cup splitter 1700 having multiple sensors, according to some embodiments. Sensor 2002 may determine when and when not a container has dropped to platform 1108. Sensor 2002 may be an optic sensor or other suitable sensor.

FIG. 20B illustrates an alternative viewpoint 2000B of cup splitter 1700 having multiple sensors, according to some embodiments. Motor 2006 may rotate the magazine an appropriate number of degrees to move to a next sleeve when a first sleeve runs out of cups. For example, in an embodiment having five sleeves, motor 2006 may rotate the magazine 72 degrees (360/5). Bearings 2004, upon which magazine 1302 rests, may allow magazine 1302 to rotate.

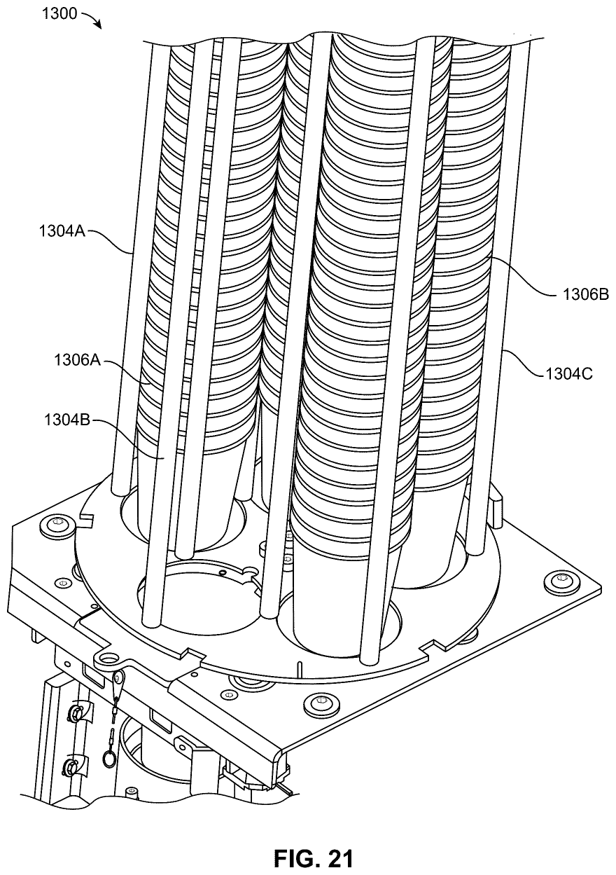

FIG. 21 illustrates cup dispenser 1300 in interactive bartender kiosk 100, according to some embodiments. In FIG. 21, a first sleeve in the plurality of sleeves is empty. In such a scenario, an optic sensor may determine that the last container in the plurality of containers for the sleeve is empty.

### Ice Dispenser

FIG. 22 illustrates an interior of ice dispenser 2200 deployed in interactive bartender kiosk 100, according to some embodiments. Ice dispenser 2200 may include insulated cabinet 2202, funnel 2204, wheel 2206, mixer 2208, motor 2210, compartments 2402A-2402C, and sensor 2404. The illustration provided in FIG. 22 is from a perspective looking down at ice dispenser 2200 from above.

Insulated cabinet 2202 may protect the ice in ice dispenser 2200 from heat to ensure that ice contained in ice dispenser 2200 does not melt or melts slowly. Insulated cabinet 2202 may be chrome, stainless steel, plastic, or other suitable material. Ice may be loaded by a technician into insulated cabinet 2202 at the start of a day or event and re-loaded periodically to meet demand. Insulated cabinet 2202 may not be actively cooled but nevertheless may serve to slow the rate of melting of ice in ice dispenser 2200. Insulated cabinet 2202 may further include a drain and a tube that connects to bottles 212 to drain water from melted ice. In another embodiment, insulated cabinet 2202 may be actively cooled to a suitable temperature to prevent melting of loaded ice.

Funnel 2204 may route downward falling ice into cup 1106. That is, as ice dispenser 2200 forces ice out of insulated cabinet 2202 through an opening above funnel 2204, funnel 2204 may provide a fan-like structure to capture the ice and transmit, direct, and/or route the ice into cup 1106.

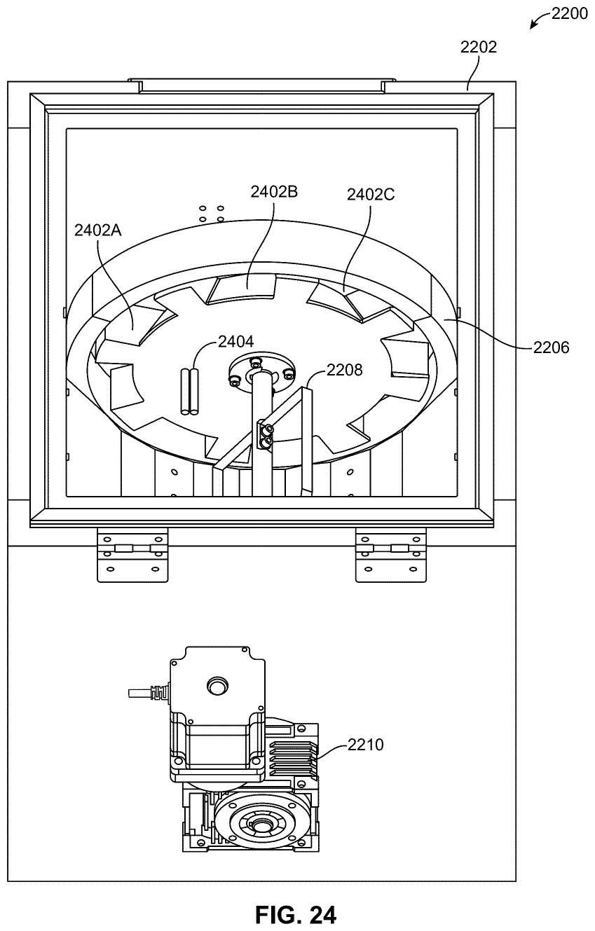

Wheel 2206 may be compartmentalized and turn clockwise or counter-clockwise. By having compartments (i.e. openings), wheel 2206 may control the outflow of ice from insulated cabinet 2202. While these compartments are not apparent from the top-down view of FIG. 22, FIG. 24, discussed below, provides more detail on wheel 2206.

Mixer 2208 may be attached to motor 2210 and may include one or more prongs or arms that turn ice stored in insulated cabinet 2202. Mixer 2208 may ensure that clumps of ice are broken up to avoid jamming at the inflow to wheel 2206.

Motor 2210 may be an electric motor that converts electrical energy into mechanical energy to turn mixer 2208 and wheel 2206. Motor 2210 may stop turning in response to determining that platform 1108 exceeding a particular weight, e.g., between 150 and 200 milligrams of ice having been dispensed. In an embodiment, motor 2210 may turn on to cycle wheel 2206 periodically (e.g., every 5 minutes) irrespective of any drink orders to eliminate clumping of ice in insulated cabinet 2202 during periods where drinks are not being ordered.

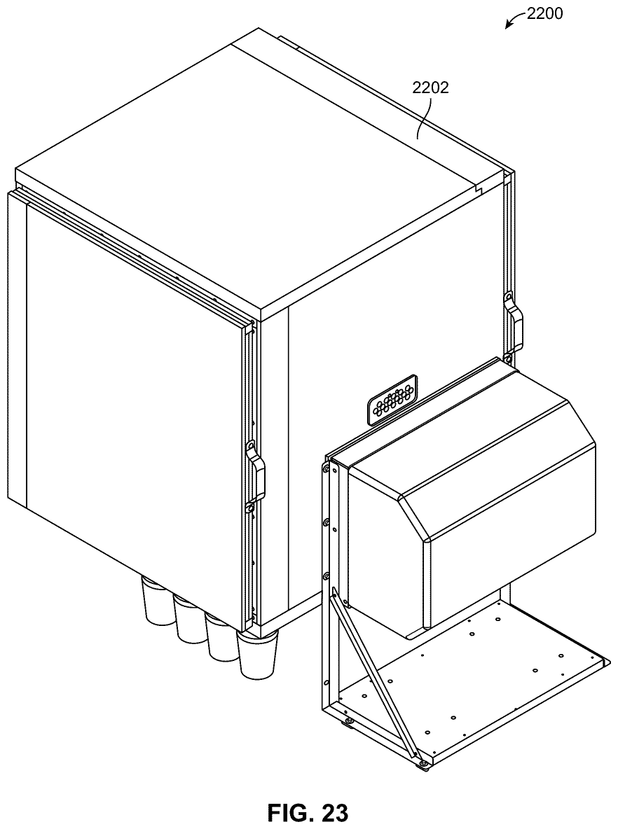

FIG. 23 illustrates an exterior of ice dispenser 2200 deployed in interactive bartender kiosk 100, according to some embodiments. The exterior of ice dispenser 2200 may be composed of chrome, stainless steel, plastic, or other suitable material.

FIG. 24 illustrates an interior of ice dispenser 2200 in an interactive bartender kiosk from an alternative viewing perspective, according to some embodiments.

Sensor 2404 may determine when ice in insulated cabinet 2202 is running low. In an embodiment, front end 503 may alert a technician when this occurs, either through dashboard 511, email, text, or other suitable notification.

Compartments 2402A-2402C are openings in wheel 2206 that assist in controlling the outflow of ice from insulated cabinet 2202. As wheel 2206 turns, a certain amount of ice will fall into a particular slot among compartments 2402A-2402C. As wheel 2206 turns further, the slot will turn until it lines up with an opening above funnel 2204. The ice may then fall from the slot in wheel 2206 and is routed by funnel 2204 into cup 1106 at station 1104B. Wheel 2206 may continue to rotate until sufficient ice is dispensed into cup 1106, as determined with reference to data from a scale on platform 1108.

### Garnish Dispenser

FIG. 25 illustrates garnish dispenser 2500 deployed in interactive bartender kiosk 100, according to some embodiments. In an embodiment, garnish dispenser 2500 may be housed in refrigerator 208 to keep pre-loaded garnishes cool and avoid spoilage. Garnish dispenser 2500 may include plurality of slots 2502, columns 2504A-2504D, element 2603, actuator 2604, conveyor 2606, back side 2802, and front side 2804. The illustration provided in FIG. 25 examines the interior of garnish dispenser 2500 from the front.

Plurality of slots 2502 may be arranged vertically in columns 2504A-2504D. Each column in columns 2504A-2504D may be configured to house a different garnish. Each slot in plurality of slots 2502 may include a garnish pre-portioned for exactly one drink. A garnish may be a cherry, lemon, lime, orange, grapefruit, pineapple, cucumber, berry, pepper, ginger, mint, rosemary, thyme, basil, sage, a flower, etc. In an embodiment, garnishes dispenser may include four columns each having 50 slots to allow 200 garnishes to be pre-loaded into garnish dispenser 2500. However, while FIG. 25 illustrates garnish dispenser 2500 having four columns, in other embodiments, more or less columns may be included in garnish dispenser 2500. As discussed below, plurality of slots 2502 may be arranged in a cartridge that is removable from the beverage dispenser to facilitate sanitation and reloading.

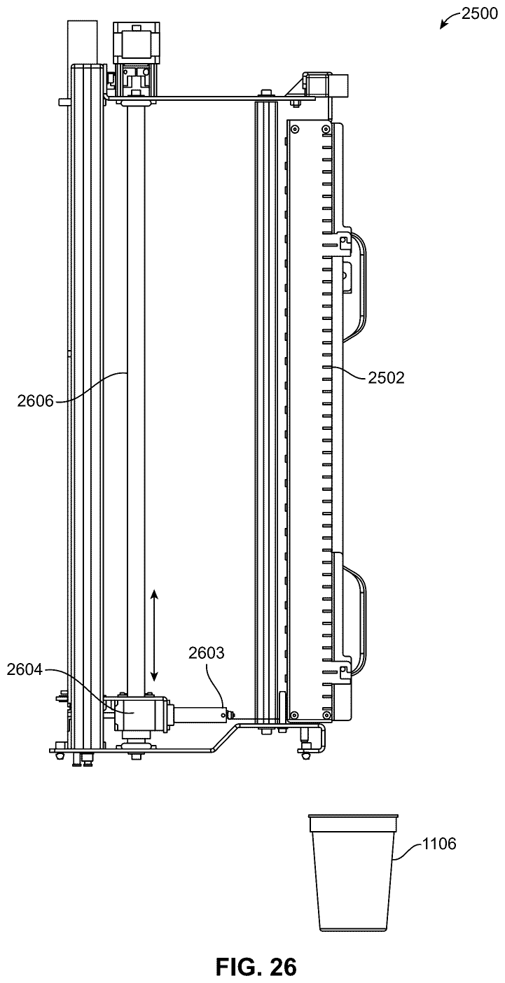

FIG. 26 illustrates an interior of garnish dispenser 2500 deployed in interactive bartender kiosk 100, according to some embodiments. The illustration provided in FIG. 26 examines the interior of garnish dispenser 2500 from a side perspective.

Element 2603 may be configured to enter at least one slot from plurality of slots 502 to push a garnish from the at least one slot. After being pushed, the garnish may free fall into cup 1106 positioned at station three on linear conveyor 202. Element 2603 may be composed of metal, plastic, glass, or other suitable material. In an embodiment, element 2603 may be configured to enter the at least one slot from a side.

Actuator 2604 may be attached to element 2603 and may push element 2603 into a slot in plurality of slots 2502 to dispense the garnish from the slot into cup 1106. Actuator 2604 may be fixedly attached to garnish dispenser 2500.

Conveyor 2606 may position element 2603 and actuator 2604 vertically within the garnish dispenser. A lead screw connected to a motor, a circular linear guide, and a pillow block may be used to move actuator 2604 vertically. Conveyor 2606 may be controlled by a controlled configured to select which of plurality of slots 2502 to dispense a garnish from. Because particular beverages on a menu of beverages may be configured to have different garnishes, conveyor 2606 may position the element 2603 and actuator 2604 before an appropriate column in columns 2504A-2504D based on a beverage selected by a customer. Additionally, the controller may track the number of garnishes that have been dispensed from each column in columns 2504A-2504D. In accordance with this count, the controller may also position element 2603 and actuator 2604 vertically at a particular “floor” corresponding to the count to ensure that the next slot has a garnish installed and that no floors are skipped. In this regard, conveyor 2606 may work from top-to-bottom or bottom-to-top when dispensing garnishes. To ensure that a garnish has been dispensed, garnish dispenser 2500 may receive feedback from a scale on platform 108 that the weight of cup 1106 increased in response to the dispensing of the garnish. A sensor may be used to the determine the start position of actuator 2604, and conveyor 2606 may return to the start position after dispensing each garnish.

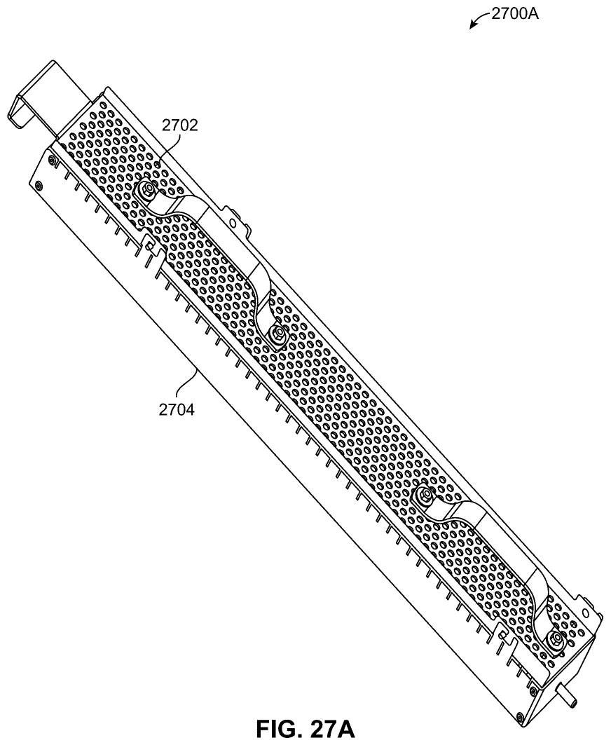

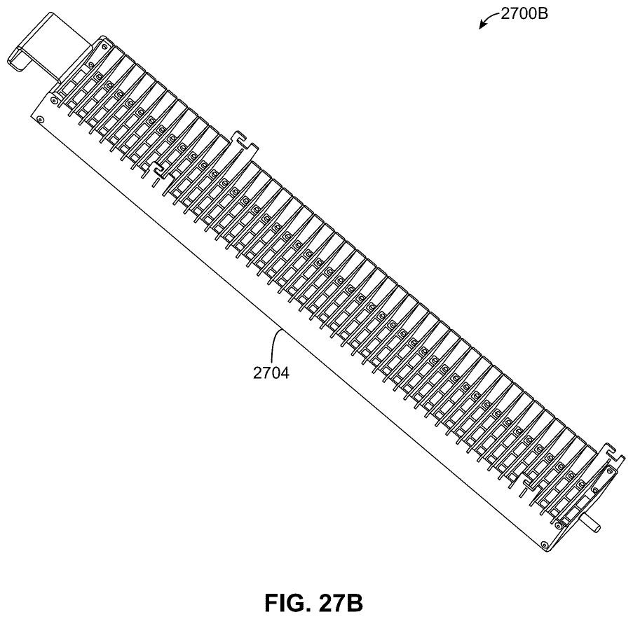

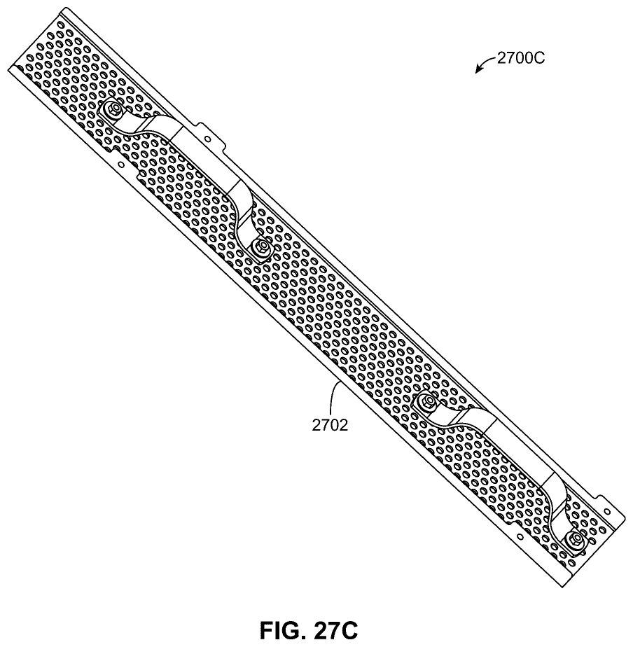

FIG. 27A illustrates pre-loaded container 2700A in a garnish dispenser 209 in interactive bartender kiosk 100, according to some embodiments. Pre-loaded container 2700A may include lid 2702 and cartridge 2704. Pre-loaded container 2700A may correspond to a column such as those discussed above as columns 2504A-2504D. In one embodiment, each pre-loaded container may include 50 slots, with four such containers in place to correspond to columns 2504A-2504D. In this embodiment, 200 pre-cut garnishes may be loaded into interactive bartender kiosk 100. Pre-loaded container 2700A may be removed from garnish dispenser 2500 by a technician. Lid 2702 may be attached to the cartridge to allow the cartridge to be removed from garnish dispenser 209 and easily transported to a prep area and returned to interactive bartender kiosk 100. Lid 2702 may serve to keep the garnishes in place during transport. When the technician places the cartridge back into garnish dispenser 2500, lid 2702 may need to be removed to allow the garnishes to be pushed out into cup 1106.

FIG. 27B illustrates cartridge 2704 of pre-loaded container 2700B in a garnish dispenser in an interactive bartender kiosk, according to some embodiments. Individual portions for each garnish may be loaded by a technician into pre-loaded container 2700A. Cartridge 2704 may be magazine or other container serving this purpose. For example, one cartridge may be loaded with cut lemons, a second cartridge may be loaded with limes, a third cartridge loaded with oranges, etc., as part of a prep process. Each slot in the plurality of slots in the cartridge may house a single garnish of the appropriate variety.

FIG. 27C illustrates lid 2702 of pre-loaded container 2700C used in garnish dispenser 209 in interactive bartender kiosk 100, according to some embodiments. Lid 2702 may snap to cartridge 2704 so that the pre-loaded container may be easily removed. Lid 2702 may include a handle to allow cartridge 2704 to be carried. Lid 2702 may be removed from cartridge 2704 to allow the cartridge to be loaded with garnishes as part of a prep process. The separable components of pre-loaded container further allows for easy sanitation of the cartridge.

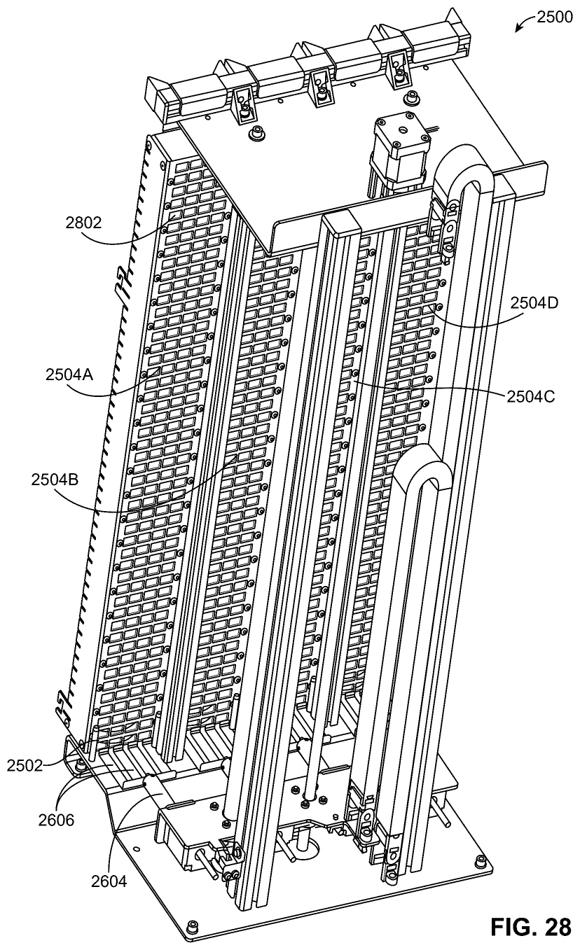

FIG. 28 illustrates an interior of garnish dispenser 2500 in interactive bartender kiosk 100, displayed from the rear, according to some embodiments. FIG. 28 further illustrates that, in some embodiments, element 2603 may include prongs or forks to effectively push the garnish from a selected slot. Additionally, FIG. 28 illustrators that actuator 2604 and element 2603 may be part of a set of a plurality of actuators and a plurality of elements. In this regard, actuator 2604 and element 2603 may each correspond to a single column in columns 2504A-2504D. Depending on the garnish to be dispensed in a selected beverage, the controller may select the appropriate, particular element/actuator to push a garnish from the appropriate column in columns 2504A-2504D. Thus, actuator 2604 and element 2603 may move forward independently from the other actuators and elements to push the garnish out of the slot without pushing a garnish out of the irrelevant columns.

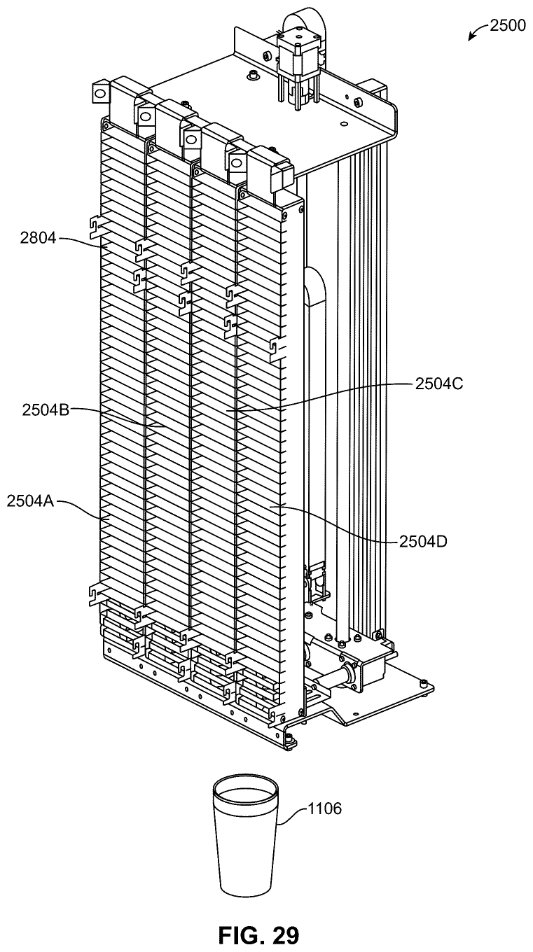

FIG. 29 illustrates garnish dispenser 2500 in interactive bartender kiosk 100 viewed from a front- and side-facing perspective, according to some embodiments. Cup 1106 may be placed by linear conveyor 202 at an appropriate sub-stations within the third station. The sub-station may be determined based on the selected drink and the garnish contained in that drink. For example, if a gin and tonic is ordered that requires a lime, front end 503 and/or a controller in garnish dispenser 2500 may determine which of the columns in columns 2504A-2504D has sliced limes installed and position platform 1108 in front of that particular column.

FIG. 28 and FIG. 29 also include illustrate back side 2802 and front side 2804. Back side 2802 may include a hole through which element 2603 may be inserted when dispensing the garnish held by the slot. The hole in back side 2802 may be small enough to prevent the garnish held by the slot from falling out of the cartridge when removed but large enough to allow element 2603 to push through. Front side 2804 may include an opening through which the garnish held by a slot is dispensed.

### Drink Dispenser

FIG. 30 illustrates an interior of drink dispenser 3000 deployed in interactive bartender kiosk 100, according to some embodiments. Drink dispenser 3000 may include manifold 3002, motor 3004, and door 3006. FIG. 30 presents a view of drink dispenser 3000 from the front.

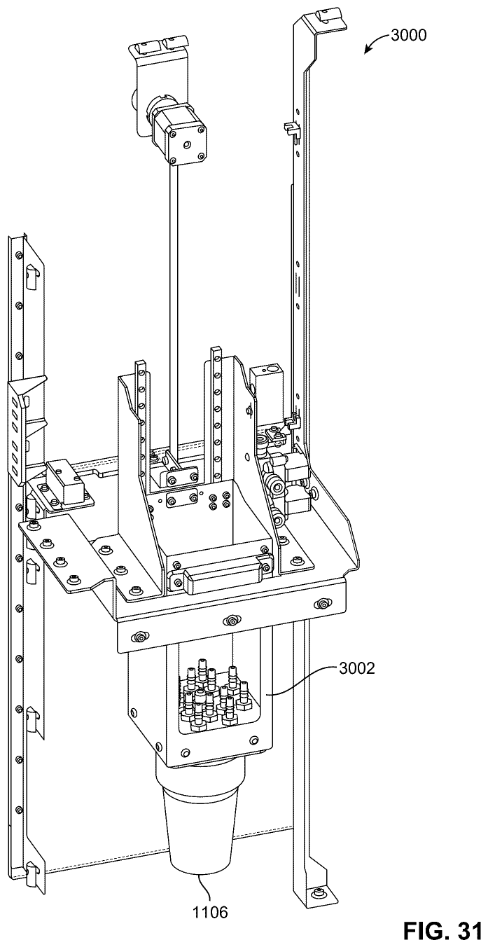

Manifold 3002 is described in further detail below with reference to FIGS. 31-37. Generally speaking, manifold 3002 may receive liquids from containers 214 and boxes 216 pumped through tubes (not shown) by pumps 220. Manifold 3002 may mix the ingredients and distribute them to cup 1106 at a fourth station in the drink-making process. Manifold 3002 may move up and down within drink dispenser 3000, e.g., manifold 3002 may move to a down position that fits snug to cup 1106 when dispensing liquid and return to an up position after dispensing the liquid. This behavior minimizes spillage of liquid. The amount and flow rate of liquids flowing into manifold 3002 may be controlled with particularity by a controller in accordance with the pre-configured proportions of beverages. The controller may be couple to electronic valves to control the flow of the carbonated water and other liquids. The controller may be couple to additional pumps that control the flow of concentrated flavored liquids from boxes 216. The controller may dispense the ingredients by signaling a pump to adjust a speed of the flow of alcoholic liquid ingredient such that the time needed to dispense the pre-configured amount of the alcoholic liquid ingredient is substantially the same as the time needed to dispense the pre-configured amount of the concentrated water.

Motor 3004 may assist in raising door 3006 after drink dispenser 3000 dispenses liquid into cup 1106. Motor 3004 may be attached to a wheel that rotates to extend or reduce a belt attached to door 3006. Using motor 3004, manifold 3002 may be attached to a vertical conveyor configured to move manifold 3002 vertically to lower manifold 3002 toward the container when the alcoholic and non-alcoholic liquid ingredients are being dispensed and to raise the manifold away from the container when the dispensing of the beverage is complete.

Door 3006 may lower during drink preparation and raise after drink completion. Door 3006 may be composed of glass, plastic, or other material. Door may be lowered to prevent a customer from accessing the container when the alcoholic liquid ingredients and non-alcoholic liquid ingredients are being dispensed. Door 3006 may be raised to allow the customer to retrieve the container when the beverage is complete. By raising door 3006, customer 502 may be signaled that the selected beverage is ready to be enjoyed. Door 3006 may be translucent or opaque. Door 3006 may further display an LED strip that further indicates that the drink is ready, e.g., by flashing. Interactive bartender 404 may also verbally inform customer 502 that the drink is ready. In an alternative embodiment, door 3006 may be manually opened and manually closed to signal to customers that interactive bartender kiosk 100 is open for business or not in operation.

FIG. 31 illustrates an interior of drink dispenser 3000 deployed in interactive bartender kiosk 100, according to some embodiments. FIG. 31 presents a view of drink dispenser 3000 from the rear. In FIG. 31, the interior of manifold 3002 may be seen. The interior of manifold is discussed in further detail below.

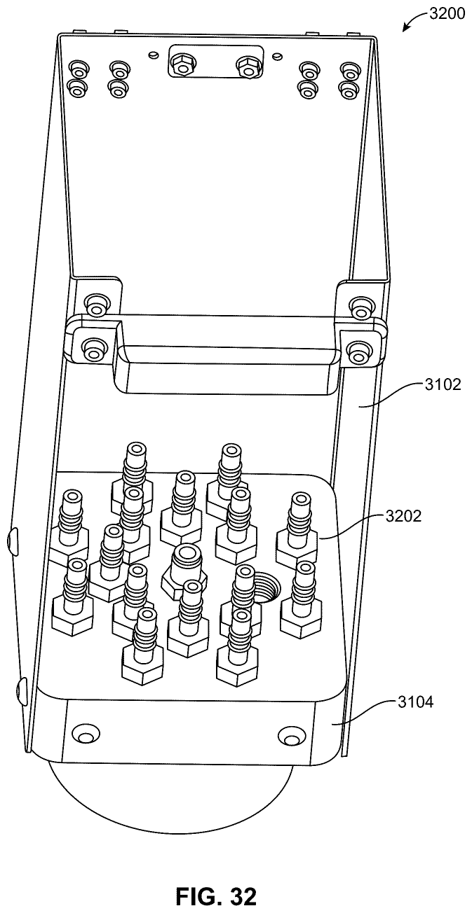

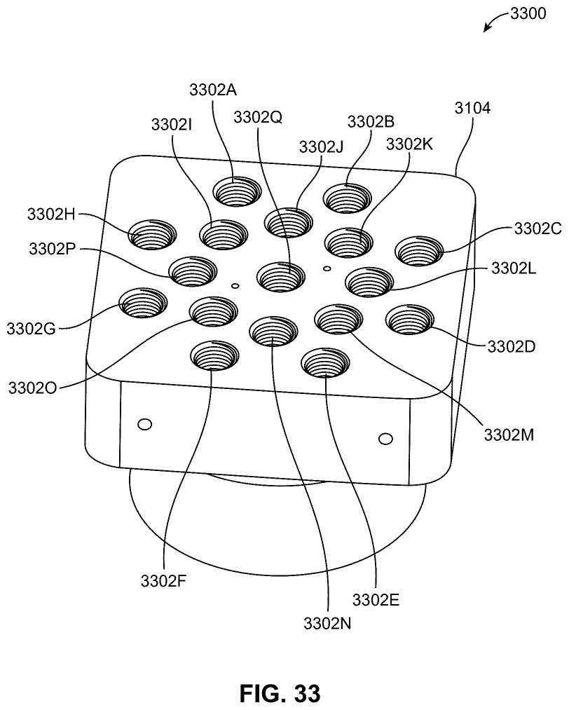

FIG. 32 illustrates interior 3200 of manifold 3002 in interactive bartender kiosk 100, according to some embodiments. Nozzles 3202 may connect to containers 214 may connect via tubing to containers 214, boxes 216, a carbonator that provides soda water, and a regular water source. Nozzles 3202 may receive carbonated water. Nozzles 3202 may receive a concentrated flavored liquid. Nozzles 3202 may receive water. Nozzles 3202 may correspond to channels 3302A-3302Q discussed below with reference to FIG. 33.

In an embodiment, manifold 3002 may be manufactured from plastic, e.g., a food-grade plastic manufactured using polylactic acid. Manifold 3002 may be 3D printed using an appropriate three-dimensional printing process. Manifold 3002 may be formed as a single piece.

FIG. 33 illustrates an interior 3300 of manifold 3002 in in an interactive bartender kiosk, according to some embodiments.

Channels 3302A-3302Q may route liquids received from nozzles 3202 through manifold 3002 and ultimately into cup 1106. The amount and flow rate of liquids from nozzles 3202 flowing through channels 3302A-3302Q may be controlled with particularity by a controller in accordance with pre-configured proportions of drinks. The controller may be configured to control flow of fluids through the first and second channels such that the non-alcoholic liquid ingredient is dispensed simultaneously with the alcoholic liquid ingredient. In an embodiment, a centrally located channel (channel 3302Q in FIG. 32) may be attached to a tube that brings soda water and flat water to manifold 3002. Such a channel may be referred to below as a first channel. An electronic valve coupled to the controller may control the flow of the carbonated water to the first channel.

In an embodiment, a subset of the channels may be arranged or substantially arranged in an inside circle (e.g., channel 3302I, 3302J, 3302K, 3302L, 3302M, 3302N, 3302O, 3302P). Channels in this inside circle may be reserved for non-alcoholic drinks. These interior channels may be connected to appropriate nozzles 3202 to receive concentrated flavored liquids and/or containers having non-alcoholic liquids. This allows the mixing of concentrated flavored liquids and soda water in the centrally located channel to occur inside of the manifold and prior to the introduction of alcoholic liquids.

Similarly, a subset of channels may be arranged or substantially arranged in an outside circle (e.g., channel 3302A, 3302B, 3302C, 3302D, 3302E, 3302F, 3302G, 3302H). Channels in the outside circle may be reserved for alcoholic drinks. Such a channel may be referred to below as a second channel. These outside channels thus may be connected to appropriate nozzles 3202 to receive alcoholic liquids from containers 214. In this regard, channels 3302A-3302Q may be fluidly isolated from one another. The channels for alcoholic fluids may be isolated from the channels for non-alcoholic fluids. This may prevent even small amounts of alcohol being incorporated into non-alcoholic drinks.

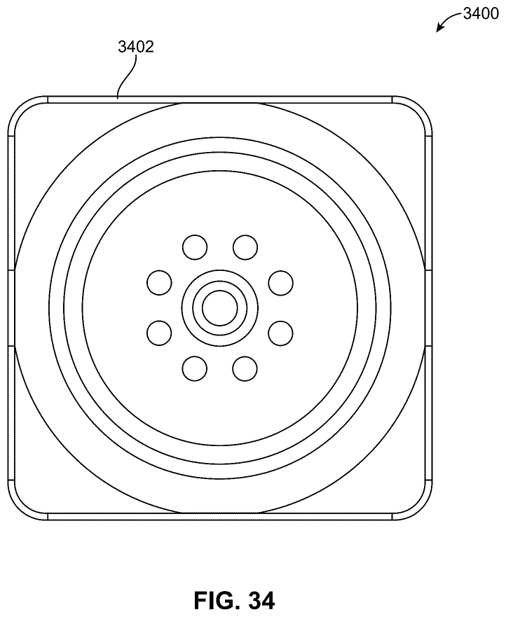

FIG. 34 illustrates bottom 3400 of manifold 3002 in interactive bartender kiosk 100, according to some embodiments. FIG. 34 provides a viewpoint of manifold 3002 from below the manifold looking up into channels 3302A-3302Q at the point at which liquids are dispensed. The eight outside channels may connect to nozzles/tubes that provide alcohol from containers 214. The interior channel may soda water or flat water, possibly mixed with concentrated liquids from boxes 216.

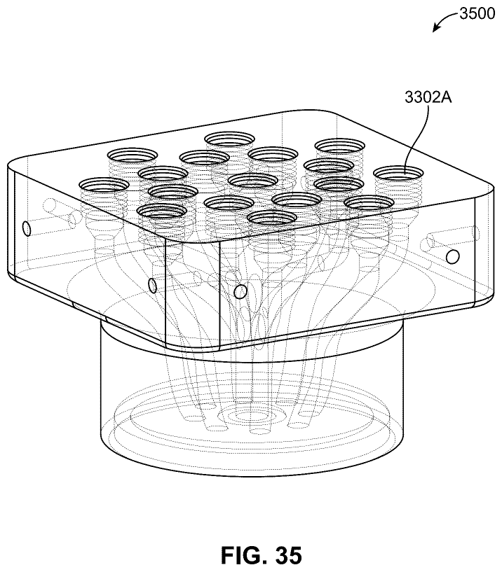

FIG. 35 illustrates interior 3500 of manifold 3002 in interactive bartender kiosk 100, according to some embodiments. FIG. 35 provides a transparent view of the routes taken by channels 3302A-3302Q within manifold 3002. As noted above, a second plurality of channels are arranged substantially circularly around a first plurality of channels. FIG. 35 also illustrates that the interior channels connect to the central channel within manifold 3002 prior to connecting with the (in this embodiment) eight outside channels. To reiterate, this allows the mixing of concentrated flavored liquids and soda water in the centrally located channel to occur before introducing alcohol.

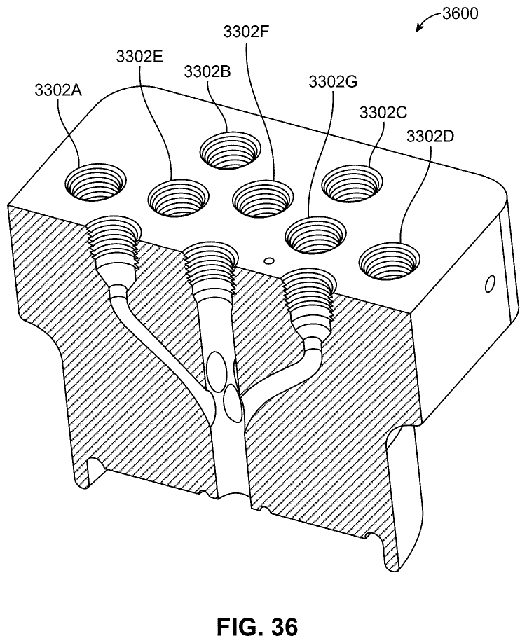

FIG. 36 illustrates an interior 3600 of manifold 3002 in interactive bartender kiosk 100, according to some embodiments. In FIG. 36, the inside channels among 3302I-3302P connect to the central channel 3302Q. This connection allows the soda/water stream to mix with flavor concentrated liquids inside of manifold 3002.

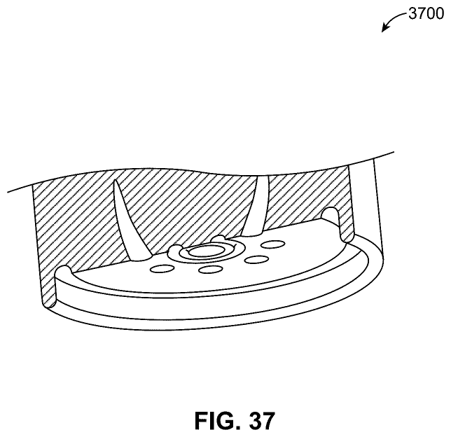

FIG. 37 illustrates an interior 3700 manifold 3002 in an interactive bartender kiosk, according to some embodiments. FIG. 37 illustrates the angled nature of the tubes that feed the alcoholic ingredients into the stream provided by the central tube (having both the flow of liquid from the central channel and the inside circle of channels). When the current flows from the central release hole, a current/flow from the angled tube of alcoholic liquid matches the current from the centrally located channel. In this manner, the flow is directed to join the current into a stream of fluid as it is falling down into the cup, thus achieving mixing of the alcoholic and non-alcoholic ingredients. Thus, the channels are directed such that the non-alcoholic liquid ingredient and the alcoholic liquid ingredient combine with one another while falling through air above or within the container.

After the liquid is dispensed, pumps 220 may use suction to return the dispensed liquids back up into the relevant tube. In this manner, the custom drink dispenser may be primed for the next drink to avoid inadvertent inclusion of prior ingredients in a subsequent drink.

### Interface Components

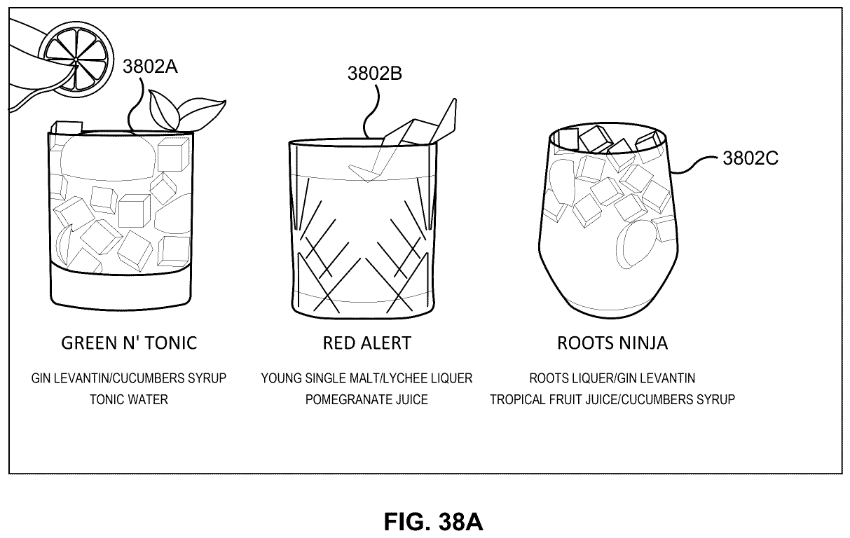

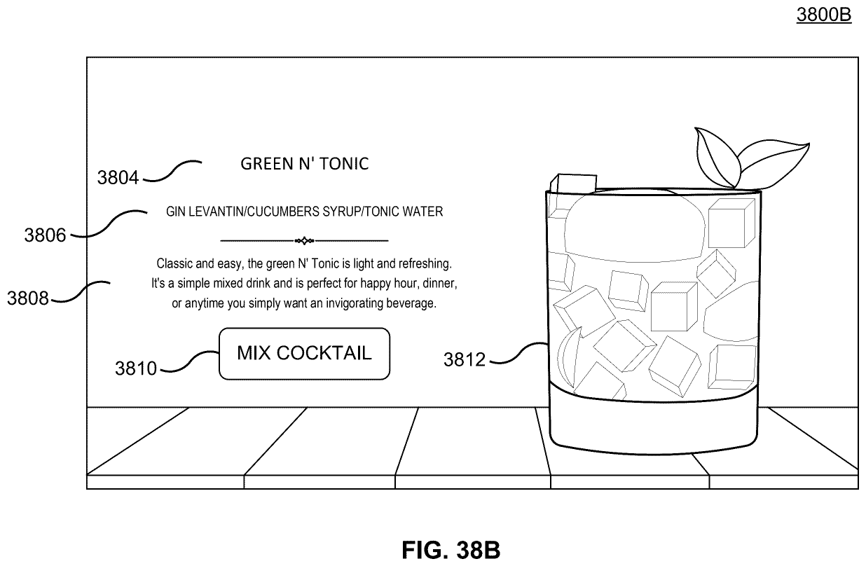

FIG. 38A is an example screen display 3800A of a menu of beverages provided by an interactive bartender, according to some embodiments. The screen display provided in FIG. 38A is merely exemplary, and one skilled in the relevant art(s) will appreciate that many approaches may be taken to provide a suitable screen display 3800A in accordance with this disclosure. Screen display 3800A may be displayed to respond to an appropriate request from a customer to view a menu of the available beverages.

Beverages 3802 including beverage 3802A, beverage 3802B, and beverage 3802C may present a menu of drinks configured by an administrator. Beverages 3802 may include the drinks that the interactive bartender serves in a format suitable for viewing by the customer. Beverages 3802 may be configured to have a name, description, and associated image. Beverages may be scrollable from right to left, display all of the beverages on a single page, or use other suitable interface design approach to convey the available beverages. In example screen display 3800A, beverage 3802A is a “Green N′ Tonic,” beverage 3802B is a “Red Alert,” and beverage 3802C is a “Roots Ninja.” Beverages 3802 may be displayed next to or in addition to interactive bartender 404, e.g., below, above, or alongside the interactive bartender. In another embodiment, beverages 3802 may temporarily replace interactive bartender 404 on screen 102. In another embodiment, Beverages 3802 may be communicated in spoken conversation to the customer, and the information in screen display 3800A thus communicated orally.

FIG. 38B is example screen display 3800B of a details page of a beverage on a pre-configured menu, according to some embodiments. In an embodiment, screen display 3800B may be accessed from the menu of beverages discussed above in screen display 3800A. For example, a customer may use a touchscreen or orally request the details for a particular beverage in the menu of beverages. The screen display provided in FIG. 38B is merely exemplary, and one skilled in the relevant art(s) will appreciate that many approaches may be taken to provide a suitable screen display 3800B in accordance with this disclosure.

Screen display 3800B may include beverage title 3804, ingredients 3806, description 3808, image 3809, and mix cocktail button 3810. Beverage title 3804 may be a configured name for the beverage. In this example, the customer has selected the “Green N′ Tonic” drink, either in spoken language or using the touchscreen and accessed the details page for this drink.

Ingredients 3806 may list the ingredients that make up the beverage, in this case “Gin Levantin,” “Cucumbers Syrup,” and “Tonic Water.” Description 3808 may be a configured description of the beverage, in this case “Classic and easy, the Green N′ Tonic is light and refreshing. It's a simple mixed drink and is perfect for happy hour, dinner, or anytime you simply want an invigorating beverage.” Image 3809 may an image configured to be associated with the beverage.

Mix cocktail button 3810 may cause interactive bartender kiosk to dispense a selected beverage. In another approach, the customer may just orally ask the interactive bartender to prepare the beverage, e.g., the customer may say out loud “Make me a Green N′ Tonic” and interactive bartender 404 may recognize the request and pour the appropriate ingredients in the configured proportions into a receptacle in bay 106.

FIGS. 39A-39I are example screen displays of a web portal for configuring interactive bartenders, according to some embodiments. The screen display provided in FIG. 39A-39I are merely exemplary, and one skilled in the relevant art(s) will appreciate that many approaches may be taken to provide a suitable GUI in accordance with this disclosure.

FIG. 39A is example screen display 3900A of a dashboard in a web portal for configuring an interactive bartender, according to some embodiments. Screen display 3900A may be a landing page for an administrator visiting the web portal. In some embodiments, screen display 3900A may aggregate and summarize data across more than one interactive bartender deployed by an organization. The administrator may select a device button that allows administrator to configure/view a particular interactive bartender kiosk, as the configurations of the interactive bartenders may differ. For example, a hotel chain could configure each deployed interactive bartender kiosk at hotel properties via the same dashboard. The hotel chain may view the dashboard in the aggregate (across all machines) or select a particular interactive bartender kiosk to view the reporting data for that particular interactive bartender kiosk.

The dashboard exemplified in screen display 3900A displays a variety of information about the performance of an interactive bartender kiosk. In screen display 3900A, this includes the total number of sessions, the total number of drinks served, a conversion percentage (total drinks/total sessions*100), the average length of conversations conducted by the interactive bartender, and a variety of suitable graphs and figures that reflect the behavior of the interactive bartender. Screen display 3900A may also include a real-time view of the conversations transpiring at the interactive bartender. One skilled in the arts will understand that screen display 3900A may include a variety of additional data, reports, and graphs related to the performance of the interactive bartenders.

FIG. 39 is example screen display 3900B of a create-device page in a web portal for configuring an interactive bartender, according to some embodiments. The create-device page that allows an administrator to add a new device to the fleet of configurable interactive bartenders. Selectable options including “payment terminal,” “ID Scanner,” and “QR Code” may be selected to indicate the features that are available in the new device. This new device may correspond to an installed interactive bartender kiosk in a particular location. Screen display 3900B includes various fields for effectuating remote control and configuration of the interactive bartender kiosk including user credentials.

FIG. 39C is example screen display 3900C of a devices page in a web portal for configuring an interactive bartender, according to some embodiments. Screen display 3900C may list the devices that are accessible for a particular business and provide relevant summary information about each deployed kiosk. This includes the options selected for that configured device (“payment terminal,” “ID Scanner,” and “QR Code”) and the liquid unit (between milliliters and ounces) that the interactive bartender kiosk uses as part of its operation.

FIG. 39D is example screen display 3900D of a containers page in a web portal for configuring an interactive bartender, according to some embodiments. Screen display 3900D may provide an administrator the ability to configure the particular ingredients used within an interactive bartender kiosk. These ingredients will then be referenced to assemble a menu of beverages as discussed below. In the exemplary embodiment of FIG. 39D, the interactive bartender kiosk has 12 separate containers that can hold ingredients. These ingredients include margarita mix, gimlet mix, old fashioned mix, vodka, simple syrup, rum, lemon juice, blue juice, filthy margarita mix, cola, and coke. But this is not limiting and any number of suitable ingredients may be configured via screen display 3900D.

As indicated in screen display 3900D, interactive bartender kiosk 100 also tracks the current volume of each of the configured ingredients in real-time. This value is displayed in screen display 3900D for each of the containers. The availability of this information allows interactive bartender kiosk 100 to generate notifications and disable drinks that include a dwindling ingredient as it nears depletion.

FIG. 39E is example screen display 3900E of a containers page in a web portal for configuring an interactive bartender, according to some embodiments. Screen display 3900E illustrates the editable and configurable nature of the containers page. An administrator may update the name of the container and also configure an “Orange Line” and a “Red Line.” These values may be referred to below as a warning value and a stop value, respectively. The warning value may be a preferred volume-when the tracked volume for that container drops below the warning value, a notification may be generated and sent to an appropriate staff member informing the staff member that they need to refill that ingredient. The stop value may be a second preferred volume-when the tracked volume for that container drops below the stop value, a notification may be generated and sent to an appropriate staff member and, moreover, menu items that use the ingredient may also be immediately disabled. This prevents customers from ordering a drink that interactive bartender kiosk is incapable of producing.

FIG. 39F is example screen display 3900F of a device-styling page in a web portal for configuring an interactive bartender, according to some embodiments. The device-styling page may allow the administrator to configure the texture of interactive bartender 204, background 402, and other graphical elements of the interactive bartender experience. For example, a user may upload appropriately formatted images or select from templates provided in the web application to uniquely tailor the look and feel of interactive bartender 204 for their location.

FIG. 39G is example screen display 3900G of a create-cocktails page in a web portal for configuring an interactive bartender, according to some embodiments. In the create-cocktails page, an administrator may create a beverage to add to the menu of beverages provided by the interactive bartender. This includes a description of the beverage, the ingredients, an associated image, text responses to provide to the customer when preparing the beverage, and animations to perform while mixing the beverage. An administrator may further configure information needed to access customer-specific API 506D to access additional information and perform customer-specific functions. For example, the text response may be configured with appropriate an API endpoint, associated parameters, and credentials to dynamically retrieve information for inclusion in the text response or even to perform specific functionality. The returns from the API may further be included in the response using techniques known to those skilled in the relevant art. An administrator may also specify mixing details for the cocktail by specifying intervals/quantities that allow for the staggering of the beverage to achieve mixing.

FIG. 39H is example screen display 3900H of a logs page in a web portal, according to some embodiments. The logs page may display the logs of past conversations. The page may include the ability to sort and group, generate reports, and glean further information from the stored logs of conversations. The logs page may be important in refining the configured keywords list to address conversations that did not result in an appropriate response. For example, an administrator may view the conversation text and determine an additional configurable record to add to the keywords to address future conversations in the same vein.

FIG. 39I is example screen display 3900I of a return-on-investment page in a web portal for configuring an interactive bartender, according to some embodiments. The return-on-investment page may provide financial information related to interactive bartender kiosk 100. Access to the return-on-investment page may be limited to particular users or user types.

FIG. 40 illustrates microcontroller 4000 that may be used in some embodiments of an interactive bartender kiosk to dispense beverages, according to some embodiments. As illustrated in FIG. 40, microcontroller 4000 may include pins 4002. Pins 4002 may be used to connect wires to microcontroller 4000 and construct a circuit. Pins 4002 may be divided into different types of pins, e.g., for grounding, providing power, reading analog/digital signals, and other functions.

As mentioned above, microcontroller 4000 may be connected, through pins 4002, to pumps 509 used to transport liquid ingredients from holding containers within kiosk 100 into a glass in bay 106. Microcontroller 4000 may have specialized control software to initialize pumps 509 and tubes. For example, on startup or on refilling ingredients, microcontroller 4000 may prime a pump to make sure excess air in the tube is evacuated. In this way, liquid dispensed from the respective pumps can be measured precisely.

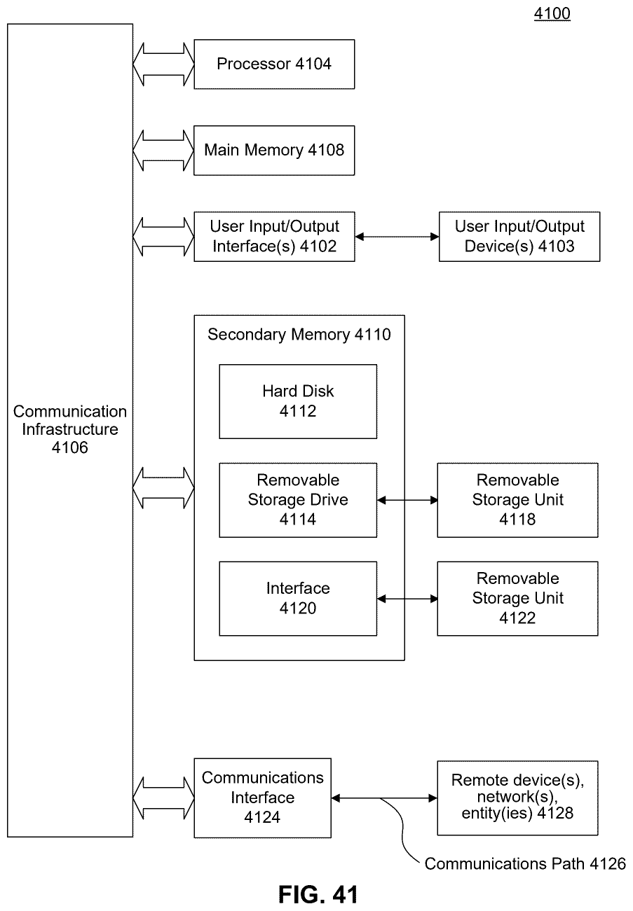

Various embodiments may be implemented, for example, using one or more well-known computer systems, such as computer system 4100 shown in FIG. 41. One or more computer systems 4100 may be used, for example, to implement any of the embodiments discussed herein, as well as combinations and sub-combinations thereof.

Computer system 4100 may include one or more processors (also called central processing units, or CPUs), such as a processor 4104. Processor 4104 may be connected to a communication infrastructure or bus 4106.

Computer system 4100 may also include user input/output device(s) 4108, such as monitors, keyboards, pointing devices, etc., which may communicate with communication infrastructure 4106 through user input/output interface(s) 4102.

One or more of processors 4104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 4100 may also include a main or primary memory 4108, such as random access memory (RAM). Main memory 4108 may include one or more levels of cache. Main memory 4108 may have stored therein control logic (i.e., computer software) and/or data.

Computer system 4100 may also include one or more secondary storage devices or memory 4110. Secondary memory 4110 may include, for example, a hard disk drive 4112 and/or a removable storage device or drive 4114. Removable storage drive 4114 may be a floppy disk drive, a magnetic tape drive, a compact disk drive, an optical storage device, tape backup device, and/or any other storage device/drive.

Removable storage drive 4114 may interact with a removable storage unit 4118. Removable storage unit 4118 may include a computer usable or readable storage device having stored thereon computer software (control logic) and/or data. Removable storage unit 4118 may be a floppy disk, magnetic tape, compact disk, DVD, optical storage disk, and/any other computer data storage device. Removable storage drive 4114 may read from and/or write to removable storage unit 4118.

Secondary memory 4110 may include other means, devices, components, instrumentalities or other approaches for allowing computer programs and/or other instructions and/or data to be accessed by computer system 4100. Such means, devices, components, instrumentalities or other approaches may include, for example, a removable storage unit 4122 and an interface 4120. Examples of the removable storage unit 4122 and the interface 4120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 4100 may further include a communication or network interface 4124. Communication interface 4124 may enable computer system 4100 to communicate and interact with any combination of external devices, external networks, external entities, etc. (individually and collectively referenced by reference number 4128). For example, communication interface 4124 may allow computer system 4100 to communicate with external or remote devices 4128 over communications path 4126, which may be wired and/or wireless (or a combination thereof), and which may include any combination of LANs, WANs, the Internet, etc. Control logic and/or data may be transmitted to and from computer system 4100 via communication path 4126.

Computer system 4100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 4100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 4100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 4100, main memory 4108, secondary memory 4110, and removable storage units 4118 and 4122, as well as tangible articles of manufacture embodying any combination of the foregoing. Such control logic, when executed by one or more data processing devices (such as computer system 4100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 41. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system for providing an interactive bartending experience leveraging artificial intelligence, comprising:
a plurality of containers storing a plurality of ingredients;
a memory; and
at least one processor coupled to the memory and configured to:
display an interactive bartender that provides a menu of beverages to a customer;
transform a spoken input received from the customer into a readable string;
determine a response to the spoken input by generating a prompt comprising one or more rules, a representation of the menu of beverages, and the readable string, transmitting the prompt to a generative artificial intelligence, and receiving a response;
convert the response to a spoken output; and
communicate the spoken output to the customer via the interactive bartender.

2. The system of claim 1, the at least one processor further configured to:
determine an intention by:
(1) generating a second prompt comprising a plurality of intentions, the spoken input, and the response,
(2) transmitting the second prompt to the generative artificial intelligence, and
(3) receiving the intention selected from the plurality of intentions.

3. The system of claim 2, wherein the intention indicates a selected beverage from the menu of beverages.

4. The system of claim 1, where to generate the prompt the at least one processor is further configured to:
retrieve a default prompt comprising one or more parameters; and
generate the prompt by parameterizing the default prompt with customer-specific information.

5. The system of claim 4, wherein the one or more parameters specify: (1) one or more ingredients for each beverage in the menu of beverages, (2) an availability for each of the one or more ingredients, and/or (3) a location.

6. The system of claim 1, the at least one processor further configured to:
receive a second spoken input;
transform the second spoken input into a second readable string;
determine a second response to the second spoken input by:
(1) generating a second prompt comprising the one or more rules, the representation of the menu of beverages, the readable string, the response, and the second readable string,
(2) transmitting the second prompt to the generative artificial intelligence, and
(3) receiving the second response.

7. The system of claim 1, wherein the generative artificial intelligence leverages a large language model built with a plurality of records of prior conversations between past users and the interactive bartender.

8. The system of claim 1, wherein the response: (1) provides the menu of beverages to the customer; (2) provides details about a beverage in the menu of beverages; (3) requests a confirmation of a selected beverage from the menu of beverages; or (4) acknowledges the confirmation of the selected beverage.

9. The system of claim 1, wherein to transform the spoken input the at least one processor is further configured to:
transmit an audio file recording of the spoken input to a cognitive services application programming interface (API); and
receive the readable string of the spoken input from the cognitive services API.

10. The system of claim 1, wherein to determine the response to the spoken input the at least one processor is further configured to:
compare the readable string to a keywords list comprising match strings, text responses, and priorities to select a matching readable string having a highest priority; and
use a text response corresponding to the matching readable string as the response.

11. The system of claim 1, the at least one processor configured to:
determine an animation associated with the response; and
display the animation while communicating the response to the customer.

12. The system of claim 1, the at least one processor further configured to:
in response to receiving a selected beverage from the menu of beverages, engage a microcontroller to dispense at least one ingredient from the plurality of containers in a pre-configured proportion into a receptacle.

13. A method for providing an interactive bartending experience leveraging generative artificial intelligence, comprising:
displaying, by one or more processors, an interactive bartender that provides a menu of beverages to a customer;
transforming a spoken input received from the customer into a readable string;
determining a response to the spoken input by generating a prompt comprising one or more rules, a representation of the menu of beverages, and the readable string, transmitting the prompt to a generative artificial intelligence, and receiving a response;
converting the response to a spoken output; and
communicating the spoken output to the customer via the interactive bartender.

14. The method of claim 13, further comprising:
determining an intention by:
(1) generating a second prompt comprising a plurality of intentions, the spoken input, and the response,
(2) transmitting the second prompt to the generative artificial intelligence, and
(3) receiving the intention selected from the plurality of intentions.

15. The method of claim 13, the generating the prompt further comprising:
retrieving a default prompt comprising one or more parameters; and
generating the prompt by parameterizing the default prompt with customer-specific information.

16. The method of claim 13, further comprising:
receiving a second spoken input;
transforming the second spoken input into a second readable string;
determining a second response to the second spoken input by generating a second prompt comprising the one or more rules, the representation of the menu of beverages, the readable string, the response, and the second readable string, transmitting the second prompt to the generative artificial intelligence, and receiving the second response.

17. The method of claim 13, wherein the generative artificial intelligence leverages a large language model built with a plurality of records of prior conversations between past customers and the interactive bartender.

18. The method of claim 13, the transforming the spoken input further comprising:
transmitting an audio file recording of the spoken input to a cognitive services application programming interface (API); and
receiving the readable string of the spoken input from the cognitive services API.

19. The method of claim 13, further comprising:
in response to receiving a selected beverage from the menu of beverages, engaging a microcontroller to dispense at least one ingredient from the plurality of containers in a pre-configured proportion into a receptacle.

20. A non-transitory computer-readable device having instructions stored thereon that, when executed by at least one computing device, causes the at least one computing device to perform operations for providing an interactive bartending experience leveraging generative artificial intelligence comprising:
displaying an interactive bartender that provides a menu of beverages to a customer,
transforming a spoken input received from the customer into a readable string;
determining a response to the spoken input by generating a prompt comprising one or more rules, a representation of the menu of beverages, and the readable string, transmitting the prompt to a generative artificial intelligence, and receiving a response;
converting the response to a spoken output; and
communicating the spoken output to the customer via the interactive bartender.
